(19) United States
(12) Patent Application Publication
(10) Pub. No.: US 2023/0063363 A1
(43) Pub. Date: Mar. 2, 2023

(54) SYSTEM AND METHOD FOR DRAFTING AT LEAST A PORTION OF A PATENT APPLICATION, FACILITATING ASSIGNMENT OF THE PATENT APPLICATION OR COMBINATIONS THEREOF

(71) Applicant: INNOVATION EXCHANGE LLC, Colleyville, TX (US)

(72) Inventors: Brandon Val ZUNIGA, Dallas, TX (US); Bradley Grant Nichols, Colleyville, TX (US)

(21) Appl. No.: 17/796,669

(22) PCT Filed: Feb. 26, 2021
(86) PCT No.: PCT/US21/20009

§ 371 Date: Jul. 31, 2022

Related U.S. Application Data
(60) Provisional application No. 62/994,166, filed on Mar. 24, 2020.

(51) Int. Cl. G06Q 10/10; G06Q 50/18; G06F 40/166

(52) U.S. Cl. CPC G06Q 10/10; G06Q 50/184; G06F 40/166

(57) ABSTRACT

A system comprises a computer and a user interface comprising an image display. A method comprises prompting a user to provide user input by displaying a user prompt on the image display; the computer receiving the user input via the user interface; and the computer using the user input to draft at least a portion of a patent application. The user input can comprise a third-party indication, the third-party indication indicating whether the user desires at least one third party to be notified. The user can be prompted to provide user input in a format that can be converted into a portion of the application without any further user input or the use of artificial intelligence. A portion of the patent application that is created using the user input can be displayed in a user prompt. The user interface can be located remotely from the computer.

### CROSS-REFERENCE AND RELATED APPLICATIONS

This application claims priority to U.S. Provisional Application No. 62/994,166, filed on Mar. 24, 2020, entitled “SYSTEM AND METHOD FOR DRAFTING AT LEAST A PORTION OF A PATENT APPLICATION, FACILITATING ASSIGNMENT OF THE PATENT APPLICATION OR COMBINATIONS THEREOF,” which is incorporated herein by reference in its entirety as an example. U.S. Provisional Application No. 62/981,898, filed on Feb. 26, 2020, entitled “SYSTEM AND METHOD FOR LABELING AN IMAGE” is incorporated herein by reference in its entirety as an example.

### BACKGROUND OF THE INVENTION

### Technical Field

This disclosure relates to systems and methods for drafting a patent application or portion of a patent application and facilitating a full or partial assignment of rights and interests in the patent application or the subject matter of the patent application. In some embodiments, this disclosure relates to drafting a patent application for a user and then providing the user with an option to indicate that the user would be interested in having the patent application reviewed by a third party with a potential interest in owning or licensing all or a portion of the rights and interests associated with a patent application, optionally including the subject matter of the patent application, any related patent applications or any patents issuing from the patent application. In some embodiments, this disclosure relates to a system and method that permit the user to decide how the patent application should be presented to a third party and the initial terms under which a third party might own or license all or a portion of the rights and interests associated with the patent application. In some embodiments, this disclosure relates to a system and method in which the user is given the opportunity to choose the initial terms from a plurality of options presented to the user. In some embodiments, this disclosure relates to an option for the user to solicit a bid or information relating to how much money a third party would be willing to pay for the ability to own or license all or a portion of the rights and interests associated with a patent application, and potentially, without the third party being provided with an opportunity to change the initial terms. In some embodiments, this disclosure relates to an option for the third party to provide information to the user relating to how much money the third party would be willing to pay for the ability to own or license all or a portion of the rights and interests associated with a patent application if the initial terms were changed as specified by the third party in amended terms.

### Background

Throughout this Background section and throughout this application, various known components are described with reference to patent applications, publications of patent applications and patents. Every patent application, publication of a patent application, and patent listed or referenced in this application (collectively the “cited references”) is hereby incorporated by reference in its entirety as an example. The cited references merely provide illustrative examples. None of the definitions or limitations in these cited references limit the disclosure or claims in this application unless the definitions or limitations are specifically copied into the present application. Accordingly, the language expressly appearing in this application is controlling over any text incorporated by reference, but not expressly included in this application. Furthermore, the terms of this application are to be construed in accordance with their ordinary meaning in the art unless some other meaning is made evident in the disclosure of this application, excluding any disclosure that is only incorporated by reference and has not actually been expressly set forth in this application.

Some examples of known components referenced in this application include, but are not limited to, computers and systems comprising computers. (See, e.g., U.S. Pat. Nos. 9,709,411B2, 9,542,201B2, 5,548,763A, and 5,655,106A.) However, this does not mean that the components listed in this application, including, but not limited to, computers and systems comprising computers, are known as part of or in combination with the systems and methods described in the present application. Nonetheless, upon reading the disclosure of the present application, a person having ordinary skill in the art (i.e., a “skilled person”) would be able to use or modify existing components, including, but not limited to, computers and systems comprising computers, to make and use the systems and methods described in this application.

Examples of computers and systems comprising computers include, but are not limited to, a computing environment (see, e.g., U.S. Pat. No. 9,600,353B2), a personal computer (see, e.g., U.S. Pat. Nos. 9,709,411B2, 9,542,201B2, 5,548,763A, and 5,655,106A), a desktop computer (see, e.g., U.S. Pat. Nos. 9,709,411B2, 9,542,201B2, 5,548,763A, and 5,655,106A), a laptop computer (see, e.g., U.S. Pat. Nos. 5,805,412A, and 8,134,831B1), a notebook computer (see, e.g., U.S. Pat. Nos. 5,805,412A, and 8,134,831B1), a tablet computer (see, e.g., U.S. Pat. Nos. 8,208,245B2, and 6,788,527B2), a handheld computer (see, e.g., U.S. Pat. Nos. 5,946,647A, 8,046,721B2, 8,074,172B2, 6,847,959B1, U.S. Pat. Nos. 8,942,694B2, 7,761,414B2, US2012/0116559A1, U.S. Pat. Nos. 9,549,056B2, and 9,569,045B2), an integrated office system (see, e.g., U.S. Pat. No. 5,877,746A), a virtual reality system (see, e.g., U.S. Pat. No. 6,054,991A), a personal digital assistant (see, e.g., U.S. Pat. Nos. 9,549,056B2, and 9,569,045B2), a smart phone (see, e.g., U.S. Pat. Nos. 5,946,647A, 8,046,721, U.S. Pat. Nos. 8,074,172B2, 6,847,959B1, 8,942,694B2, 7,761,414B2, US2012/0116559A1, U.S. Pat. Nos. 9,549,056B2, and 9,569,045B2), a smart watch (see, e.g., U.S. Pat. No. 9,946,229B2), a smart television set (T.V.) (see, e.g., US20150156554A1, and U.S. Pat. No. 9,578,272B, a network server (see, e.g., U.S. Pat. Nos. 6,452,925B1, 6,842,769B1, 6,868,444B1, 6,952,428B, 7,808,918B2, and 8,935,706B2), a cloud server (see, e.g., U.S. Pat. No. 9,270,753B2, US20120297059A1, and US20130247136A1), a virtual server (see, e.g., U.S. Pat. Nos. 8,776,050B2, 8,386,610B2, and 7,734,778B2), a cloud-based computer (see, e.g., U.S. Pat. Nos. 8,996,695B2, 8,843,603B1, 8,996,891B2, 9,875,671B2, and 9,965,151B2), a virtual machine (see, e.g., U.S. Pat. Nos. 7,913,226B2, 7,996,835B2, 5,996,026A, and 8,776,050B2), a virtual personal computer (see, e.g., U.S. Pat. Nos. 8,335,931B2, 7,370,360B2, 7,996,785B2, and 8,225,314B2) a network (see, e.g., U.S. Pat. Nos. 6,452,925B1, 6,842,769B1, 6,868,444B1, 6,952,428B, 7,808,918B2, and 8,935,706B2), the internet (see, e.g., U.S. Pat. Nos. 7,761,558B1, 8,438,154B2, US20090144240A1, US20050234885A1, US20080065723A1, U.S. Pat. No. 5,956,038A, US20060064471A1, U.S. Pat. No. 8,219,567B2, and U.S. Pat. No. 7,925,692B2), or any combination thereof.

Interfaces permitting a user to interact with a computer or a system comprising a computer are well known. (See, e.g., any of the patents or publications cited with reference to computers or systems comprising computers.) However, this does not mean that interfaces permitting a user to interact with a computer or a system are known as part of or in combination with the systems and methods described in the present application. Nonetheless, upon reading the disclosure of the present application, a skilled person would be able to use or modify existing interfaces to make and use the systems and methods described in the present disclosure.

Examples of interfaces permitting a user to interact with a computer or a system comprising a computer include, but are not limited to, an image display (e.g., monitor, touchscreen), a controller for a visible location selector (e.g., a controller, a controller for a cursor, a controller for an arrow, a mouse, a joystick, a key, a keyboard, a touch pad, a touch screen, a sensor to detect movement of a user, or any combination thereof), a controller, a controller for a cursor, a controller for an arrow, a mouse 0430, a joystick, a key, a keyboard 0424, a touch pad, a touch screen, a sensor to detect movement of a user, a sound detector (e.g., microphone), a sound maker (e.g., speaker), a virtual reality system (see, e.g., U.S. Pat. No. 6,054,991A), a virtual reality headset (see, e.g., U.S. Ser. No. 10/073,516B2), a head mounted display (see, e.g., U.S. Ser. No. 10/073,516B2), a sensor, a vibrator, a robot, a light detector 0434 (e.g., camera), or any combination thereof.

Certain standards for creating patent drawings and related symbols and labels are known. (See, e.g., 37 C.F.R. § 1.84 (2019), which is incorporated herein by reference in its entirety as an example.). However, this does not mean that these standards, symbols and labels are known as part of or in combination with the systems and methods described in the present application.

Additionally, systems and methods exist for determining the elements of a claim, checking the elements of a claim for proper antecedent basis, proofing the text of a patent application, and editing the text of a patent application. However, this does not mean that these systems and methods are known as part of or in combination with the systems and methods described in the present application. Nonetheless, upon reading the disclosure of the present application, a skilled person would be able to use or modify existing systems and methods to make and use the systems and methods described in the present disclosure.

Examples of systems and methods for determining the elements of a claim, checking the elements of a claim for proper antecedent basis, proofing the text of a patent application, editing the text of a patent application, preparing parts or all of a patent application, or combinations thereof are provided, for example, in US20040059994A1, US20090276694A1, US20130262968A1, US20140317096A1, US20170075877A1, 20180232361, 20190332674, U.S. Pat. Nos. 5,774,833A, 9,542,360B2, 8,041,739B2, 8,046,364B2, U.S. Ser. No. 10/417,341B2. Every application, patent application publication and patent recited in this paragraph is hereby incorporated by reference herein as an example.

Examples of systems and methods for determining the elements of a claim, checking the elements of a claim for proper antecedent basis, proofing the text of a patent application, editing the text of a patent application, preparing parts of a patent application, or combinations thereof are also provided by existing software, including PatentOptimizer® patent drafting technology available from LexisNexis IP North America Offices, having an address at 2331 Mill Road, Suite 300, Alexandria, Va. 22314, United States of America; TurboPatent® patent drafting technology available from TurboPatent, having an address at 105 S Main St., Suite 240, Seattle, Wash. 98104, United States of America, and Specifico® patent drafting technology, available from Specificio, Inc., having an address at 4676 Admiralty Way, Room 210, Marina Del Rey, California 90292, United States of America.

Various existing systems and methods are capable of being used to draft patent applications. However, these systems and methods fail to provide some or all of the following features.

For example, existing systems and methods fail to provide a convenient way for inventors, applicants, or assignees of patent applications to protect their inventions and find third parties interested in owning or licensing all or a portion of the rights and interests associated with a patent application.

Existing systems and methods fail to help facilitate the manufacture, marketing, and commercial exploitation of an inventor's patent application or the subject matter disclosed in the patent application.

Existing system and methods fail to facilitate the ability of a patent professional to obtain an invention disclosure from a user (e.g., inventor, inventors, applicant, applicants or any combination thereof), thereby decreasing the costs, time, errors, and misunderstandings associated with obtaining the invention disclosure.

Existing system and methods fail to facilitate the ability of a patent professional to obtain an invention disclosure from an inventor, inventors, applicant, or applicants located remotely from the patent professional, thereby decreasing travel costs, risks of spreading illness, or any combination thereof.

Existing system and methods fail to enable a user to select one or a combination of invention types for which to provide user input so that a patent application covering the invention type or inventions types can be prepared by the system.

Existing system and methods fail to enable a user to provide user input corresponding to one or a combination of invention types for which to provide user input so that a patent application covering the invention type or inventions types can be prepared by the system.

Existing system and methods fail to enable a user to provide user input comprising an element or elements of an invention so that a patent application can be prepared by the system.

Existing system and methods fail to enable a user to provide user input comprising an element or elements of an invention in a specific format so that a patent application can be prepared by the system without the system needing to use more complex artificial intelligence, which can require additional system resources, for example, more power, faster computers, more memory, more time, or any combination thereof.

Existing system and methods fail to include a user prompt that prompts a user to provide user input and displays a portion of the patent application, for example, a claim or claims, that is created by the system or method using the user input.

Existing system and methods fail to comprise a method and/or system that can label an image, for example, a patent figure or drawing provided by a user as user input, much less label the image with a single touch of a touch screen or a single click of a mouse.

Additionally, existing system and methods fail to facilitate an inventor's ability to prepare or mostly prepare a draft patent application that can be filed by the inventor or applicant without significant review by a patent professional, attorney or agent and thereby reducing or eliminating the costs associated with such review or filing of the patent application. Furthermore, existing systems and methods fail to provide inventors with the ability to discuss their inventions with potential investors, while reducing or eliminating the costs of attorney review, and while mitigating the risk that a potential investor will steal the invention. Accordingly, existing systems and methods fail to facilitate the sale or license of the invention, for example, in the form of a sale or license of a patent application or subject matter disclosed in a patent application.

Advantageously, however, one or any selection of these features that are lacking in existing systems and methods can be advantageously provided in a novel system or method for drafting a patent application and/or facilitating assignment of the patent application or subject matter disclosed in the patent application, as described in the present disclosure.

### SUMMARY OF SELECTED EMBODIMENTS OF THE INVENTION

In a first aspect, the invention comprises a system. The system comprises a computer and a user interface. The user interface is in communication with the computer. The user interface comprises an image display and at least one input device configured to permit a user to communicate with the computer. The system is configured to perform a method comprising several steps. A first step comprises prompting a user to provide user input by displaying a user prompt on the image display. A second step comprises the computer receiving the user input from the user via the user interface. A third step comprises the computer using the user input to draft at least a portion of a patent application describing at least one invention. The user input comprises at least one element of an invention of the at least one invention.

In a second aspect, the user input comprises a third-party indication, the third-party indication indicating whether the user desires at least one third party to be notified of the existence of the patent application.

In a third aspect, the prompting the user to provide user input comprises prompting the user to provide the user input in a format that can be converted into a portion of the application without any further user input.

In a fourth aspect, the prompting the user to provide user input comprising displaying a portion of the patent application that is created by the system or method using the user input, optionally the portion of the patent application comprising a claim or claims of the patent application.

In a fifth aspect, the user interface is located remotely from the computer. The prompting the user to provide user input comprises displaying a portion of the patent application that is created by the system or method using the user input, optionally the portion of the patent application comprising a claim or claims of the patent application.

In a sixth aspect, the invention comprises a method of using a system. The system comprises a computer and a user interface. The user interface comprises an image display. The method comprises several steps. A first step comprises prompting a user to provide user input by displaying a user prompt on the image display. A second step comprises the computer receiving the user input from the user via the user interface. A third step comprises the computer using the user input to draft at least a portion of a patent application describing at least one invention. The user input comprises at least one element of an invention of the at least one invention.

In a seventh aspect, the method is a method of using a system for drafting at least a portion of a patent application and receiving an indication regarding whether a user desires to notify at least one third party. The user input comprises a third-party indication, the third-party indication indicating whether the user desires at least one third party to be notified of the existence of the patent application.

In an eighth aspect, the method is a method of using a system for drafting at least a portion of a patent application. The prompting the user to provide user input comprises prompting the user to provide the user input in a format that can be converted into a portion of the application without any further user input.

In a ninth aspect, the method is a method of using a system for drafting at least a portion of a patent application. The prompting the user to provide user input comprises displaying a portion of the patent application that is created by the system or method using the user input.

In a tenth aspect, the method is a method of using a system for obtaining a patent application disclosure from a remote user interface. The user interface is located remotely from the computer.

Additional inventive embodiments will be evident to a person having ordinary skill in the art upon reading this disclosure.

### BRIEF DESCRIPTION OF THE DRAWINGS

FIG. 1 depicts a schematic flow chart that illustrates an embodiment of a method for obtaining patent-related user input along with other optional steps, which are shown in a specific combination with a specific order but can also be performed in any possible combination and in any possible order.

FIG. 2 depicts a schematic flow chart that illustrates a simplified version of the embodiment of a method for obtaining patent-related user input, indicating that the method can comprise drafting a patent application or a portion of the patent application without other optional steps; although other optional steps illustrated in FIG. 1 or described in this disclosure are not excluded, and any step or any combination of steps described in this disclosure can be included in the method of FIG. 2 in any possible order.

FIG. 3 depicts a schematic flow chart that illustrates a simplified version of the embodiment of a method for obtaining patent-related user input, indicating that the method can comprise prompting the user to provide a third-party indication, taking at least one step to obtain a bid for an assignment or a license, or any combination thereof, without other optional steps; although other optional steps illustrated in FIG. 1 or described in this disclosure are not excluded, and any step or any combination of steps described in this disclosure can be included in the method of FIG. 3 in any possible order.

FIG. 4 depicts a schematic illustration of an embodiment of a computer in direct or indirect communication with any component or any combination of components of a system, a device or combination of devices outside the system, or any combination thereof. The computer can comprise, for example, a processor, memory, or any combination thereof. The component or any combination of components of the system can comprise, for example, the computer, a user interface, a remote platform, a connected device or devices, or any combination thereof. The device or combination of devices outside the system can comprise, for example, a computer, a user interface, a router, a network, the internet, a memory storage device, a remote platform or any combination thereof.

FIG. 5 depicts a schematic illustration of an embodiment of a computer in direct or indirect communication with an embodiment of a user interface, a remote platform, a connected device, a combination of connected devices, or any combination thereof. The user interface can comprise several components, including, for example, an image display, a controller for a visible location selector (e.g., a mouse), a keyboard, a sound detector (e.g., microphone), a sound maker (e.g., speaker), a light detector (e.g., camera), or any combination thereof.

FIGS. 6-53 depict an ordered series of schematic illustrations which provide an example of how a system and method can be used to: prompt the user (e.g., an applicant or inventor) to provide user input, which user input can comprise a navigation indication; a plurality of navigation indications; a type of invention that the user desires to claim or describe; an element or elements of an invention; a modification indication; a plurality of modification indications; whether the user desires assistance from a patent professional entity (e.g. a patent attorney, patent agent, paralegal or combination thereof); whether the user desires a patent professional entity to review and/or file the patent application or a finalized patent application developed using the user input; whether the user desires to share the user input, the patent application, the finalized patent application, or any combination thereof with a third party (e.g., an entity that may be interested in obtaining an assignment or license to the patent application; or any combination thereof. As further examples, the user input can enable the system and method to create a draft patent application using the user input; to enable a patent professional entity to review and/or modify the patent application to provide a finalized patent application; to enable the patent application or finalized patent application to be filed (e.g., by a user optionally using the system); to enable the user input, the patent application, the finalized patent application, or any combination thereof to be shared with the third party; or to share the user input, the patent application, the finalized patent application, or any combination thereof with the third party.

FIGS. 6-8 depict an ordered series of schematic illustrations which provide an example of how a system and method can be used to: provide a user interface that permits the user to provide patent-related user input (e.g., FIG. 5); prompt a user to provide patent-related user input (e.g., FIG. 5); receive patent-related user input (e.g., FIG. 7); provide a visible depiction of the patent-related user input (e.g., FIG. 7); display a user prompt comprising a prompt-termination symbol, which can comprise a next-prompt symbol (e.g., graphic stating “CONTINUE”) to provide a prompt-termination indication (e.g., next-prompt indication) indicating that a user is finished providing user input in response to the user prompt (see, e.g., FIGS. 7-8); and display a user prompt comprising a previous-prompt symbol to provide a previous-prompt indication (see, e.g., FIGS. 7-8).

FIGS. 9-13 depict an ordered series of schematic illustrations which provide an example of how a system and method can be used to: display a user prompt that comprises a help request indicator (e.g., clickable underlined text) that a user can activate to see a further description or explanation of language in the user prompt and deactivate to hide the further description or explanation of the language.

FIGS. 14-20 depict an ordered series of schematic illustrations which provide an example of how a system and method can be used to: display a user prompt on the image display and receive user input in response to the user prompt, for example, by permitting a user to type user input (e.g. a claim element) and select an indefinite article corresponding to the user input by moving a mouse over a location corresponding to the selected indefinite article or by touching a touch screen at the location (e.g., FIG. 14, 16); and displaying a patent claim or other portion of a patent application comprising the user input.

FIGS. 21-24 depict an ordered series of schematic illustrations which provide an example of how a system and method can be used to: display a user prompt on the image display (e.g., FIGS. 21-24); receive user input in response to the user prompt for example, by permitting a user to select whether an invention has a common name (e.g., FIG. 21), select an indefinite article corresponding to the user input (e.g., FIG. 23) by moving a mouse over a location corresponding to the selected indefinite article or by touching a touch screen at the location, and type user input (e.g., a common name for the invention as illustrated in FIG. 24); and display a patent claim or other portion of a patent application comprising the user input (e.g., FIGS. 21-24).

FIGS. 25-26 depict an ordered series of schematic illustrations which provide an example of how a system and method can be used to: prompt a user to provide user input by providing the user with an opportunity to provide at least one assistance indication, for example, in the form of a question mark on an image display (e.g., FIG. 25); and activated from a deactivated configuration (illustrated by an unfilled question mark) into an activated configuration (e.g., filled question mark), for example, by using a mouse to click on the question mark (e.g., FIGS. 25-26).

FIGS. 27-33 depict an ordered series of schematic illustrations which provide an example of how a system and method can be used to: prompt the user to provide user input by indicating whether an element of the invention (e.g., component of the invention) comprises a sub-element or sub-elements (e.g., FIGS. 27-29), prompt the user to provide user input comprising a word or group of words (e.g., sub-element of a previously received element) in a blank (e.g., FIG. 30), prompt the user to provide user input by selecting the indefinite article that applies to the word or group of words (e.g., FIGS. 31, 32), and display a patent claim or other portion of a patent application comprising the user input (e.g., FIGS. 30-33).

FIGS. 34-36 depict an ordered series of schematic illustrations which provide an example of how a system and method can be used to: prompt the user to provide user input comprising an indication as to whether an element of the invention has a characteristic (e.g., weight) that the user desires to describe.

FIGS. 37-40 depict an ordered series of schematic illustrations which provide an example of how a system and method can be used to: prompt the user to provide user input comprising an indication as to whether an element of the invention has a characteristic (e.g., weight) that the user desires to describe, for example, by selecting the characteristic from a set of characteristics or selecting the characteristic from a set of characteristics and further specifying information with respect to the characteristic.

FIGS. 41-47 depict an ordered series of schematic illustrations which provide an example of how a system and method can be used to: prompt the user to provide user input comprising an indication as to whether an element of the invention has an additional characteristic (e.g., user defined characteristic) that the user desires to describe, for example, by selecting the characteristic from a set of characteristics or selecting the characteristic from a set of characteristics and further specifying information with respect to the characteristic (e.g., with an additional user prompt as illustrated in FIGS. 44-47).

FIG. 48 depicts a schematic illustration which provides an example of how a system and method can be used to: prompt the user to provide user input comprising an indication as to whether a user is done describing an invention.

FIGS. 49-50 depict an ordered series of schematic illustrations which provide an example of how a system and method can be used to: prompt the user to provide user input comprising an indication as to whether a user desires to further describe a subsequent invention that was previously identified in the user input.

FIGS. 51-52 depict an ordered series of schematic illustrations which provide an example of how a system and method can be used to: prompt the user to provide user input comprising a third-party indication, the third-party indication indicating whether the user desires at least one third party to be provided with access to the user input or patent application so that the third party can review the user input or patent application.

FIGS. 53-54 depict an ordered series of schematic illustrations which provide an example of how a system and method can be used to: prompt the user to provide user input comprising a patent professional review indication, the at least one patent professional review indication indicating that the user desires a patent professional entity to review a patent application or the user input relating to a patent application.

FIGS. 55-61 depict an ordered series of schematic illustrations which provide an example of how a system and method can be used to: prompt the user (e.g., a patent professional entity reviewing an application) to provide user input comprising a navigation indication, a plurality of navigation indications, a modification indication, a plurality of modification indications, or any combination thereof, for example to edit a patent application created by the system with user input and finalize the patent application for filing.

FIG. 55 depicts a schematic illustration which provides an example of how a system and method can be used to: prompt the user (e.g., a patent professional entity reviewing an application) to provide user input comprising a navigation indication, thereby indicating that the user desires to review a list of the at least one assistance indications, user defined characteristics, or a category of user input.

FIG. 56 depicts a schematic illustration which provides an example of how a system and method can be used to: prompt the user (e.g., a patent professional entity reviewing an application) to provide user input comprising a second navigation indication from the user, the second navigation indication indicating that the user desires to review at least one assistance indication, user defined characteristic, or user input in a list of the at least one assistance indications, user defined characteristics, or a category of user input.

FIG. 57 depicts a schematic illustration which provides an example of how a system and method can be used to: prompt the user (e.g., a patent professional entity reviewing an application) to provide user input comprising a modification indication from the user, thereby instructing the system and/or method to modify or edit the user input previously provided by a user.

FIG. 58 depicts a schematic illustration which provides an example of how a system and method can be used to: prompt the user (e.g., a patent professional entity reviewing an application) to provide user input comprising a navigation indication from the user, the second navigation indication indicating that the user desires to finalize the application; to review a portion of an application created by the system using the user input; or to review at least one assistance indication, user defined characteristic, or user input in a list of the at least one assistance indications, user defined characteristics, or a category of user input.

FIG. 59 depicts a schematic illustration which provides an example of how a system and method can be used to: prompt the user (e.g., a patent professional entity reviewing an application) to provide user input comprising a navigation indication from the user, the navigation indication indicating that the user desires to review at least one assistance indication or user defined characteristic.

FIG. 60 depicts a schematic illustration which provides an example of how a system and method can be used to: prompt the user (e.g., a patent professional entity reviewing an application) to provide user input comprising a modification indication from the user, the modification indication indicating that the user desires to modify or edit a user defined characteristic that was previously provided by a user.

FIG. 61 depicts a schematic illustration which provides an example of how a system and method can be used to: receive user input comprising a modification indication from the user and modify user input (e.g., a user defined characteristic) previously provided by a user.

FIG. 62 depicts a schematic illustration which provide an example of how a system and method can be used to: prompt the user to provide user input comprising a word or group of words, for example, an element (e.g., component) or elements (e.g., components) of an invention that is a composition) in a blank or blanks; prompt the user to provide user input by selecting the indefinite article that applies to the word or group of words; and display a patent claim or other portion of a patent application comprising the user input.

FIG. 63 depicts a schematic illustration which provide an example of how a system and method can be used to: prompt the user to provide user input comprising a word or group of words, for example, an element (e.g., component) or elements (e.g., components) of an invention that is a product, in a blank or blanks; prompt the user to provide user input by selecting the indefinite article that applies to the word or group of words; and display a patent claim or other portion of a patent application comprising the user input.

FIG. 64 depicts a schematic illustration which provide an example of how a system and method can be used to: prompt the user to provide user input comprising a word or group of words, for example, an element (e.g., component) or elements (e.g., components) of an invention that is an article, in a blank or blanks; prompt the user to provide user input by selecting the indefinite article that applies to the word or group of words; and display a patent claim or other portion of a patent application comprising the user input.

FIG. 65 depicts a schematic illustration which provide an example of how a system and method can be used to: prompt the user to provide user input comprising a word or group of words, for example, an element (e.g., step) or elements (e.g., steps) of an invention that is a method, in a blank or blanks, which element, elements, blank or blanks can be ordered; prompt the user to provide user input by ordering the word or group of words, for example, by displaying a number or letter next to each blank; and display a patent claim or other portion of a patent application comprising the user input.

FIG. 66 depicts a schematic illustration which provide an example of how a system and method can be used to: prompt the user to provide user input comprising a word or group of words, for example, an element (e.g., component) or elements (e.g., components) of an invention that is a method of use (e.g., method of using an article), in a blank or blanks; prompt the user to provide user input by selecting the indefinite article that applies to the word or group of words; and display a patent claim or other portion of a patent application comprising the user input.

FIG. 67 depicts a schematic illustration which provide an example of how a system and method can be used to: prompt the user to provide user input comprising a word or group of words, for example, an element (e.g., step) or elements (e.g., steps) of an invention that is a method of use (e.g. method of using an article), in a blank or blanks, which element, elements, blank or blanks can be ordered; prompt the user to provide user input by ordering the word or group of words, for example, by displaying a number or letter next to each blank; and display a patent claim or other portion of a patent application comprising the user input.

FIG. 68 depicts a schematic illustration which provide an example of how a system and method can be used to: prompt the user to provide user input comprising a word or group of words, for example, an element (e.g., component) or elements (e.g., components) of an invention that is a method of making (e.g., method of making an article), in a blank or blanks; prompt the user to provide user input by selecting the indefinite article that applies to the word or group of words; and display a patent claim or other portion of a patent application comprising the user input.

FIG. 69 depicts a schematic illustration which provide an example of how a system and method can be used to: prompt the user to provide user input comprising a word or group of words, for example, an element (e.g., step) or elements (e.g., steps) of an invention that is a method of making (e.g. method of making an article), in a blank or blanks, which element, elements, blank or blanks can be ordered; prompt the user to provide user input by ordering the word or group of words, for example, by displaying a number or letter next to each blank; and display a patent claim or other portion of a patent application comprising the user input.

### DETAILED DESCRIPTION

Many examples of systems and methods of the present disclosure are provided throughout this disclosure, for example, in the Additional Embodiments section, in the many figures included in this disclosure and in the Brief Description of the Drawings section of this disclosure. Aspects of systems and/or methods according to this disclosure will be further described in this Detailed Description section.

In the following Detailed Description, reference is made to the accompanying drawings which form a part hereof and which provide illustrative examples. Many of these references to the drawings are included in the Additional Embodiments section of this disclosure. Modifications, including, for example, structural changes, substitutions, and rearrangements, can be made to the disclosed examples without departing from the scope of this disclosure.

Unless otherwise indicated, each identical or substantially similar element in the drawings uses the same reference number. However, to avoid unnecessarily cluttering the drawings and causing distraction, the reference numbers for the elements are not repeated on every drawing.

As will be seen in greater detail throughout this disclosure, some embodiments of the systems and methods described in this disclosure can be provided with one or any combination of the following, non-limiting advantages.

Some of the systems and methods are capable of providing a convenient way for inventors, applicants, or assignees of patent applications to protect their inventions and find third parties interested in owning or licensing all or a portion of the rights and interests associated with a patent application. Accordingly, some of the systems and methods can help facilitate the manufacture, marketing, and commercial exploitation of an inventor's patent application or the subject matter disclosed in the patent application.

Some of the systems and methods described in this disclosure facilitate the ability of a patent professional to obtain an invention disclosure (e.g., description of an invention) from a user (e.g., inventor, inventors, applicant, applicants or any combination thereof), thereby decreasing the costs, time, errors, and misunderstandings associated with obtaining the invention disclosure. For example, the systems and methods described in this disclosure can enable the patent professional to obtain the types and formats of user data that are useful for more efficiently preparing a patent application. Additionally, tasks that can be handled by a computer, for example, requesting user input to answer specific questions, answering a user's follow-up questions about the specific questions to help obtain the desired answers from the user in response to the specific questions, and preparing a first draft of the patent application using the user input, can be handled by the systems and methods described in this disclosure. This can free the patent professional to perform higher value work and work more efficiently, thereby providing the user with a patent application at a lower cost, higher quality, more quickly, or any combination thereof, for example, when compared to the patent professional taking the invention disclosure; the patent professional preparing the patent application without using the system or method; an inventor or applicant preparing the patent application without using the system or method; or any combination thereof.

Some of the systems and methods described in this disclosure facilitate the ability of a patent professional to obtain an invention disclosure from an inventor, inventors, applicant, or applicants located remotely from the patent professional, thereby decreasing travel costs, risks of spreading illness, or any combination thereof.

Some of the systems and methods described in this disclosure enable a user to select one or a combination of invention types for which to provide user input so that a patent application covering the invention type or inventions types can be prepared by the system.

Some of the systems and methods described in this disclosure enable a user to provide user input corresponding to one or a combination of invention types for which to provide user input so that a patent application covering the invention type or inventions types can be prepared by the system.

Some of the systems and methods described in this disclosure enable a user to provide user input comprising an element or elements of an invention so that a patent application can be prepared by the system.

Some of the systems and methods described in this disclosure enable a user to provide user input comprising an element or elements of an invention in a specific format so that a patent application can be prepared by the system without the system needing to use more complex artificial intelligence, which can require additional system resources, for example, more power, faster computers, more memory, more time, or any combination thereof.

Some of the systems and methods described in this disclosure enable a user to provide user input comprising an element or elements of an invention in a specific format so that a patent application, including for example, claims, can be prepared by the system without the system needing to receive the claims as user input or needing use more complex artificial intelligence, which can require additional system resources, for example, more power, faster computers, more memory, more time, or any combination thereof.

Some of the systems and methods described in this disclosure enable a user to provide user input comprising an element or elements of an invention in a specific format so that a patent application, including for example, all the components of the specification of a patent application, can be prepared by the system without the system needing to receive the claims as user input or needing use more complex artificial intelligence, which can require additional system resources, for example, more power, faster computers, more memory, more time, or any combination thereof.

Some of the systems and methods described in this disclosure enable a user to provide user input comprising an element or elements of an invention in a specific format that includes a plurality of potential user inputs that a user can select simultaneously to decrease the amount of time required to prompt a user to provide user input, to decrease the amount of time required for the user to provide the user input, or any combination thereof.

Some of the systems and methods described in this disclosure enable a user to provide user input comprising an element or elements of an invention in a specific format that includes a plurality of potential user inputs that can be further specified by a user (e.g., by populating blanks or selecting further user inputs) to decrease the amount of time required to prompt a user to provide user input, to decrease the amount of time required for the user to provide the user input, to avoid the user providing information in a format that the method and/or system is not designed to receive, to avoid the need to use more complicated artificial intelligence to understand the user input, or any combination thereof.

Some of the systems and methods described in this disclosure enable a user to provide user input comprising an element or elements of an invention in a specific format that includes a blank adjacent to an indication of whether an indefinite article should be used with the word or words entered in the blank, and if so, which indefinite article should be used with the word or words entered in the blank to decrease the amount of time required to prompt a user to provide user input, to decrease the amount of time required for the user to provide the user input, to avoid the user providing information in a format that the method and/or system is not designed to receive, to avoid the need to use more complicated artificial intelligence to understand the user input, or any combination thereof.

Some of the systems and methods described in this disclosure include a user prompt that prompts a user to provide user input and displays a portion of the patent application, for example, a claim or claims, that is created by the system or method using the user input. For example, this can enable the user to better understand how the user input will impact the patent application and can therefore help the user to understand the content and format of user input to provide to the system and/or method in response to a user prompt from the system and/or method. In some embodiments, the portion of the patent application that is created by the system using the user input is updated immediately or essentially immediately (e.g., in less than 0.5, 1, 2, 3, 4, or 5 seconds; before the user prompt is no longer displayed to the user by the system and/or method; or any combination thereof) after the system and/or method receives the user input.

Some of the systems and methods described in this disclosure comprise a method and/or system that can label an image, for example, a patent figure or drawing provided by a user as user input, much less label the image with a single touch of a touch screen or a single click of a mouse. Examples of a method and/or system that can label an image are described in U.S. Provisional Patent Application No. 62/981,898, filed on Feb. 26, 2020, and entitled “System and Method for Labeling an Image,” which is incorporated herein by reference in its entirety as an example.

Some of the systems and methods described in this disclosure facilitate an inventor's or applicant's ability to prepare or mostly prepare a draft patent application that can be filed by the inventor or applicant without significant review by a patent professional, attorney or agent, thereby reducing or eliminating the costs associated with such review or filing of the patent application, decreasing the costs associated with drafting and filing the patent application, increasing the number of individuals who can pay for a patent professional to review their patent application before filing, decreasing patent office costs associated with reviewing applications that fail to comply with application rules, increasing the number of patent applications that can be reviewed by a patent application, or any combination thereof.

Some of the systems and methods described in this disclosure facilitate the ability of inventors to discuss their inventions with potential investors, while reducing or eliminating the costs of attorney review, and while mitigating the risk that a potential investor will steal the invention.

Some systems and methods described in this disclosure facilitate the sale or license of the invention disclosed in a patent application, for example, in the form of a sale or license of the patent application or subject matter disclosed in a patent application.

Of course, other advantages of the methods and systems described in this disclosure will be evident to a skilled person reading this disclosure. Thus, the listing of advantages provided in this disclosure is illustrative and not limiting. Accordingly, while some embodiments of the systems and methods described herein can be provided with one of the advantages described herein or any combination of the advantages described herein, additional embodiments of the systems and methods described herein are not required to provide all or any of the advantages described herein.

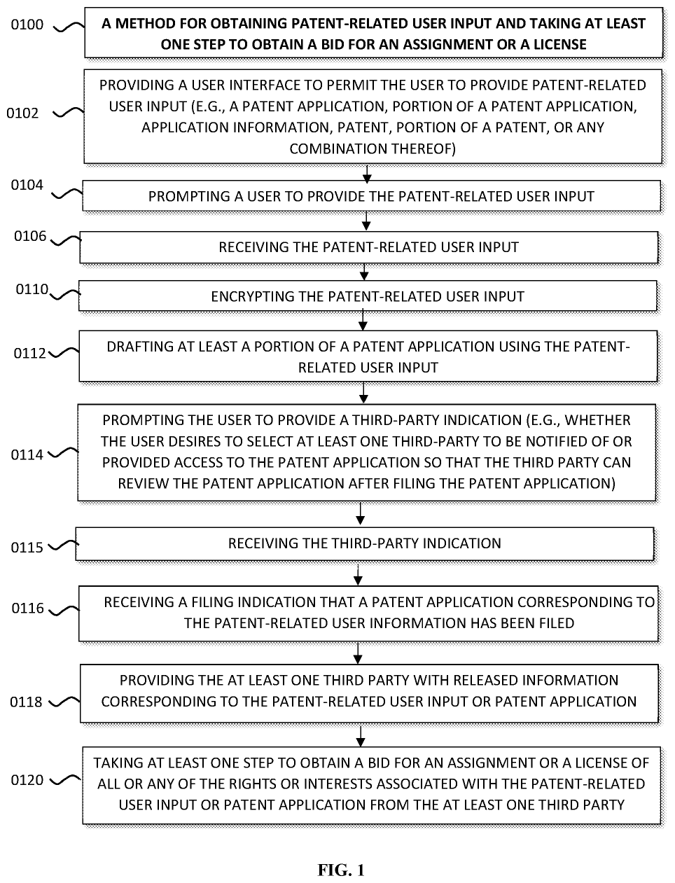

For ease of comprehending how the system and method can be employed, several examples of a method 0100 will now be described with reference to FIGS. 1, 4, 5 and 6. The method 0100 can comprise an ordered series of steps, with several options being possible.

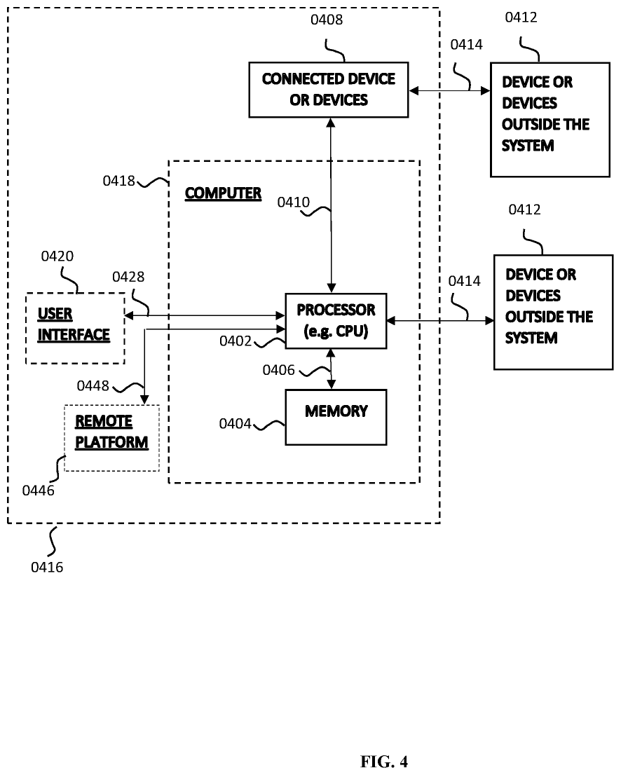

With reference to FIGS. 4 and 5, the method 0100 can be accomplished using a system 0416, which system 0416 can comprise a computer 0418 and a user interface 0420, and the user interface 0420 can comprise an image display 0432.

With reference to FIG. 1, in one embodiment, the method 0100 comprises several steps. A first step comprises prompting 0104 a user 0602 to provide user input 2002 by displaying a user prompt 0606 on the image display 0432. Examples are illustrated in FIGS. 6 and 20. Still further examples appear throughout the Figures.

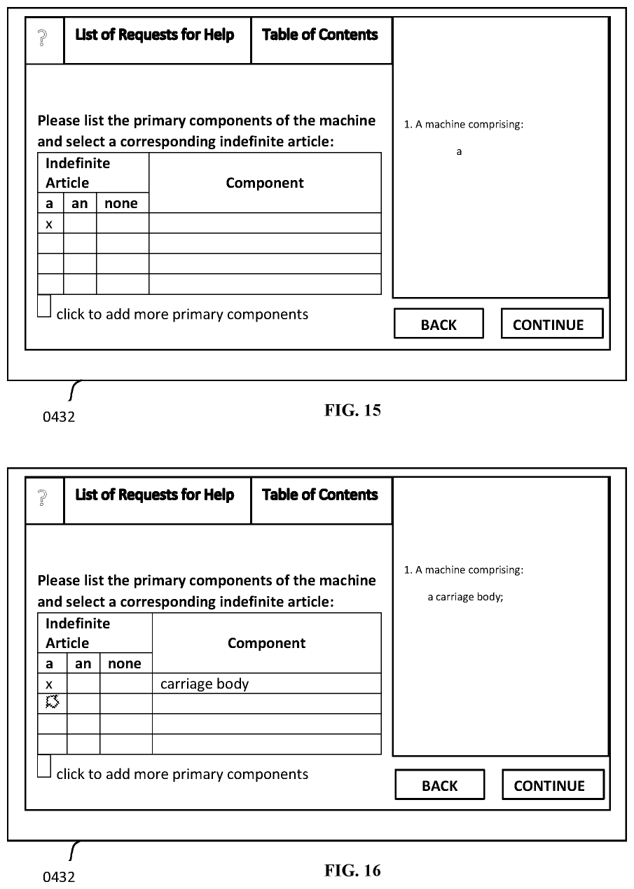

A second step comprises the computer 0418 receiving 0106 the user input 2002 from the user 0602 via the user interface 0420. FIGS. 14 to 15 illustrate how a user can use a location indicator (e.g., an arrow or cursor) to provide user input 2002 by clicking a box to toggle an “x” on or off, thereby indicating the corresponding indefinite article for a component of an invention, which component is input by a user in the form of a word or group of words as illustrated in FIG. 16.

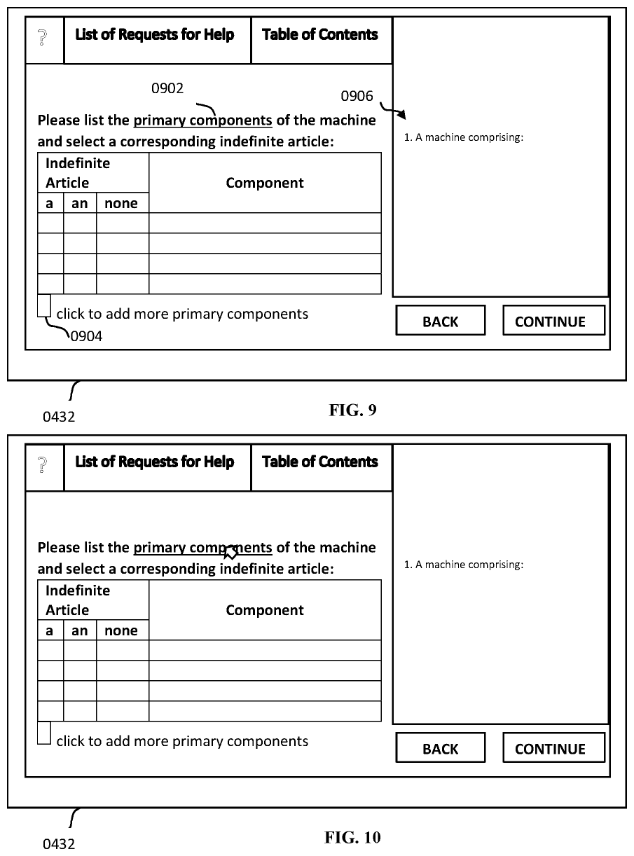

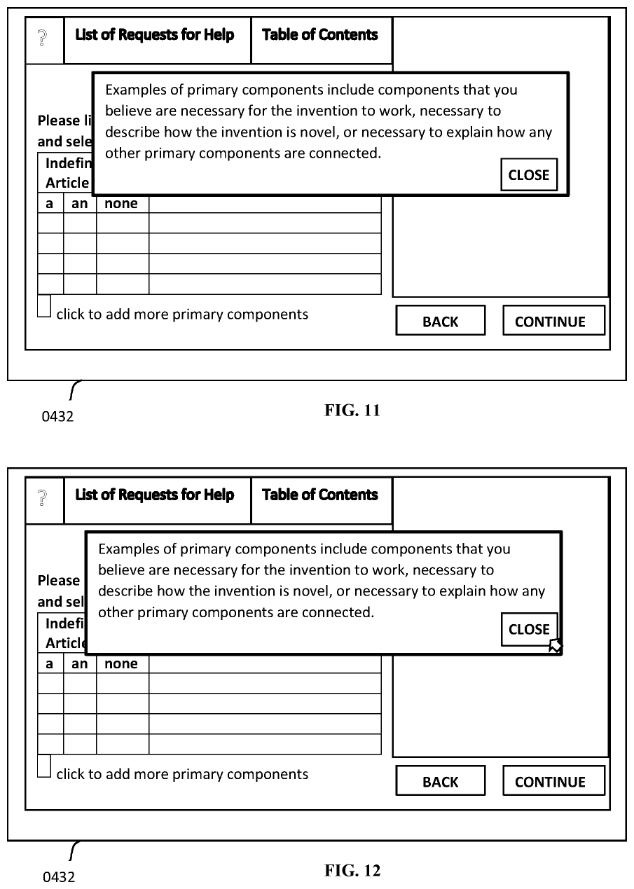

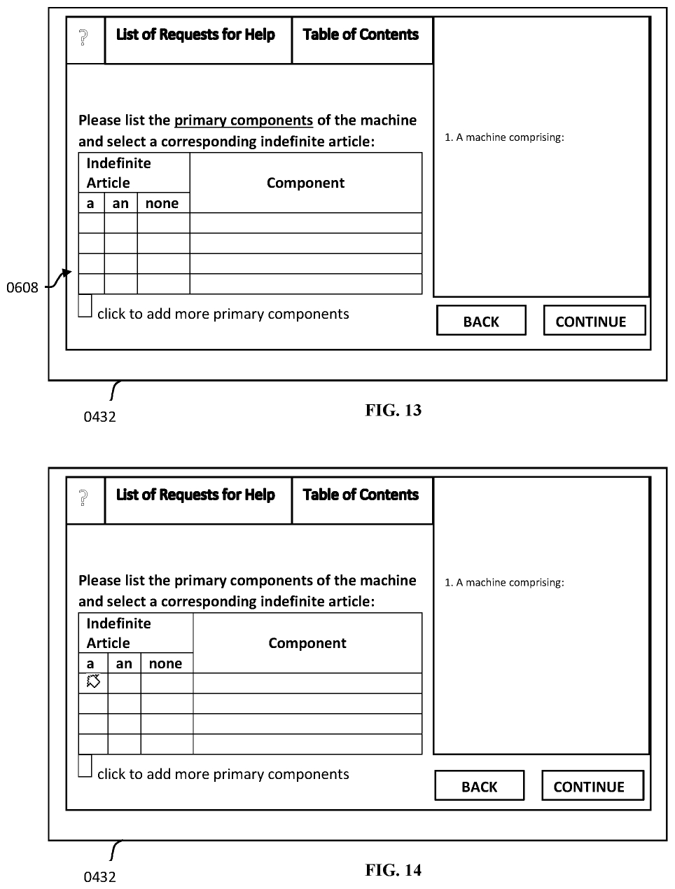

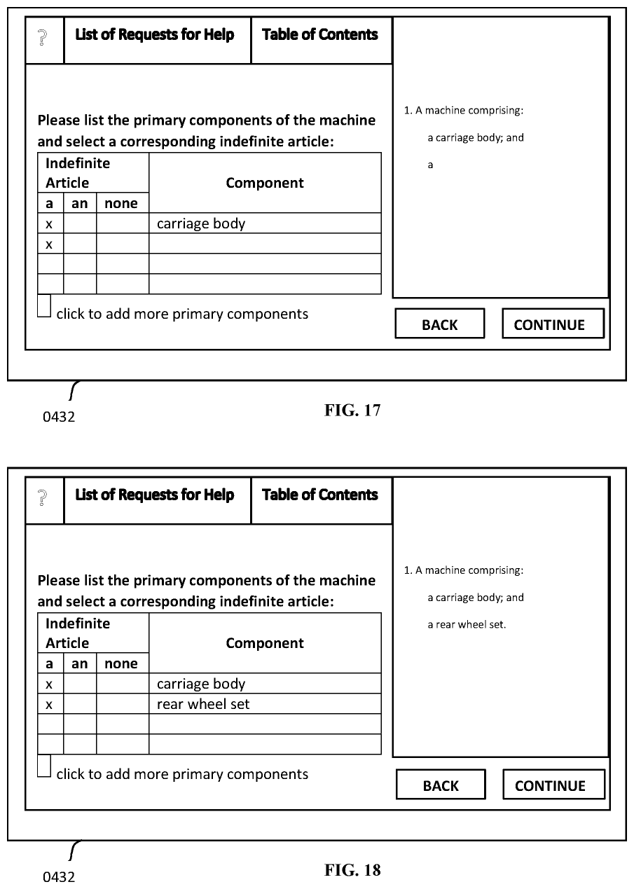

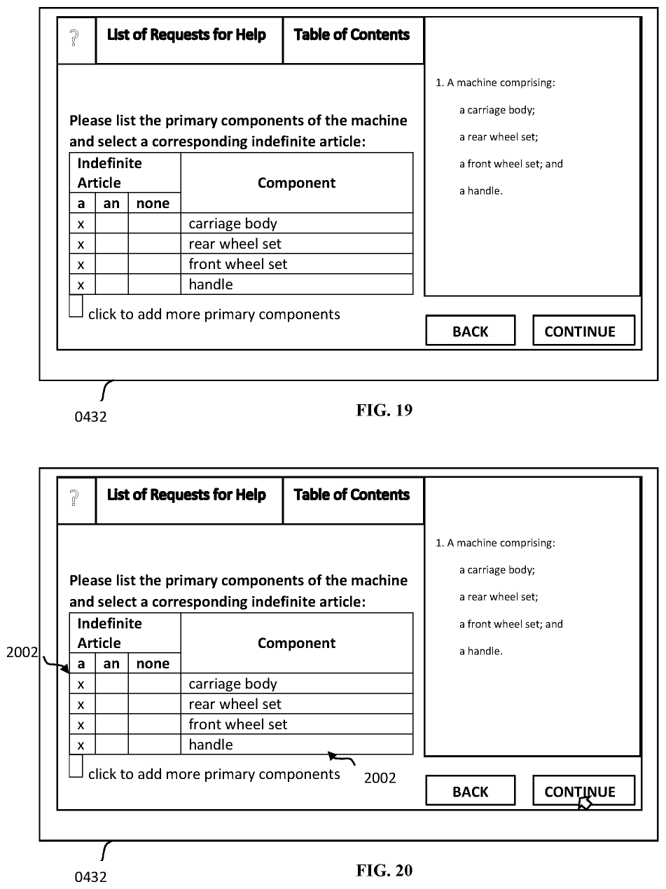

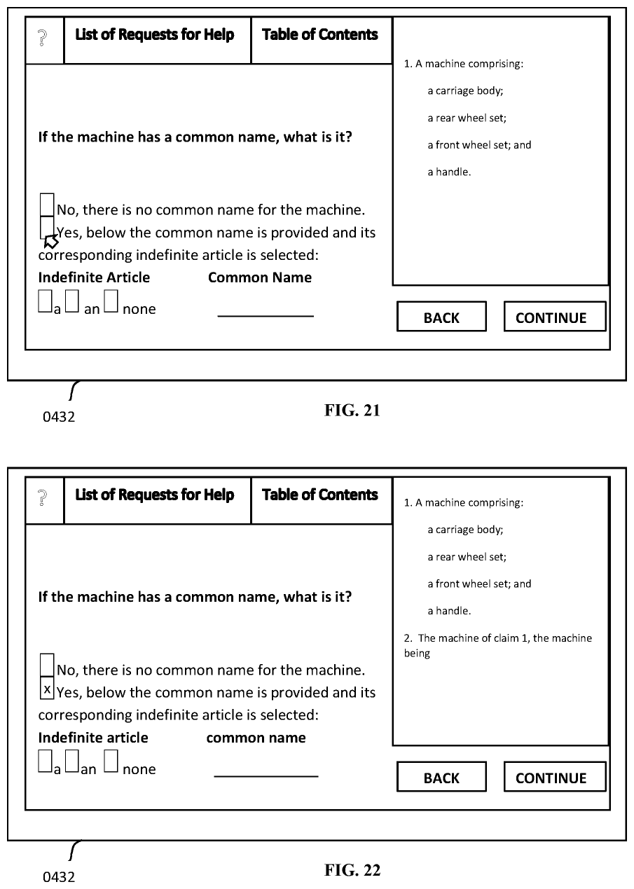

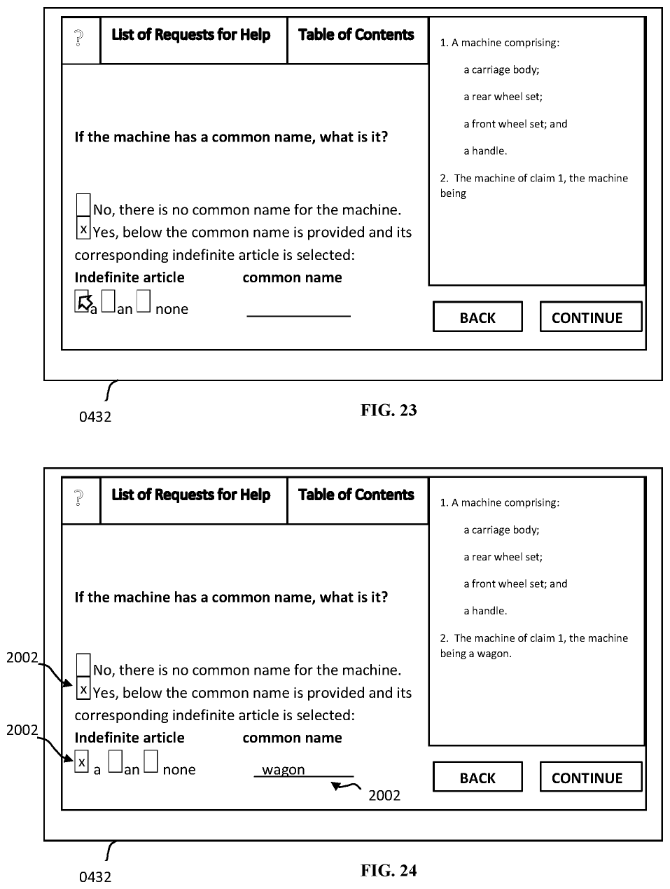

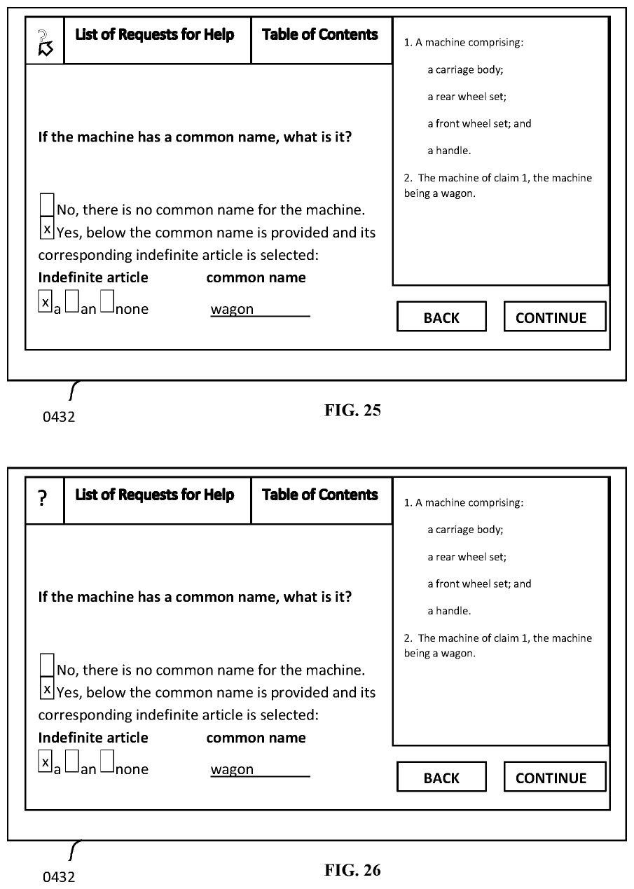

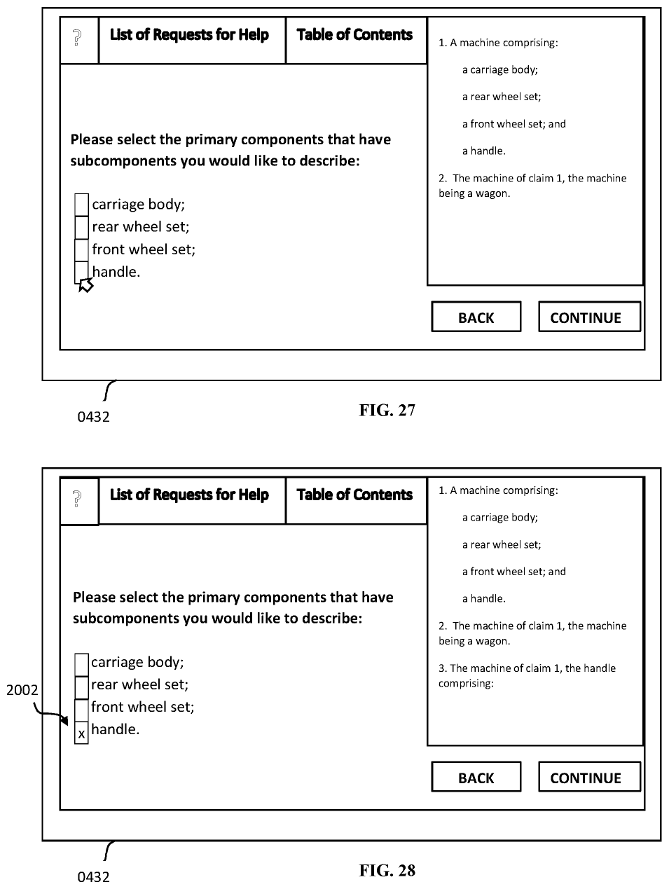

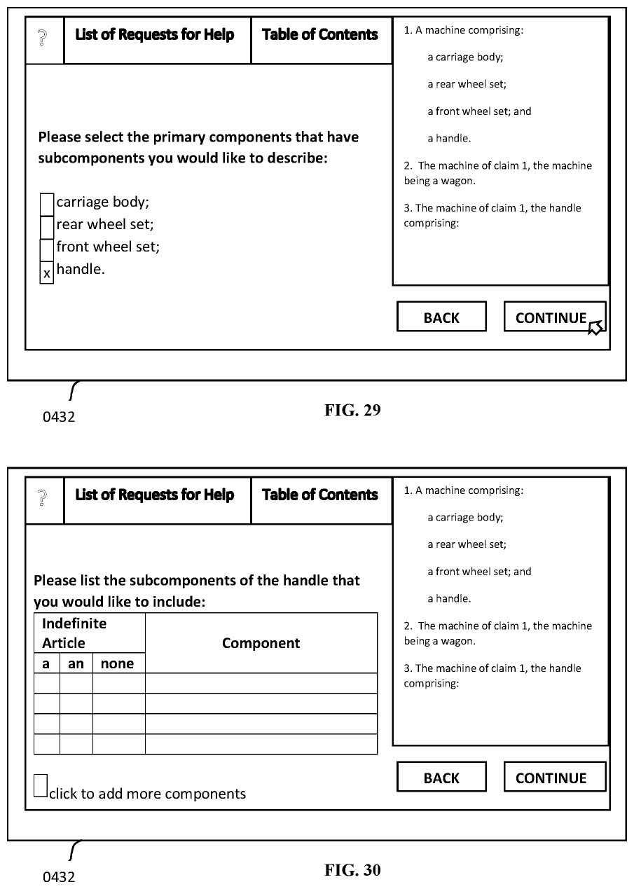

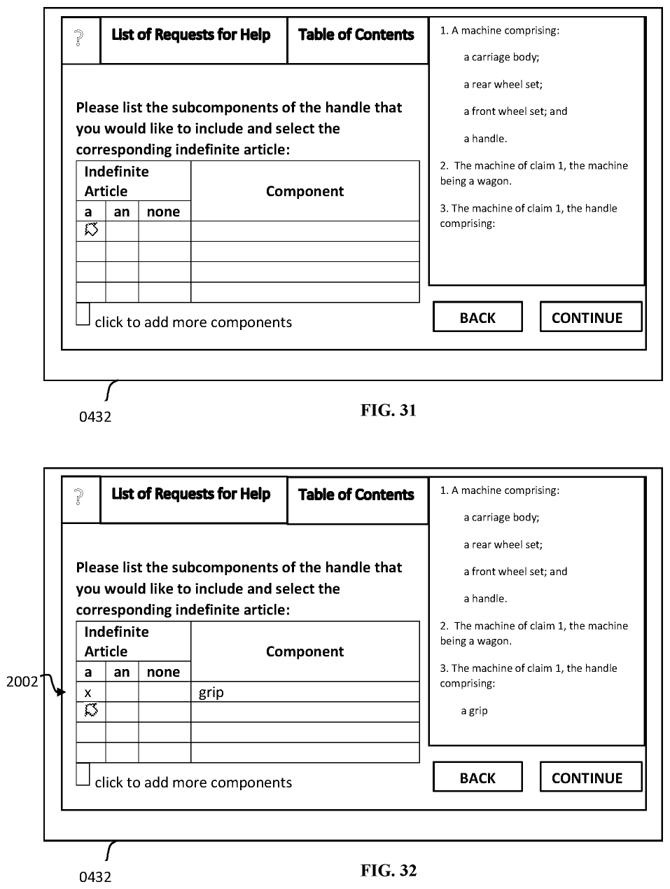

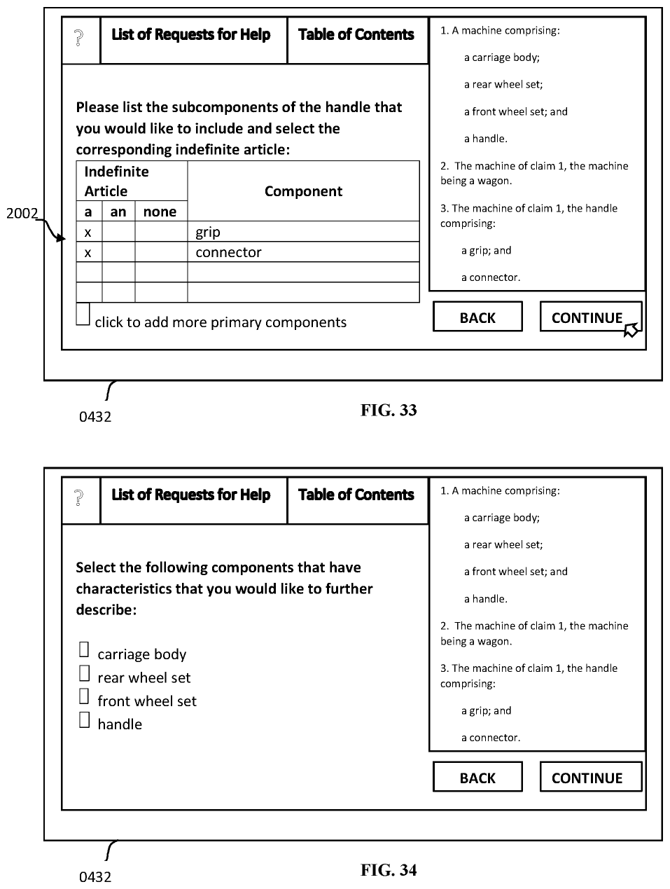

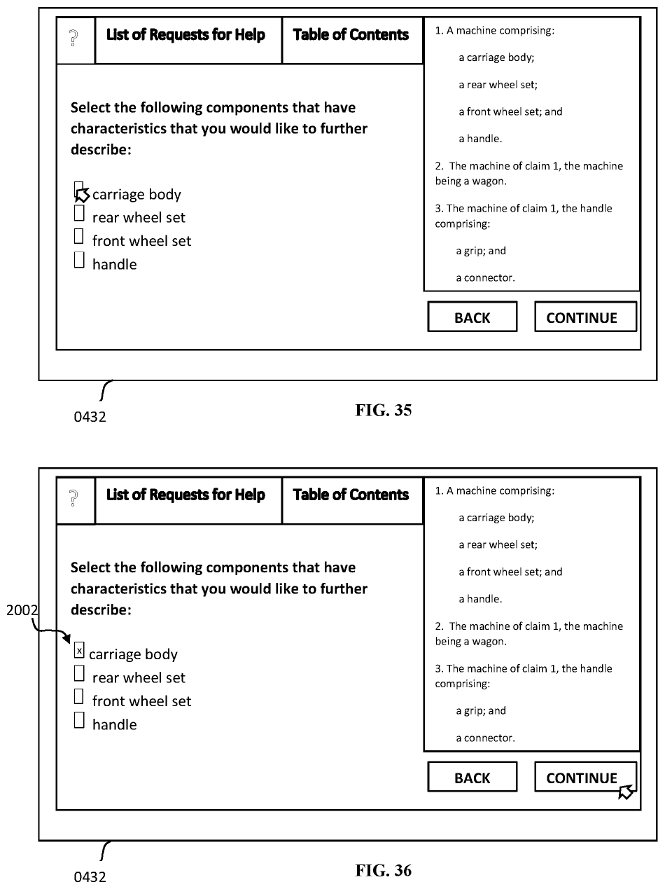

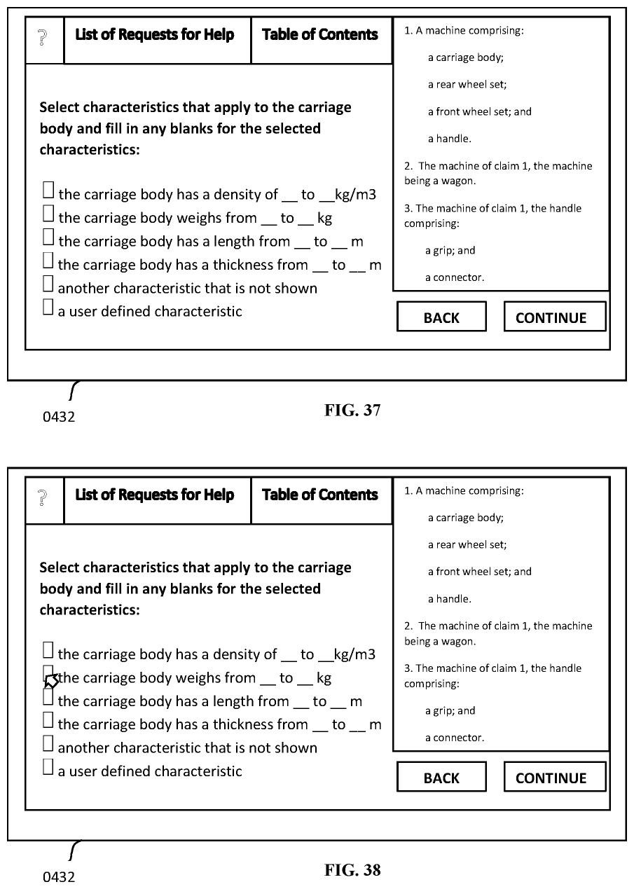

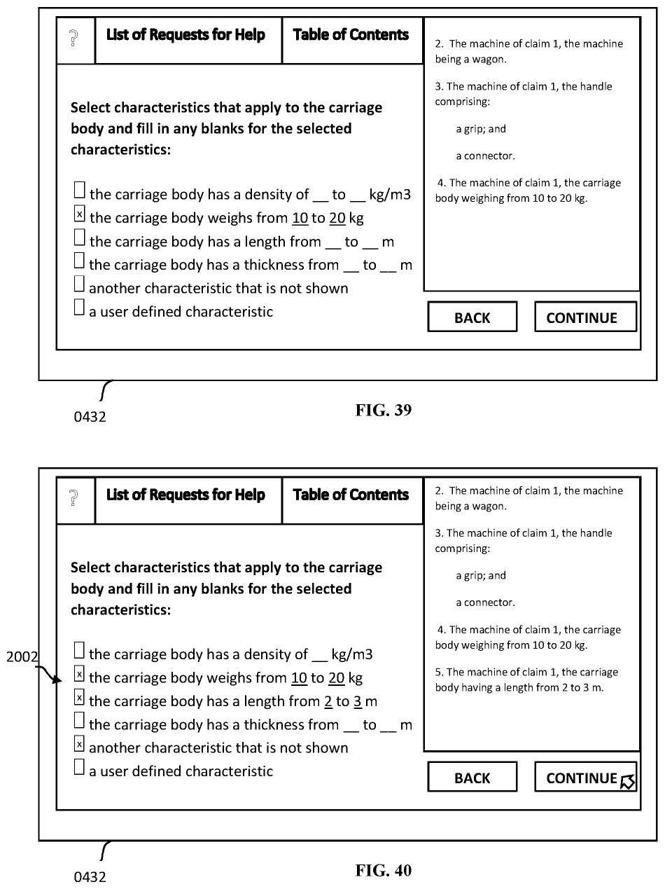

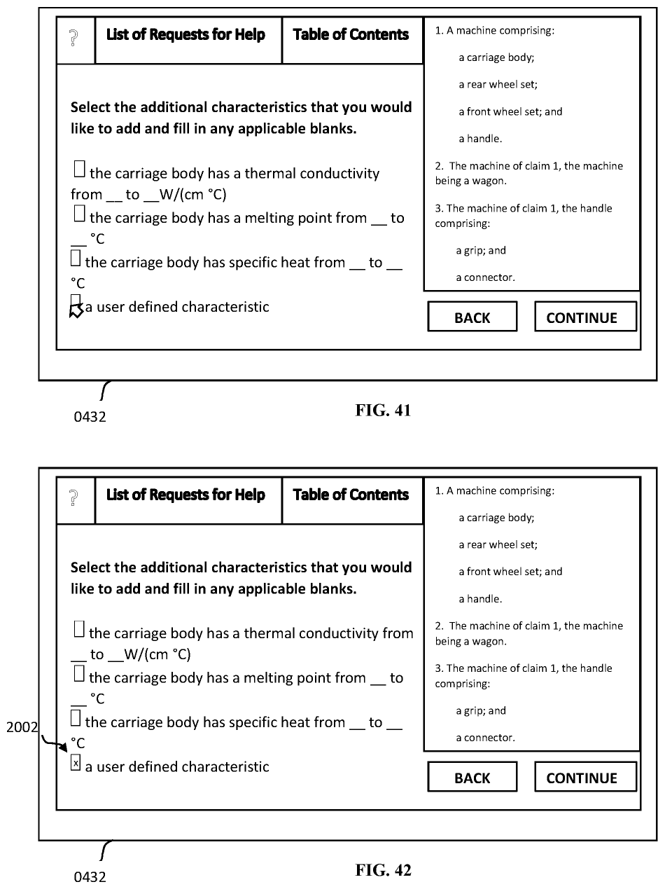

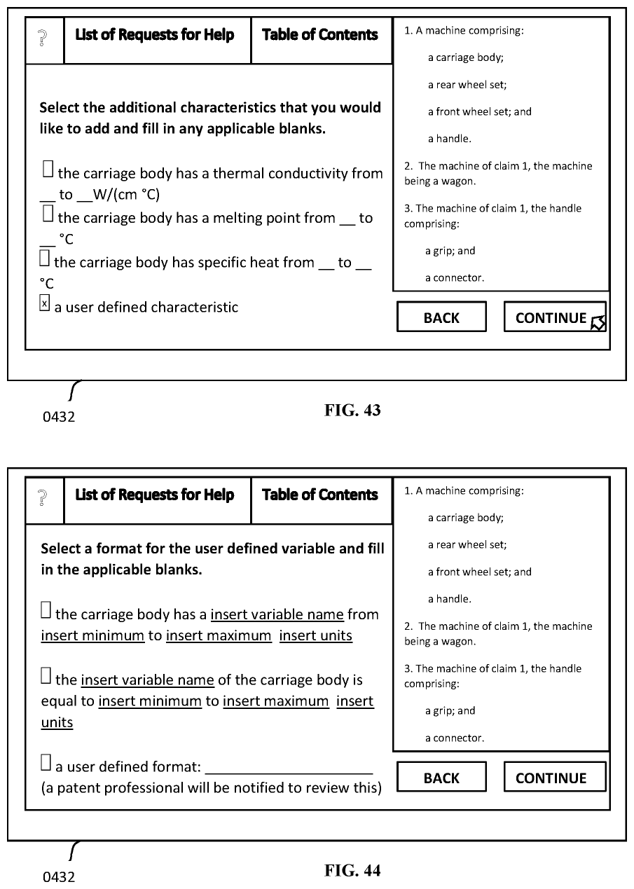

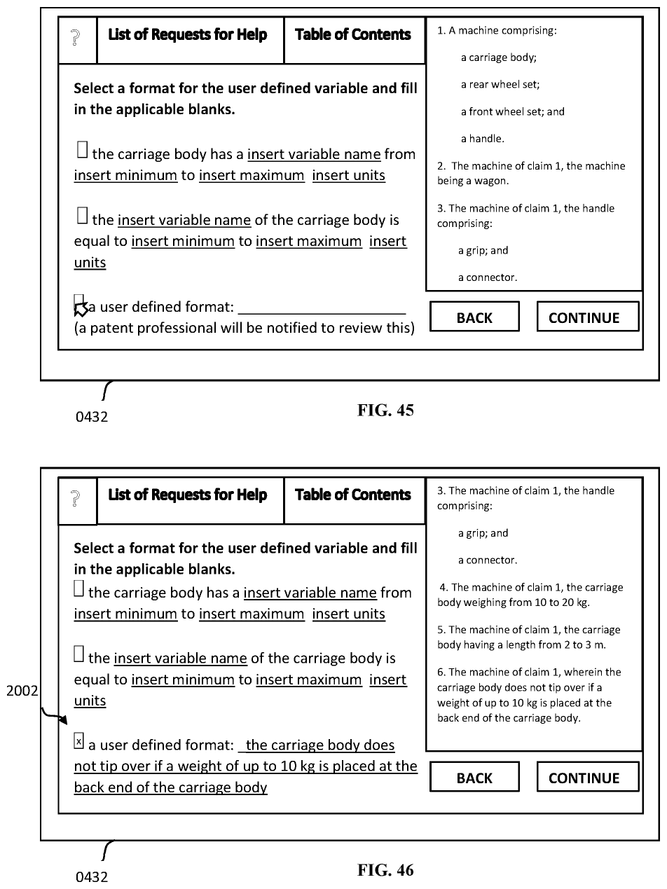

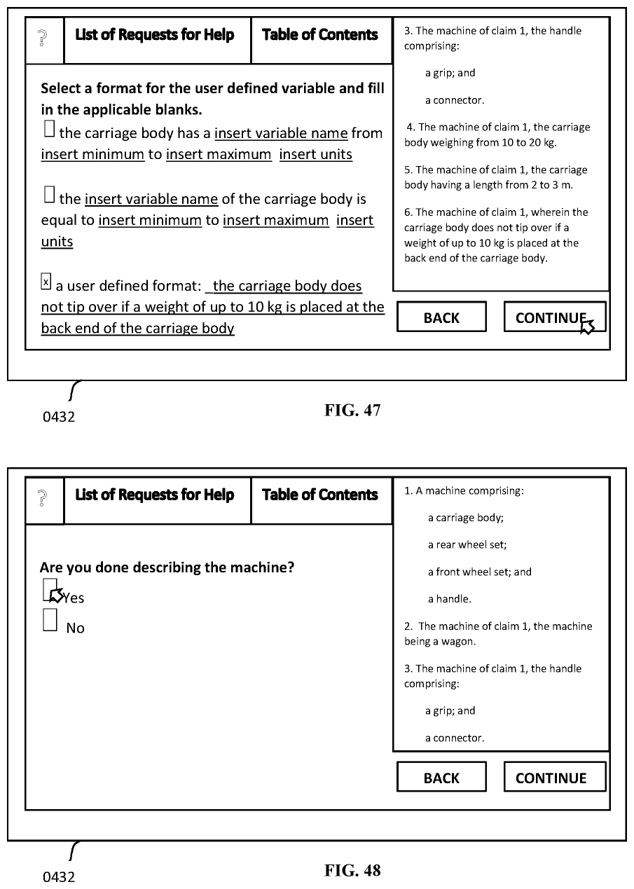

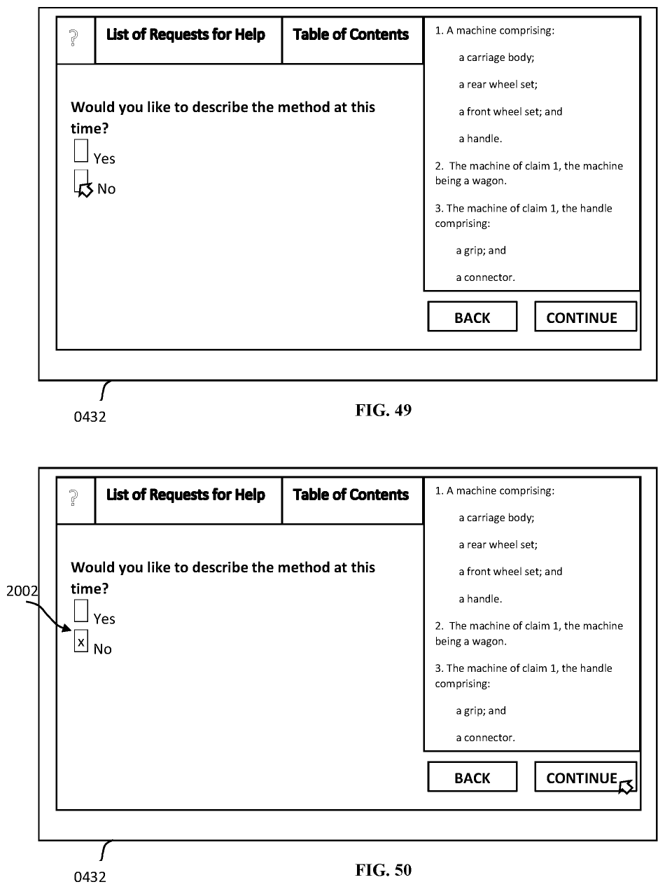

A third step comprises the computer 0418 using the user input 2002 to draft 0112 at least a portion of a patent application (e.g., a claim) describing at least one invention, the user input 2002 comprising at least one element of an invention of the at least one invention. FIGS. 6 to 20 provide an example of how a claim of a patent application can be created from user input.

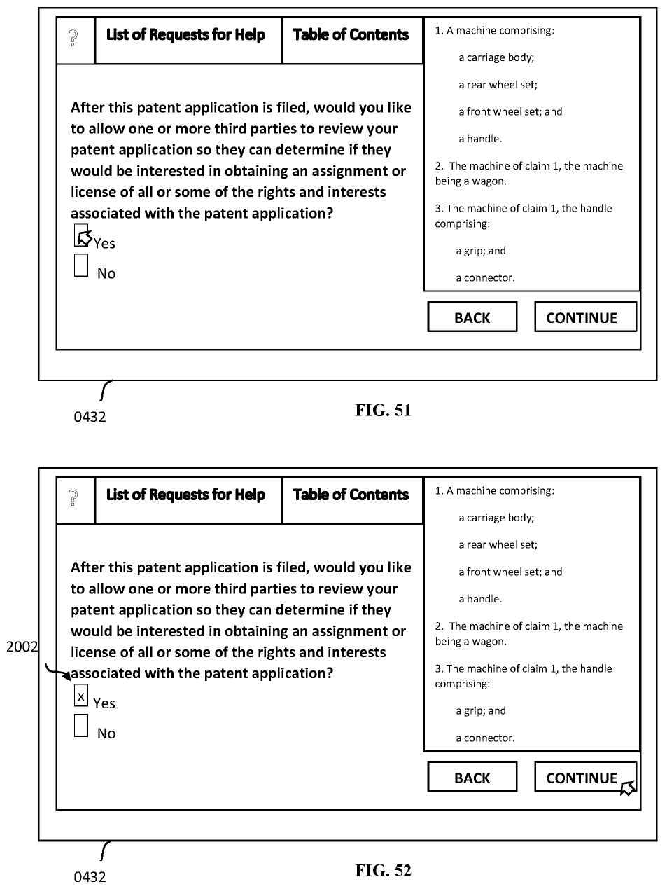

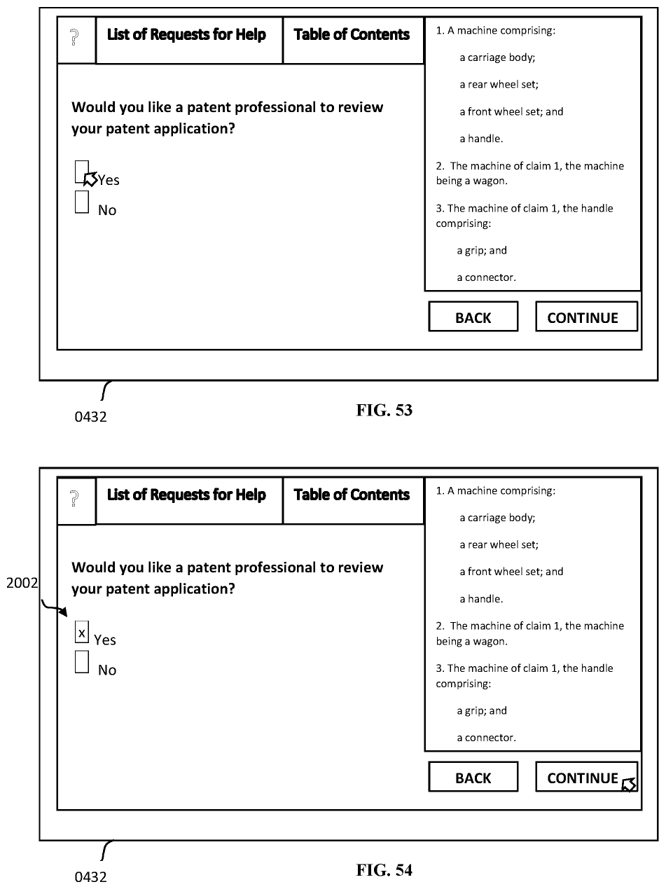

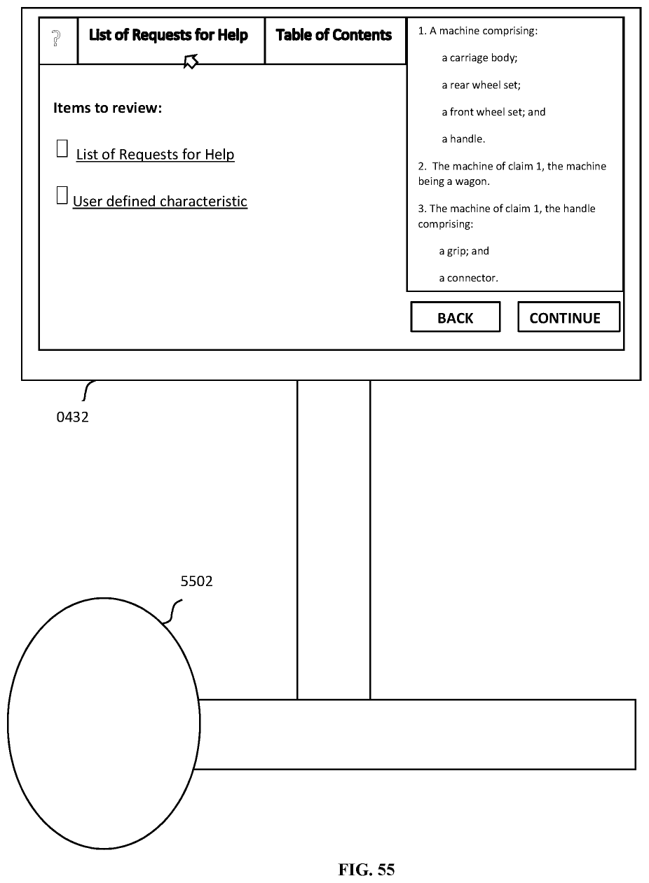

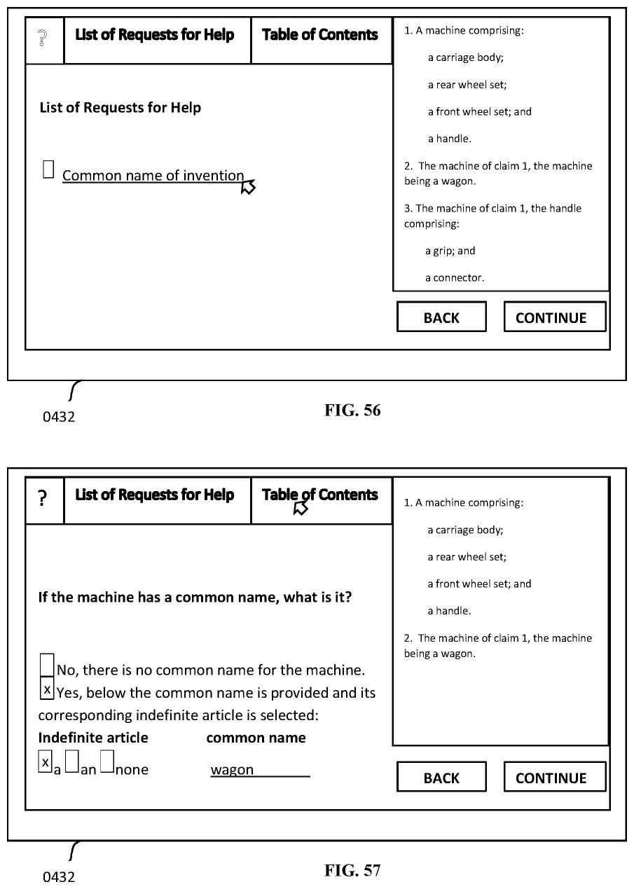

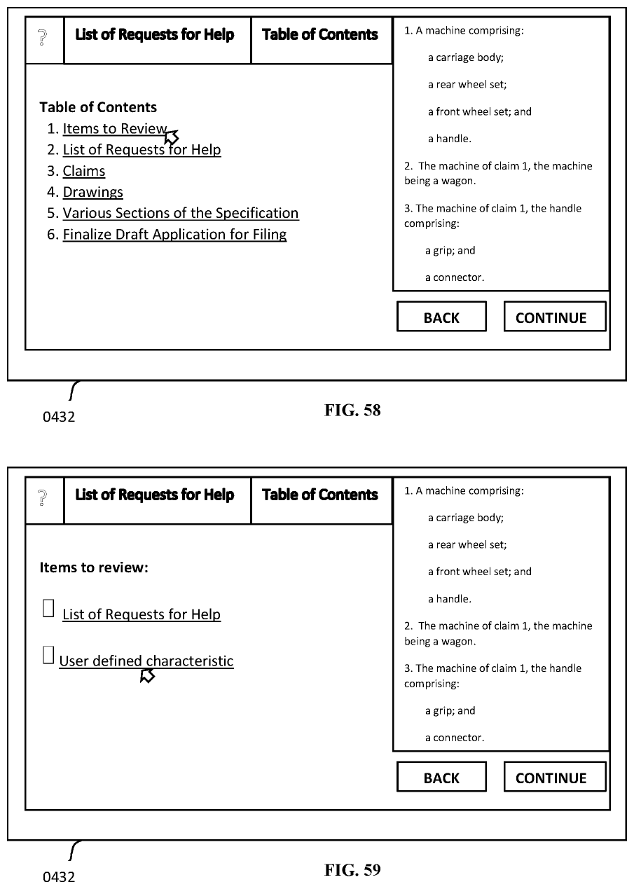

These method 0100 steps can be employed with various options. In a first option, the method 0100 can be a method 0100 of using the system 0416 for drafting 0112 at least a portion of a patent application and receiving 0115 an indication regarding whether a user 0602 desires to notify at least one third party. For example, the user input 2002 can comprise a third-party indication, the third-party indication indicating whether the user 0602 desires at least one third party to be notified of the existence of the patent application. FIGS. 6 to 20 provide an example of how at least a portion of a patent application (e.g., a claim) can be created from user input. FIGS. 51 to 52 provide an example of a system receiving 0115 an indication regarding whether a user 0602 desires to notify at least one third party.

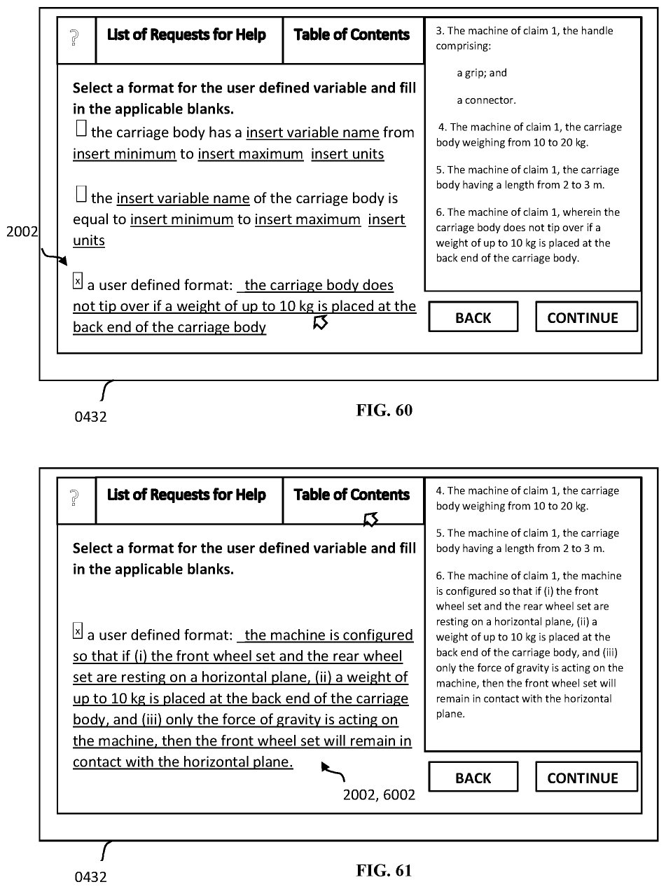

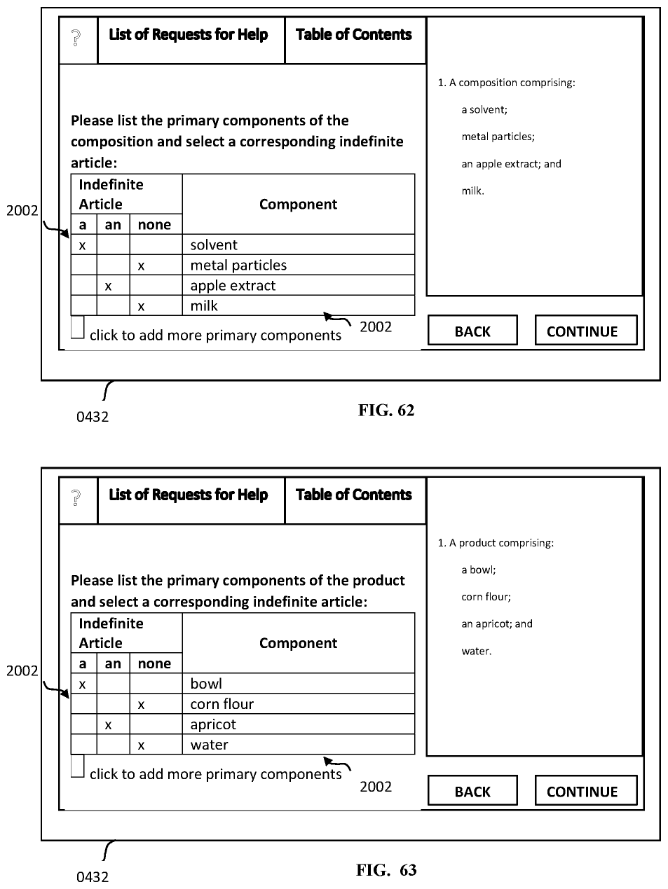

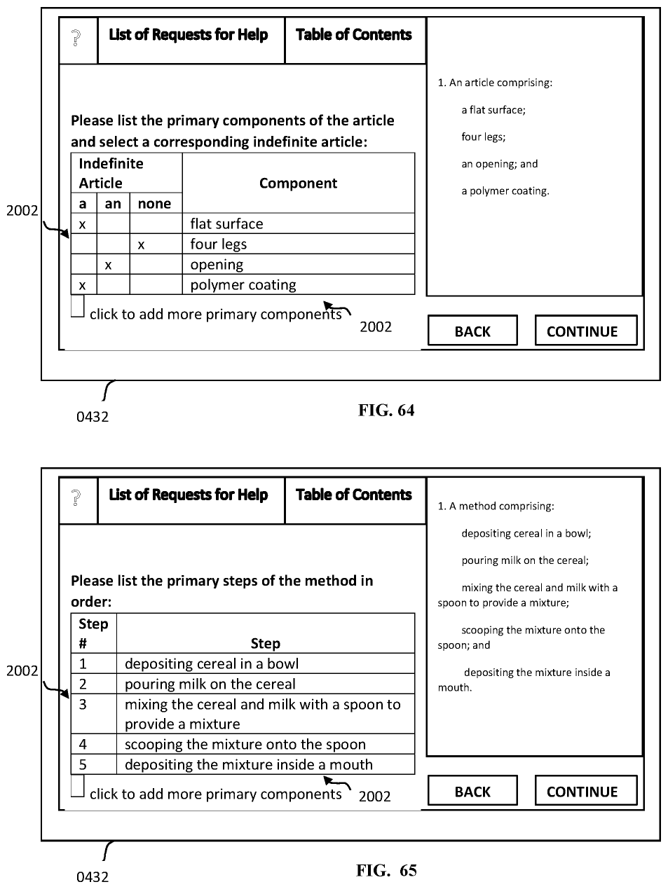

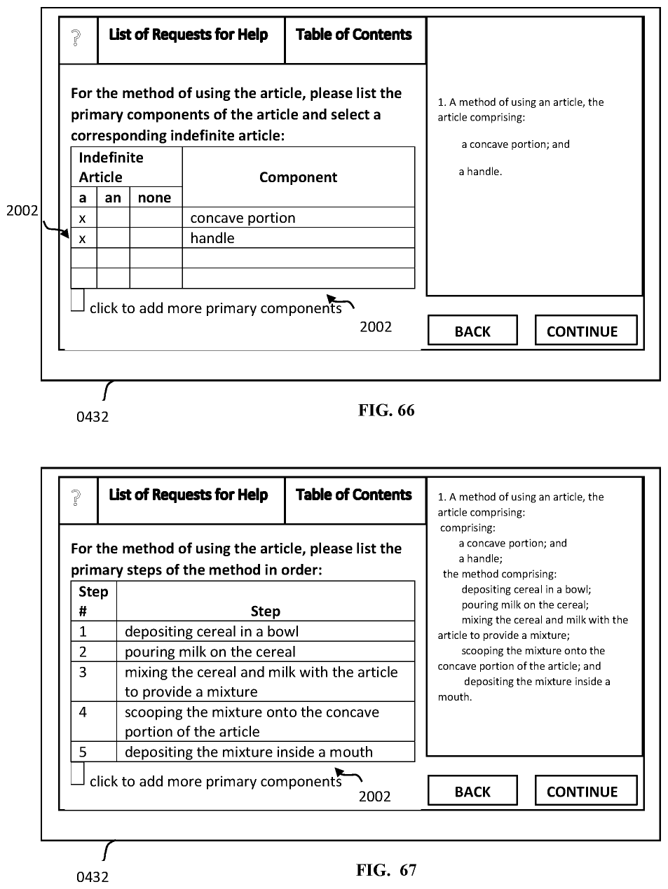

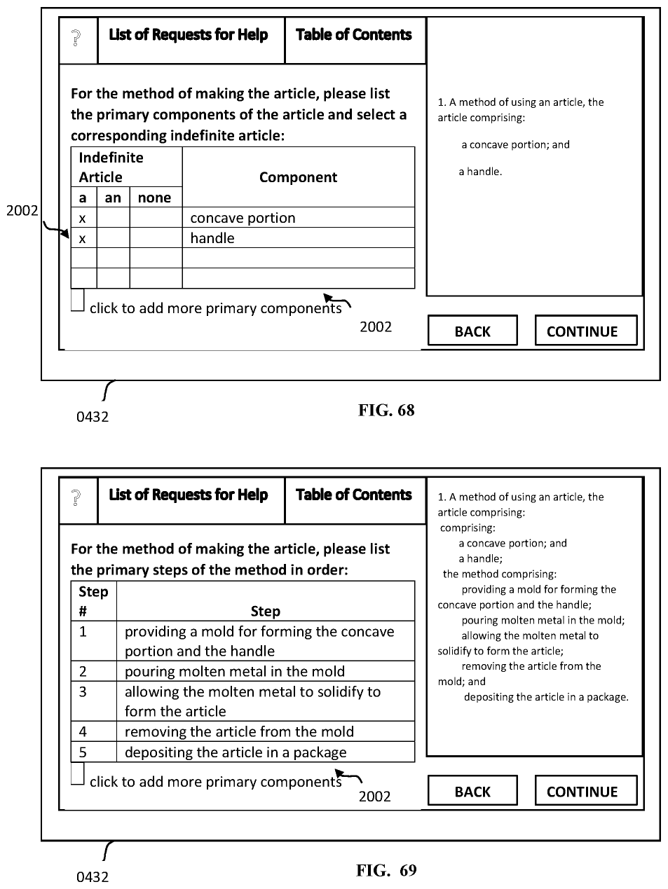

In a second option, the method 0100 can be a method 0100 of using the system 0416 for drafting at least a portion of a patent application. Additionally, the prompting the user 0602 to provide user input 2002 can comprise prompting the user 0602 to provide the user input 2002 in a format that can be converted into a portion of the application without any further user input 2002. FIGS. 6 to 20 and 60-69 provide examples of how a system can prompt the user 0602 to provide the user input 2002 in a format that can be converted into a portion of the application without any further user input 2002.

In a third option, the method 0100 can be a method 0100 of using the system 0416 for drafting a patent application. Additionally, the prompting the user 0602 to provide user input 2002 can comprise displaying a portion of the patent application that is created by the system 0416 using the user input 2002. FIGS. 14 to 20 provide an example of how a system can display a portion of a patent application (e.g., a claim) that is created by the system 0416 using the user input 2002. As illustrated, in some embodiments, the user input can be immediately or almost immediately displayed as a portion of the patent application so that a user can understand how the portion of the patent application will appear as a result of the user input, and optionally change the user input if such a change seems appropriate to the user.

In a fourth option, the method 0100 can be a method 0100 of using the system 0416 for obtaining a patent application disclosure from a remote user interface 0420, the user interface 0420 being located remotely from the computer 0418. FIG. 5 provides an example of how a system can provide a user interface 0420, which user interface can be located with the computer 0418 or remotely relative to the computer 0418. Examples of a user interface being located with the computer include the user interface being adjacent to the computer, in the same room as the computer, or less than 3, 2, or 1 meters from the computer, or any combination thereof. Examples of a user interface being located remotely from the computer include the user interface being in a location that is not with the computer, the user interface being in a different room from the computer, at least 3, 5, 10, 20, 30, 40, 50, 100, 200, 300, 400, 500, 1000, 1500, or 2000 meters away from the computer, in a different city than the computer, in a different county than the computer, in a different province than the computer, in a different state than the computer, in a different political subdivision or governmental subdivision of a country or state than the computer, in a different continent than the computer, in communication with the computer via a network, in communication with the computer via the internet, anywhere on Earth, anywhere that the user interface 0420 can be in communication with the computer, or any combination thereof.

As a skilled person would understand upon reading this disclosure, various advantages can be associated with fewer steps, additional steps, combinations of steps, or orderings of steps as described in this disclosure. Accordingly, this application provides several additional illustrative (i.e., non-limiting) examples of methods 0100 according to the present disclosure.

With reference again to FIG. 1, a method for obtaining patent-related user input and taking at least one step to obtain a bid for an assignment or a license is illustrated. The method can comprise several steps.

A first step comprises providing 0102 a user interface to permit the user to provide patent-related user input (e.g., a patent application, at least a portion of a patent application, application information, patent, at least a portion of a patent, or any combination thereof).

A second step comprises prompting 0104 the user to provide the patent-related user input.

A third step comprises receiving 0106 the patent-related user input.

A fourth step comprises encrypting 0110 the patent-related user input.

A fifth step comprises drafting 0112 at least a portion of a patent application using the patent-related user input.

A sixth step comprises prompting 0114 the user to provide a third-party indication (e.g., whether the user desires to select at least one third-party to be notified of or provided access to the patent application so that the third party can review the patent application after the step of filing the patent application.)

A seventh step comprises receiving 0115 the third-party indication.

An eighth step comprises receiving 0116 a filing indication that a patent application corresponding to the patent-related user information has been filed.

A ninth step comprises providing 0118 the at least one third party with released information corresponding to the patent-related user input or patent application.

A tenth step comprises taking 0120 at least one step to obtain a bid for an assignment or a license of all or any of the rights or interests associated with the patent-related user input or patent application from the at least one third party.

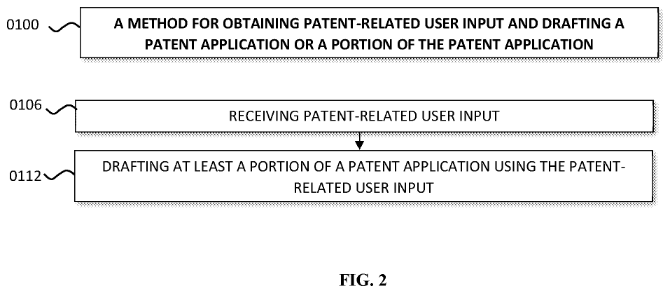

With reference now to FIG. 2, a method for obtaining patent-related user input and drafting a patent application or a portion of the patent application is illustrated. The method can comprise several steps.

A first step comprises receiving 0106 the patent-related user input.

A second step comprises drafting 0112 at least a portion of a patent application using the patent-related user input.

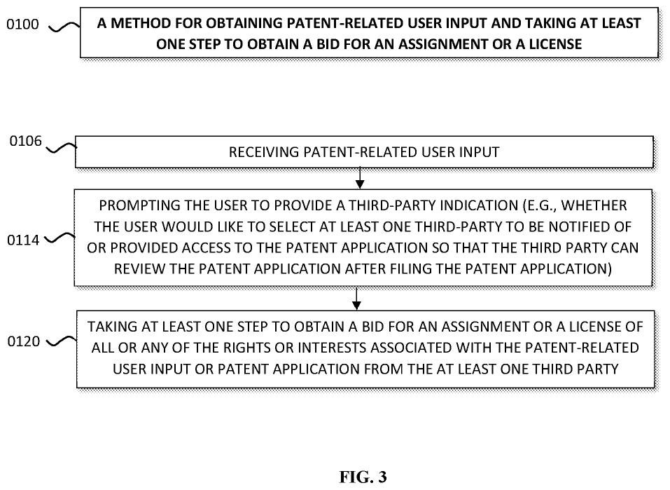

With reference now to FIG. 3, a method for obtaining patent-related user input and taking at least one step to obtain a bid for an assignment or a license is illustrated. The method can comprise several steps.

A first step comprises receiving 0106 the patent-related user input.

A second step comprises prompting 0114 the user to provide a third-party indication (e.g., whether the user desires to select at least one third-party to be notified of or provided access to the patent application so that the third party can review the patent application after the step of filing the patent application.)

A third step comprises taking 0120 at least one step to obtain a bid for an assignment or a license of all or any of the rights or interests associated with the patent-related user input or patent application from the at least one third party.

Additional features and options for a method and/or system of this disclosure are illustrated throughout FIGS. 1 to 69. Nonetheless, the embodiments illustrated in the Figures are only illustrative, not limiting. Using this disclosure for reference, a skilled person would understand that many different modifications of the expressly disclosed embodiments are possible. For example, any method step or combination of method steps described in this disclosure can be omitted from or added to any of the methods described in this disclosure to create additional methods. Additionally, the order of a step in any method can be swapped with another step or otherwise reordered to create additional embodiments.

Moreover, any step or combination of steps of a method described in this disclosure can be repeated one, two, three or any number of times. Since any method can involve performing a second step or steps similar to a first step previously described with reference to the method, every element described with reference to the first method, can be considered a first element of the kind described. For example, user input can be a first user input, a selected location can be a first selected location, a selected indefinite article can be a first indefinite article, an indication can be a first indication, a positional indication can be a first positional indication, or any combination thereof. Additionally, because the steps or a selection of steps can be performed any number of times in any order, subsequent performance of a step that has previously been performed can be given a name indicating that the step is one of several steps, for example, the name can include “subsequent,” “additional,” “second,” “third,” “fourth,” “fifth,” “sixth” or any other appropriate designation relating to number or order or both number and order.

Moreover, as a skilled person would understand upon reading this disclosure, there are many suitable options for accomplishing the steps of the methods described in this disclosure. With reference to FIGS. 4 and 5, any step described in this application can occur via any system described in this disclosure, any component or combination of components of a system described in this disclosure, any computer 0418 described in this disclosure, any combination of the computers 0418 described in this disclosure, any user interface described in this disclosure, any component of a user interface described in this disclosure, any combination of the components of a user interface described in this disclosure, or any combination thereof. By way of example, components that can be included in a user interface 0420 include, but are not limited to, the image display 0432 (e.g., monitor, touchscreen), a controller for a visible location selector (e.g., a controller, a controller for a cursor, a controller for an arrow, a mouse 0430, a joystick, a key, a keyboard 0424, a touch pad, a touch screen, a sensor to detect movement of a user, or any combination thereof) a keyboard 0424, a sound detector 0426 (e.g., microphone), a sound maker 0422 (e.g., speaker), a virtual reality system, a virtual reality headset, a head mounted display, a sensor, a vibrator, a robot, a light detector 0434 (e.g., camera), or any combination thereof.

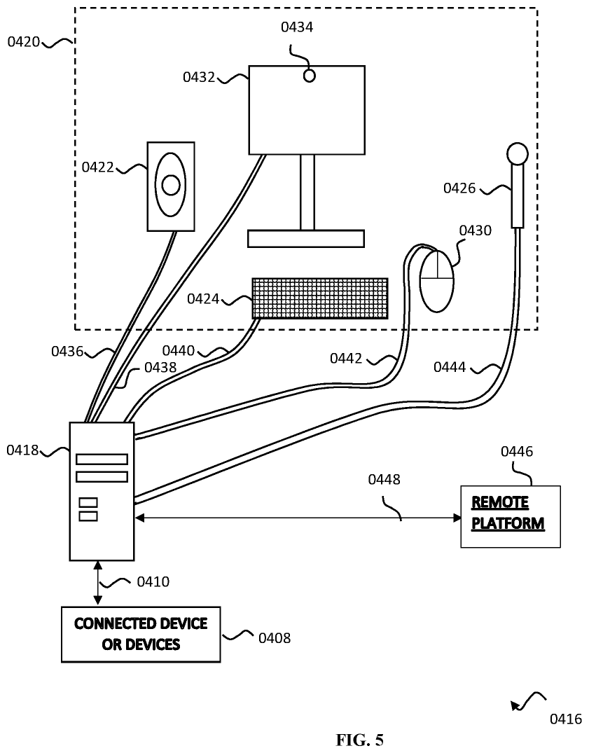

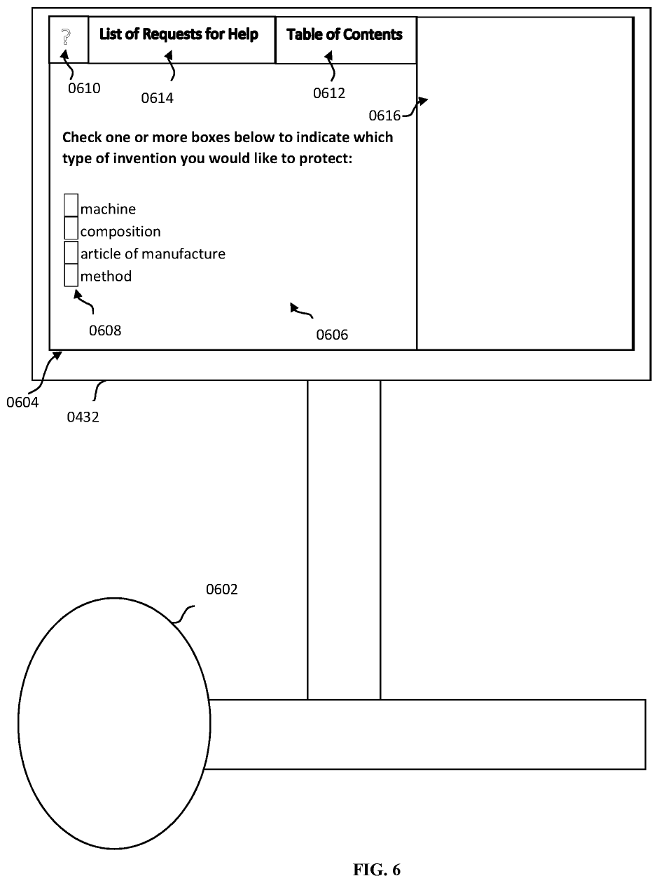

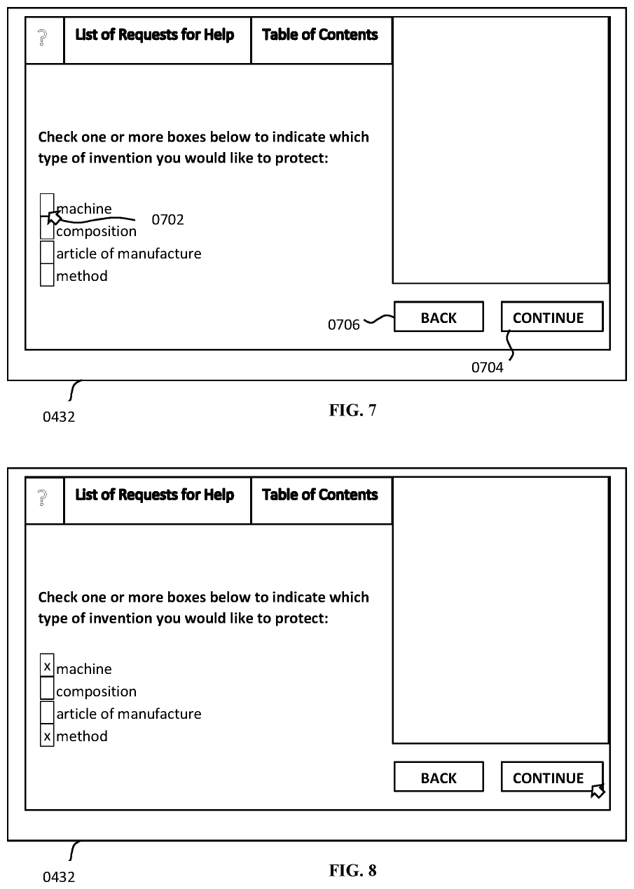

FIG. 7 provides examples of how, for example, a user can use a mouse to position a location indicator (e.g., arrow or cursor) over an image displayed on an image display, the image comprising a user prompt. FIGS. 7 and 8 provide examples of how, for example, by clicking a button on the mouse or touching a touch screen of the image display, user input can be provided to the system and the system can display the user input or a portion of the user input on the image display.

In addition to using a mouse, touch screen, or touch pad, many other options for selecting an image are possible. For example, the images can be assigned numbers or letters or combinations thereof. Thus, even if a user prompt is displayed on an image display, a user can speak or push a key or combination of keys on a keyboard to select a desired image.

In some embodiments, the user interface (e.g., an input device of the user interface) can comprise a controller for the visible location selector that allows the user to move the visible location selector over a selected location on the image display.

Selecting an indefinite article or no indefinite article for a word or group of words can be accomplished in many ways. An illustration of is provided in FIG. 14 and FIG. 15. This could be done, for example, by allowing the user to select a box, a two-way switch for each indefinite article, or a three-way switch which can only be used to select one of “a,” “an” or no indefinite article, or another switch that can only be used to select one of three or more possible indefinite articles. Of course, various options are available, especially for languages having additional indefinite articles or additional conjugations for indefinite articles. As another example, a user could press a key or combination of keys to identify a specifically selected indefinite article, and this could occur while a plurality of labels from which to select the specifically selected label is or is not displayed to the user on the image display. As an additional option, the user could be allowed to identify (e.g., by touching or using a mouse to click) any portion of an indefinite article label corresponding to an indefinite article to be selected.

Any method, step or portion of a step described herein can comprise allowing the user to move a visible location selector (e.g. cursor or arrow) over a selected location on an image (e.g., user prompt) or plurality of images (e.g., user prompts) that is displayed on the image display 0432. An example of the visible location selector is provided in FIG. 14. Optionally, the user interface (e.g., an input device of the user interface) comprises a controller for the visible location selector that allows the user to move the visible location selector over a selected location on the image display.

Any method, step or portion of a step described herein can comprise giving the user an opportunity to skip responding to a user prompt or to indicate that a user has finished responding to a user prompt, for example, when it may not otherwise be evident that the user has finished responding to the user prompt.

With respect to creating or drafting a patent application or a portion of a patent application from user input, a skilled person reading the present disclosure would understand that this step can be accomplished in many ways. Various examples of existing systems and methods for preparing all or a portion of a patent application have already been provided in this disclosure, for example, in the Background section. Any step or any combination of steps from these examples can be combined with a step or combination of steps described in this disclosure to create additional embodiments for drafting a patent application or portion of a patent application.

In some embodiments of a method and/or system in accordance with this disclosure, the method and/or system can automatically include certain information in the patent application as a result of user input. Then, the user can be asked to provide additional user input, with the additional user input being selected based on previously received user input. Once the claims are drafted, for example, as illustrated in various examples in this disclosure, the specification can be created, for example, by re-wording some or all of the clauses of the claims into sentences following grammatical rules. However, this is not necessary.

For example, since the format of the claims will be determined by the system and/or method from the user input, the system and/or method can also directly create the specification from the user input. In either case, because the system and/or method can supply a user prompt to the user, and the user prompt can be configured to limit the response of the user to a desired format, the system and/or method can create a specification by simply inserting the user input or portions of the user input into a specification shell or template which is configured to receive the user input having the desired format.

With respect to the sections of a patent application or a shell or template for a patent application, this disclosure itself provides an example of how sections of a patent application can be combined and arranged to form a patent application and how passages of language that do not necessarily depend on a particular invention can be combined and arranged in a patent application or used in a template for a patent application.

For some portions of the application, for example, the Background section, it can be desirable to ask a user (e.g., an inventor or a patent professional entity) to type the entire section or most of the section. Nonetheless, any section or portion of a patent application can also be created after prompting a user to provide relevant user input and then inserting the user input into a shell or template. As will be evident to a skilled person upon reading this disclosure, when the user can see the pertinent section of the application on an image display as the user is providing user input in response to a user prompt, it is much easier for the system and/or method to receive the desired or expected user input (e.g., user input in a desired format) in response to a user prompt. This, in turn, can be advantageous to provide an appropriately drafted portion of a patent application.

In some embodiments, the system and/or method can be provided with default options (for example, a default template or shell for a patent application) which can be edited by a user. As an example, if a patent application template typically states: “What is claimed is:” before the claims, this language can be changed to “I claim:” or “We claim:” or something else. Similarly, if the patent application template typically includes an “additional embodiments section” additional section

### ADDITIONAL EMBODIMENTS

The following clauses are provided as further description of the present disclosure:

1. A method of using a system for drafting a patent application and receiving an indication regarding whether a user desires to notify at least one third party, optionally the system comprising a computer and a user interface, the user interface comprising an image display, the method comprising:

prompting a user (e.g., the user) to provide user input (e.g., by displaying a user prompt on the image display);

receiving the user input from the user via the user interface, optionally the computer receiving the user input from the user (e.g., via the user interface); and

using the user input to draft at least a portion of a patent application (e.g., a claim, claims, any portion or any combination of portions of a patent application described in this disclosure, or an entire patent application) describing at least one invention, optionally the computer using the user input to draft the patent application describing at least one invention;

the user input comprising at least one element of an invention of the at least one invention; and

the user input comprising a third-party indication, the third-party indication indicating whether the user desires at least one third party to be notified of the existence of the patent application, optionally the third party being an entity that is not responsible for receiving a patent application or information relating to a patent application for a patent office or a government.

2. A method of using a system for drafting a patent application, optionally the system comprising a computer and a user interface, optionally the user interface comprising an image display, the method comprising:

prompting a user to provide user input (e.g., by displaying a user prompt on the image display);

receiving the user input from the user (e.g., via the user interface), optionally the computer receiving the user input from the user via the user interface; and

using the user input to draft at least a portion of a patent application (e.g., a claim, claims, any portion or any combination of portions of a patent application described in this disclosure, or an entire patent application) describing at least one invention, optionally the computer using the user input to draft the patent application describing at least one invention;

the user input comprising at least one element of an invention of the at least one invention; and

the prompting the user to provide user input comprising prompting the user to provide the user input in a format that can be converted into a portion of the application (e.g., a claim or claims) without any further user input;

optionally wherein any additions, edits or omissions from the user input used to create the portion of the application from the user input do not require artificial intelligence;

optionally wherein any additions, edits or omissions from the user input used to create the portion of the application from the user input can be determined due the format of the user prompt and the format of the user input that the user is prompted to provide;

optionally wherein any additions, edits or omissions from the user input used to create the portion of the application from the user input can be determined as a result of the user being prompted to provide the user input in such a format that at least one addition, edit or omission (e.g., one or a combination of an addition, additions, edit, edits, omission, or any combination thereof) can always be made to the user input to provide the portion of the application (e.g., the claim or the claims), optionally without needing to change the user input apart from changing the tense of a word, optionally without needing to change any word or words input by the user (e.g., change the tense);

optionally the user input comprising a word or words inserted by a user (e.g., the user) into a blank;

optionally the user input comprising information that can be selected from a list of information;

optionally the information can be further specified via additional user input (e.g., user input inserted into a blank in the information); and

optionally the user input comprises a word or group of words and indicating whether an indefinite article corresponds to the word or group of words, and if an indefinite article corresponds to the word or group of words, which indefinite article corresponds to the word or group of words.

3. A method of using a system for drafting a patent application, optionally the system comprising a computer and a user interface, optionally the user interface comprising an image display, the method comprising:

prompting a user to provide user input (e.g., by displaying a user prompt on the image display);

receiving the user input from the user (e.g., via the user interface), optionally the computer receiving the user input from the user via the user interface; and

using the user input to draft at least a portion of a patent application (e.g., a claim, claims, any portion or any combination of portions of a patent application described in this disclosure, or an entire patent application) describing at least one invention, optionally the computer using the user input to draft the patent application describing at least one invention;

the user input comprising at least one element of an invention of the at least one invention; and

the prompting the user to provide user input comprising displaying a portion of the patent application that is created by the system using the user input, optionally the portion of the patent application comprising a claim or claims of the patent application.

4. A method of using a system for obtaining a patent application disclosure from a remote user interface, optionally the system comprising a computer and a user interface, optionally the user interface comprising an image display, the method comprising:

prompting a user to provide user input (e.g., by displaying a user prompt on the image display, optionally the user interface being located remotely from the computer, the image display being located remotely from the computer, or any combination thereof); and

receiving the user input from the user (e.g., via the user interface), optionally the computer receiving the user input from the user via the user interface;

using the user input to draft at least a portion of a patent application (e.g., a claim, claims, any portion or any combination of portions of a patent application described in this disclosure, or an entire patent application) describing at least one invention, optionally the computer using the user input to draft the patent application describing at least one invention; and

the user input comprising at least one element of an invention of the at least one invention;

optionally providing a patent professional entity located remotely from the user interface with access to the draft patent application; optionally (i) the patent professional entity located with the computer or located remotely from the computer, (ii) the patent professional entity having access to (a) a computer of the entity (optionally having the configuration of any computer described herein), (b) a user interface of the entity comprising an image display of the entity (optionally having the configuration of any user interface described herein), (c) any system described herein, (d) any component or combination of components of a system described herein, or (e) any combination thereof; optionally the computer of the entity, the user interface of the entity comprising an image display of the entity, the system, the component or combination of components of the system, or any combination thereof forming a part of the system; optionally the computer of the entity, the user interface of the entity comprising an image display of the entity, the system, the component or combination of components of the system, or any combination thereof having any configuration described herein, being in communication with or connected to any system, component of a system or combination of components of a system described herein, or any combination thereof; and

optionally prompting the patent professional entity to approve the patent application for filing, optionally prompting the patent professional entity to approve the patent application for filing with a patent office where the patent professional entity is authorized to prepare patent applications for others;

optionally filing the patent application, optionally using a system described in this disclosure, any component or combination of components of a system described in this disclosure, or any combination thereof to file the patent application.

5. A method 0100, 0200, 0300 (optionally the method of any preceding clause), the method comprising:

optionally providing 0102 a user interface that permits the user 0602 to provide user input 2002 (e.g., patent-related user input);

optionally prompting 0104 the user 0602 to provide user input 2002 (e.g., patent-related user input);

optionally receiving 0106 user input 2002 (e.g., patent-related user input, the patent-related user input 2002; optionally the patent-related user input 2002 comprising preliminary invention disclosure information from a or the user 0602 (e.g., inventor, applicant, client or potential client), a patent application, portion of a patent application, application information, patent, portion of a patent, patent information or any combination thereof) from a or the user 0602;

optionally the user input 2002 (e.g., patent-related user input) comprises a preliminary invention disclosure, a patent application, a portion of a patent application, application information, a patent, a portion of a patent, patent information, any information related to a patent, any information related to obtaining a potential patent, or any combination thereof;

optionally encrypting 0110 the user input 2002 (e.g., patent-related user input) (e.g., any component of the user input 2002 (e.g., patent-related user input), any combination of components of the user input 2002 (e.g., patent-related user input), a patent application, portion of a patent application, application information, patent, portion of a patent, patent information or any combination thereof), optionally to protect the user input 2002 (e.g., patent-related user input) while the user input 2002 (e.g., patent-related user input) is stored or communicated from one system or component of a system to another system or component of a system;

optionally drafting 0112 a patent application or portion of a patent application using the user input 2002 (e.g., patent-related user input), optionally directly from the user input 2002 as opposed to, for example, receiving claims from the user and using the claims to draft at least a portion of a patent application (e.g., a claim, claims, any portion or any combination of portions of a patent application described in this disclosure, or an entire patent application);

optionally prompting 0114 the user 0602 to provide a third-party indication, the third-party indication indicating (i) whether the user desires to select the identity, identities, class-related characteristic, class-related characteristics, number or any combination thereof of at least one third-party to be provided access to the user input 2002 (e.g., patent-related user input) or patent application so that the third party can review the user input 2002 (e.g., patent-related user input) or patent application, optionally before the user input 2002 or patent application is published (e.g., by a patent office) or made available to the public indiscriminately; (ii) whether the user desires at least one third party (e.g., a single third party, at least two third parties, or a plurality of third parties) to be notified of the existence of the user input 2002 (e.g., patent-related user input) or patent application or information related to the user input 2002 (e.g., patent-related user input) or patent application (e.g., field of the invention, title, claims, any information contained in the user input 2002 (e.g., patent-related user input) or patent application or meta data related to the user input 2002 (e.g., patent-related user input) or patent application (e.g., the inventor, the applicant, number of pages, number of drawings, filing date, or any combination thereof), (iii) whether the user desires at least one third party to be provided with access to the user input 2002 (e.g., patent-related user input) or patent application so that the third party can review the user input 2002 (e.g., patent-related user input) or patent application, (iv) whether the user desires the entire public to be provided with information related to or access to the user input 2002 (e.g., patent-related user input) or patent application, (v) whether the user desires to limit access to the application or information related to the application to a specific selection of at least one third party (for example, in exchange for being able to use any method and/or system described in this disclosure, in exchange for a lower filing fee, or any combination thereof), (vi) whether the user desires at least one third party to bid for an assignment or a license of all or any of the rights or interests associated with the user input 2002 (e.g., patent-related user input) or patent application, or (vii) any combination thereof;

optionally receiving 0115 a third-party indication (e.g., the third-party indication), the third-party indication indicating (i) whether the user desires to select the identity, identities, class-related characteristic, class-related characteristics, number or any combination thereof of at least one third-party to be provided access to the user input 2002 (e.g., patent-related user input) or patent application so that the third party can review the user input 2002 (e.g., patent-related user input) or patent application, optionally before the user input 2002 or patent application is published (e.g., by a patent office) or made available to the public indiscriminately; (ii) whether the user desires at least one third party (e.g., a single third party, at least two third parties, or a plurality of third parties) to be notified of the existence of the user input 2002 (e.g., patent-related user input) or patent application or information related to the user input 2002 (e.g., patent-related user input) or patent application (e.g., field of the invention, title, claims, any information contained in the user input 2002 (e.g., patent-related user input) or patent application or meta data related to the user input 2002 (e.g., patent-related user input) or patent application (e.g., the inventor, the applicant, number of pages, number of drawings, filing date, or any combination thereof), (iii) whether the user desires at least one third party to be provided with access to the user input 2002 (e.g., patent-related user input) or patent application so that the third party can review the user input 2002 (e.g., patent-related user input) or patent application, (iv) whether the user desires the entire public to be provided with information related to or access to the user input 2002 (e.g., patent-related user input) or patent application, (v) whether the user desires to limit access to the application or information related to the application to a specific selection of at least one third party (for example, in exchange for being able to use any method and/or system described in this disclosure, in exchange for a lower filing fee, or any combination thereof), (vi) whether the user desires at least one third party to bid for an assignment or a license of all or any of the rights or interests associated with the user input 2002 (e.g., patent-related user input) or patent application, or (vii) any combination thereof;

optionally the third party is not an agent of a patent office or government acting on behalf of the patent office or government;

optionally the third party is not an entity responsible for receiving a patent application or information relating to patent applications for a patent office or a government;

optionally the third party is a private entity (e.g., company or individual human;

optionally the step of prompting 0114 the user 0602 to provide a third-party indication occurs before a patent application (e.g., finalized patent application) corresponding to the user input 2002 (e.g., patent-related user input) is filed with a patent office, after the patent application (e.g., finalized patent application) is filed with a patent office, or any combination thereof;

optionally receiving 0116 a filing indication indicating that a patent application corresponding to the patent-related user information the has been filed with the patent office;

optionally providing 0118 the at least one third party with released information (e.g., user-approved information, third-party requested information, or any combination thereof) corresponding to the user input 2002 (e.g., patent-related user input) or patent application;

optionally providing 0118 the at least one third party with released information comprises forwarding the patent application or portion of a patent application to a patent professional entity (e.g., entity employing or comprising patent professionals, firm, partnership, law firm, patent agent, patent agents, patent attorney, patent attorneys, paralegal, paralegals or combination thereof) to finalize the patent application or portion of the patent application to provide a finalized patent application, file the patent application or finalized patent application, or any combination thereof;

optionally the released information comprising the user input 2002 (e.g., patent-related user input), a portion of the user input 2002 (e.g., patent-related user input), information created using the user input 2002 (e.g., patent-related user input), meta data regarding the user input 2002 (e.g., patent-related user input), a patent application, a portion of the patent application, information created using the patent application, meta data regarding the patent application, or any combination thereof;

optionally the providing 0118 the at least one third party with the released information comprising (i) providing at least one third party (e.g., the at least one third party, a single third party, at least two third parties, a plurality of third parties) with access to the user input 2002 (e.g., patent-related user input) or patent application, (ii) notifying (e.g., providing a notification to) at least one third party (e.g., the at least one third party) of the existence of the user input 2002 (e.g., patent-related user input) or patent application or information related to the user input 2002 (e.g., patent-related user input) or patent application, (iii) providing at least one third party (e.g., the at least one third party) with access to the user input 2002 (e.g., patent-related user input) or patent application, (iv) providing at least one third party (e.g., the at least one third party) with access to the user input 2002 (e.g., patent-related user input) or patent application so that the third party can review the user input 2002 (e.g., patent-related user input) or patent application, (v) providing the entire public with information related to or access to the user input 2002 (e.g., patent-related user input) or patent application, (vi) taking at least one step to obtain a bid for an assignment or a license of all or any of the rights or interests associated with the user input 2002 (e.g., patent-related user input) or patent application (e.g., patent application or patent corresponding to the user input 2002 (e.g., patent-related user input)) from at least one third party (e.g., the at least one third party), or (vii) any combination thereof;

optionally taking 0120 at least one step to obtain a bid for an assignment or a license of all or any of the rights or interests associated with the user input 2002 (e.g., patent-related user input) or patent application (e.g., patent application or patent corresponding to the user input 2002 (e.g., patent-related user input)) from at least one third party (e.g., the at least one third party);

optionally the taking 0120 the at least one step to obtain the bid comprising (i) providing at least one third party (e.g., the at least one third party, a single third party, at least two third parties, a plurality of third parties) with access to the user input 2002 (e.g., patent-related user input) or patent application, (ii) notifying (e.g., providing a notification to) at least one third party (e.g., the at least one third party) of the existence of the user input 2002 (e.g., patent-related user input) or patent application or information related to the user input 2002 (e.g., patent-related user input) or patent application, (iii) providing at least one third party (e.g., the at least one third party) with access to the user input 2002 (e.g., patent-related user input) or patent application, (iv) providing at least one third party (e.g., the at least one third party) with access to the user input 2002 (e.g., patent-related user input) or patent application so that the third party can review the user input 2002 (e.g., patent-related user input) or patent application, (v) providing the entire public with information related to or access to the user input 2002 (e.g., patent-related user input) or patent application, (vi) soliciting (e.g., requesting) a bid for an assignment or a license of all or any of the rights or interests associated with the user input 2002 (e.g., patent-related user input) or patent application (e.g., patent application or patent corresponding to the user input 2002 (e.g., patent-related user input)) from at least one third party (e.g., the at least one third party), (vii) providing at least one third party (e.g., the at least one third party) with the ability to bid for an assignment or a license of all or any of the rights or interests associated with the user input 2002 (e.g., patent-related user input) or patent application (e.g., patent application or patent corresponding to the user input 2002 (e.g., patent-related user input)), (viii) obtaining bid information related to a bid (e.g., a bid or information related to a bid, potential bid or conditional bid) from at least one third party (e.g., the at least one third party) for an assignment or a license of all or any of the rights or interests associated with the user input 2002 (e.g., patent-related user input) or patent application, (ix) communicating (e.g., to the user) bid information related to a bid from at least one third party (e.g., the at least one third party) for an assignment or a license of all or any of the rights or interests associated with the user input 2002 (e.g., patent-related user input) or patent application, optionally the communicating comprising displaying the bid information on an image display 0432 (e.g., the image display 0432), or (x) any combination thereof;

optionally, the at least one third party being the entire public, being limited to a specific selection of at least one third party (for example, in exchange for being able to use any method and/or system described in this disclosure, in exchange for a lower filing fee, or any combination thereof);

optionally encrypting 0110 data (e.g., a selected portion or portions of or all of any patent-related user data, any application information, any information, any indication, any communication, or any combination thereof) that is received from a user, sent to a user, received from a third party (e.g., the at least one third party), sent to a third party (e.g., the at least one third party), stored, or any combination thereof to protect the data from unauthorized access (e.g., being accessed, read, understood, or any combination thereof by an unauthorized party), optionally while allowing the data to be read by at least one authorized party (e.g., the user, the at least one third party, a selection of the at least one third party, or any combination thereof), optionally the system and/or method is configured to encrypt the data while the data is (i) stored on a system, (ii) stored on a component of a system, (iii) communicated from one system or component of a system to another system or component of a system, or (iv) any combination thereof;

or

any combination thereof.

6. The method of any preceding clause:

wherein the method is for obtaining user input 2002 (e.g., patent-related user input), for partially drafting a patent application, for drafting a patent application, for determining information from a user 0602 regarding interest in a potential assignment or license of some or all of the rights or interests associated with a patent application, for connecting an inventor or applicant with a third party interested in the potential assignment or license of some or all of the rights or interests associated with a patent application, for connecting an inventor or applicant with a patent professional, of using a system for drafting a patent application and receiving an indication regarding whether a user (e.g., the user) desires to notify at least one third party, the system comprising a computer and a user interface, of using a system for drafting a patent application, of using a system for obtaining a patent application disclosure from a remote user interface. or any combination thereof;

wherein the method is performed by a system described in this disclosure;

7. The method 0100, 0200, 0300 of any preceding clause, the prompting the user to provide user input 2002 (e.g., patent-related user input), the drafting a patent application or portion of a patent application, or any combination thereof comprising:

optionally prompting a user 0602 to provide user input 2002 (e.g., patent-related user input, application information), optionally to a system, any component of a system, system for implementing the method, any component of a system for implementing the method, a computer, a user interface, a network, or any combination thereof) via a user interface (e.g., image display 0432), optionally the system comprising a computer, the user interface, the network, or any combination thereof, optionally prompting the user 0602 comprises displaying a visible prompt 0606 to the user 0602 on the image display 0432 (e.g., displaying an image 0604 comprising the visible prompt 0606 on the image display 0432);

optionally the prompting the user 0602 to provide user input 2002 (e.g., patent-related user input) comprises displaying a user prompt 0606 (e.g., in the form of an image 0604) on an image display 0432;

optionally the user prompt 0606, the image, or a combination thereof comprises a prompt-termination symbol (e.g. next-prompt symbol 0704, a symbolic representation indicating that a user (e.g., the user) desires to advance to a subsequent user prompt, a graphic stating “continue,” a graphic stating “skip” or a combination thereof) to provide a prompt-termination indication (e.g., next-prompt indication) indicating that a user (e.g., the user) is finished (completely, temporarily, provisionally or a combination thereof) providing user input 2002 in response to the user prompt 0606 or that the user 0602 desires to skip providing (completely, temporarily, provisionally or a combination thereof) user input 2002 in response to the user prompt 0606;

optionally the user prompt 0606, the image, or a combination thereof comprises a previous-prompt symbol 0706 (e.g., a graphic stating “back”) to provide a previous-prompt indication that a user 0602 (e.g., the user) desires to return to a previous user prompt 0606 (e.g., to provide user input 2002 in response to the previous user prompt 0606);

optionally the user prompt 0606, the image 0604, or a combination thereof comprises a table-of-contents link 0612 (e.g., a graphic stating “Table of Contents,” a graphic stating “Menu” or a combination thereof) to provide a table-of-contents indication that a user 0602 (e.g., the user) desires to view a table of contents or a menu that comprises links (e.g., graphical, clickable hyperlinks) allowing the user 0602 to navigate to various user prompts 0606 provided by the system and/or method (e.g., by touching a touchscreen at a location corresponding to any of the links or by moving a positional indicator 0702 (e.g., cursor, arrow) over any of the links and selecting the link, for example, by clicking a mouse button);

optionally the user prompt 0606, the image, the table-of-content link, or a combination thereof does not comprise (e.g., prevents the user 0602 from) being able to provide a user input 2002 for information that the program and/or system is not configured to receive (e.g., at the time, before receiving other user input 2002, or any combination thereof);

optionally the user prompt 0606 comprises a help request indicator 0902 which the user 0602 can activate (e.g. by touching a location corresponding to the help request indicator on a touch screen of the image display 0432, by using a mouse or touch pad to move a positional indicator 0702 (e.g., cursor or arrow) over a location on the image display 0432 corresponding to the help request indicator 0902 and activating the help request indicator (e.g., by pressing a button on the mouse or the touch pad), or any combination thereof), optionally the system and/or method (e.g., the user prompt displayed on the image display) will provide a further description or explanation of language (e.g., in the user prompt) corresponding to the help request indicator if the help request indicator is activated, optionally the help request indicator is located adjacent to language that the system and/or method will further describe or explain if the help request indicator is activated, optionally the help request indicator is a question mark, optionally the help request indicator is underlined text, optionally the system and/or method will further describe or explain the underlined text if the help request indicator is activated, optionally the system and/or method will stop displaying the further description or explanation of the language (e.g., in the user prompt) corresponding to the help request indicator if the help request indicator is deactivated (e.g., by pressing a deactivator (e.g., a graphic with the word “close”));

optionally the user prompt 0606 comprises an additional input indicator 0904 indicating that the user 0602 desires to provide additional input (e.g., an additional invention; additional inventions; additional components of an invention; additional subcomponents of an invention; additional characteristics, additional features, additional advantages, or any combination thereof for an invention, its components, its subcomponents, its characteristics, its features or any combination thereof) relating to the user prompt 0606;

optionally providing the user 0602 with an opportunity to provide a help request indication; optionally the system and/or method is configured so that a user 0602 (e.g., the user) can provide the system and/or method with a help request indication by pressing a help request indicator 0902, optionally the help request indicator 0902 being a part of a user prompt 0606 appearing on the image display 0432;

optionally the system and/or method can be configured so that the user 0602 can be one of a plurality of users for (e.g., authorized by the system and/or method to use, provided with a user id and password, actually using, or any combination thereof) the system and/or method, optionally the user 0602 can change, for example, from a first user (e.g., applicant, first applicant, inventor, first inventor, patent professional entity, first patent professional entity, patent agent, first patent agent, patent attorney, first patent attorney, paralegal, first paralegal, or any combination thereof) to a second user 5502 (e.g., applicant, second applicant, inventor, second inventor, patent professional entity, second patent professional entity, patent agent, second patent agent, patent attorney, second patent attorney, paralegal, second paralegal, or any combination thereof);

optionally giving a or the user 0602 (e.g., patent professional entity) an opportunity to modify the user input 2002 (e.g., any portion of the user input 2002, a selection of the user input 2002, all of the user input 2002), optionally, the giving the user 0602 (e.g., patent professional entity) the opportunity to modify the user input 2002 comprises giving the patent professional entity access to the method and/or system, any portion of the method and/or system, a table of contents, prompts to which a user 0602 (e.g., the user) has provided user input 2002, an opportunity to edit the user input 2002 previously provided, or any combination thereof;

optionally receiving a modification indication (e.g., new user input 2002, 6002) from a or the user (e.g., patent professional entity) to modify or edit the user input 2002 (e.g., any portion of the user input 2002, a selection of the user input 2002, all of the user input 2002);

optionally modifying or editing (e.g., automatically or after receiving a separate instruction from the user) the user input 2002 (e.g., after receiving a modification indication), thereby providing modified user input 2002, optionally modifying or editing information (e.g., language, data, etc.) in the application (e.g., a portion of the application or the entire application) corresponding to (e.g., comprising, being created using, derived from or any combination thereof) the modified user input 2002 to provide modified information in accordance with (e.g., consistent with, including the same edits made to, or any combination thereof) the modified user input 2002, optionally every instance of the information in the application corresponding to the modified user input 2002 is modified in accordance with the modified user input 2002;

optionally storing cross-reference data that indicates that information in the application corresponds to user input 2002;

optionally displaying user input 2002 or information derived from the user input 2002 in the application, optionally the system and/or method is configured so that changes to the user input 2002 also change the information derived from the user input 2002 that is displayed in the application;

optionally receiving user input 2002 (e.g., patent-related user input) (e.g., the user input 2002 (e.g., patent-related user input), application information, the or application information, any user input 2002 (e.g., patent-related user input) disclosed in this application, any portion of user input 2002 (e.g., patent-related user input) disclosed in this application or any combination thereof) from a user (e.g., the user) via a user interface (e.g., the user interface);

optionally the receiving user input 2002 (e.g., patent-related user input) comprises receiving a patent application, subject matter disclosed in a patent application, a patent, subject matter disclosed in a patent, or any combination thereof;

optionally using the user input 2002 (e.g., patent-related user input) to draft all or a portion of a patent application;

optionally drafting all or a portion of the patent application can comprise providing the draft patent application in a format (e.g., computer file) that can be edited (e.g., as a Microsoft® Word document) so that the user or patent professional entity can modify the document;

optionally the system and/or method are configured for drafting the application, the entire application, or a portion of the application (e.g., the specification, tile, technical field, problem, solution to the problem, background, summary of the invention, brief description of the drawings, detailed description, additional embodiments, abstract, or any combination thereof) without requiring artificial intelligence, without using artificial intelligence, without requiring methods that change the tense of a verb or gerund provided in user input 2002, without using methods that change the tense of a verb or gerund provided in user input 2002, or any combination thereof;

optionally the system and/or method are configured for drafting the application, the entire application, or a portion of the application (e.g., the specification, tile, technical field, problem, solution to the problem, background, summary of the invention, brief description of the drawings, detailed description, additional embodiments, abstract, or any combination thereof) so that any change employed in the tense of a verb or gerund can be determined without using or requiring the method and/or system to be provided with artificial intelligence;

optionally the system and/or method are configured for drafting the application, the entire application, or a portion of the application (e.g., the specification, tile, technical field, problem, solution to the problem, background, summary of the invention, brief description of the drawings, detailed description, additional embodiments, abstract, or any combination thereof) so that any change employed in the tense of a verb or gerund can be determined as a result of the verb being part of user input 2002 (e.g., pre-written user input 2002, a phrase, a sentence, a characteristic that is present or not present, a characteristic that can be toggled on or off (e.g., using a selection indicator 0608), a characteristic that can be selected by selecting a check box 0608, a phrase or sentence with a blank in it for a noun or gerund, etc.) that is selected (e.g., partially or completely selected) by the user rather than drafted (e.g., partially or completely drafted) by the user;

optionally the system and/or method are configured for drafting the application, the entire application, or a portion of the application (e.g., the specification, tile, technical field, problem, solution to the problem, background, summary of the invention, brief description of the drawings, detailed description, additional embodiments, abstract, or any combination thereof) so that any change employed in the tense of a verb or gerund can be determined as a result of the as a result of a specific tense always being appropriate for use in the application or a portion of the application due to the configuration of the wording of the language in the application or portion of the application, the language in the wording of the user prompt 0606 used to obtain the verb or gerund for which a change in tense is employed, or any combination thereof, optionally, the user prompt 0606 prompts a user (e.g., the user) to provide at least one gerund (e.g., “providing,” “receiving,” etc.) or plurality of gerunds for a method step or steps, and the application or a portion of the application is provided with language that indicates that a first step of a method comprises [first gerund], wherein [first gerund] is the first gerund of the at least one gerund, optionally the application or a portion of the application is provided with language that indicates that a second step of the method comprises [second gerund], wherein [second gerund] is the second gerund of the at least one gerund, optionally the application or a portion of the application is provided with language that indicates that a last step of the method comprises [last gerund], wherein [last gerund] is the last gerund of the at least one gerund, or any combination thereof;

optionally the drafting the patent application or a portion of the patent application comprises adding a label to an image provided by the user (e.g., a label comprising a symbolic designation (e.g. a reference number), a location indicator (e.g. a lead line) or any combination thereof);

optionally providing the user with an opportunity to provide at least one assistance indication (e.g., an assistance indication or plurality of assistance indications), the at least one assistance indication indicating that the user desires to discuss a prompt, or some other issue with the patent professional entity (e.g., to receive assistance from the patent professional entity);

optionally the step of providing the user with an opportunity to provide the at least one assistance indication occurs during or after the user has been prompted to provide the system and/or method with information (e.g., user input 2002 (e.g., patent-related user input));

optionally the step of providing the user with an opportunity to provide the at least one assistance indication comprises displaying an assistance indicator 0610 (e.g., button, check box, switch, or question mark) on the image display 0432 during or after the user has been prompted to provide the system and/or method with information (e.g., user input 2002 (e.g., patent-related user input)), the assistance indicator 0610 being configured to be activated from a deactivated configuration (e.g., indicating that no assistance is requested by the user) into an activated configuration indicating that assistance is requested by the user and deactivated from the activated configuration to a deactivated configuration indicating that no assistance is requested by the user;

optionally the system is configured to store the at least one assistance indication;

optionally the system is configured to provide an indication (e.g., key or combination of keys on a keyboard) or link 0614 (e.g., that can be activated by a user (e.g., the user), for example, with a touchscreen, touch pad, mouse, keyboard, or any combination thereof) to a list of at least one assistance request corresponding to at least one assistance indication provided by a user (e.g., the user), optionally the link is visible in an image 0604 or user prompt 0606 appearing in an image 0604 on the image display 0432; optionally the link 0614 to the at least one assistance request is in the form of a list comprising at least one entry, optionally each entry of the at least on entry being configured to be a link that can be selected to navigate a user (e.g., the user) to data (e.g., a user prompt, a plurality of user prompts, images comprising a user prompt or plurality of image prompts, any combination thereof or any data relating thereto) corresponding to an assistance indication in the at least one assistance indication provided by the user;

optionally the system is configured to communicate the at least one assistance indication to the patent professional entity;

optionally the system is configured to provide a list of assistance indications, optionally the list comprising a symbolic indication for each assistance indication in the list, thereby permitting the user or the patent professional entity to access details regarding each assistance indication in the list from the list (e.g., with one and only one action, with one action comprising touching a location on a touchscreen of the image display 0432 corresponding to the assistance indication (and thereby selecting the assistance indication), with two and only two actions, with two actions comprising moving (e.g., using a mouse or touch pad) a location indicator (e.g., arrow or cursor) over a location on an image display 0432 corresponding to the assistance indication and selecting the assistance indication (e.g., by clicking a mouse, clicking the touch pad);

or

any combination thereof.

8. The method 0100, 0200, 0300 of any preceding clause:

optionally the step of prompting the user to provide application information comprises prompting the user to provide specifically configured information;

optionally the step of prompting the user to provide specifically configured information is configured so that the computer will be able to directly insert the specifically configured information into a claim without further configuring he information;

optionally the step of prompting the user to provide specifically configured information comprises asking the user to provide a selection indication to select specific information (e.g., partially specified information, or a type of information) for inclusion in a patent application (e.g., in a claim of the patent application);

optionally the step of prompting the user to provide specifically configured information comprises asking the user to provide specifically configured information to further specify the partially specified information for inclusion in a patent application (e.g., in a claim of the patent application;

optionally the step of prompting the user to provide specifically configured information (e.g., the step of asking the user to provide a selection indication to select specific information, the step of further specifying the partially specified information, or any combination thereof) comprises prompting the user to provide a selection indication to select information for inclusion in the patent application (e.g., a claim of the patent application), optionally the selection indication requires and only requires the user to make a single selection, optionally the selection indication requires and only requires the user to take a single action (e.g., touching a touch screen) or two actions (e.g., using a mouse to move a cursor over a location corresponding to a selected location and clicking a button on the mouse to identify the selected location), optionally the selection indication requires and only requires the user to click a button on a mouse one time, click a button on a touch pad one time, or touch a touchscreen one time, optionally the selection indication requires and only requires the user to move a positional indicator 0702 (e.g., an arrow or cursor) over a location corresponding to a selected location and identifying the selected location;

optionally the step of prompting the user to provide specifically configured information (e.g., the step of asking the user to provide a selection indication to select specific information, the step of further specifying the partially specified information, or any combination thereof) comprises prompting the user to toggle a selection indicator 0608 on or off (e.g., to check or uncheck a box, to slide a switch on or off, or any combination thereof) optionally the selection indicator 0608 is displayed on the image display 0432;

optionally the step of prompting the user to provide specifically configured information (e.g., the step of asking the user to provide a selection indication to select specific information, the step of further specifying the partially specified information, or any combination thereof) comprises prompting the user to toggle a plurality of selection indicators 0608 on or off, optionally each of the plurality of selection indicators 0608 being visible on the image display 0432 simultaneously;

optionally the step of prompting the user to provide specifically configured information (e.g., the step of asking the user to provide a selection indication to select specific information, the step of further specifying the partially specified information, or any combination thereof) comprises prompting the user to insert specifically configured information (e.g., comprising at least a portion of, a selection of, or all of the application information) into a blank displayed on an image display 0432 of a user interface, optionally, the blank and any words around the blank (e.g., before the blank, after the blank, within a phrase containing the blank, within a sentence containing the blank, within a context informing a user (e.g., the user) as to the specifically configured information to be inserted in the blank, or any combination thereof) are configured (e.g., positioned, ordered, arranged, worded, conjugated, formatted, displayed, or any combination thereof) so that the user will insert the specifically configured information (e.g., a symbol, a letter, a digit, a number, a word, a phrase, a sentence, or any combination thereof) into the blank in a specified configuration so that the specifically configured information can be copied directly into a claim without having to change (e.g., change the position, order, arrangement, conjugation, format, display or any combination thereof) the specifically configured information;

optionally the step of prompting the user to provide user input comprises prompting the user to indicate whether an element of the invention (e.g., component, subcomponent, step, substep, or any combination thereof) comprises a sub-element or sub-elements (e.g., subcomponent, subcomponent of a subcomponent, substep, substep of a substep, or any combination thereof);

optionally the step of prompting the user to provide user input comprises prompting the user to provide a word or group of words (e.g., element of the invention, elements of the invention, component of an invention, components of an invention, sub-element of the invention, sub-elements of the invention, subcomponent of a component, subcomponents of a component, sub-element of a sub-element, sub-elements of a sub-element, subcomponent of a subcomponent, subcomponents of a subcomponent, or any combination thereof), optionally in a blank or blank corresponding to each word or group of words, and to select the indefinite article that applies to the word or group of words, optionally for each word or group of words the selecting the indefinite article occurring via a single user indication (e.g., one and only one user action, touching a location on a touch screen of an image display that corresponds to the selected indefinite article, two and only two user actions, moving a location indicator (e.g., an arrow or a cursor) over a location on an image display that corresponds to the selected indefinite article and selecting the indefinite article (e.g., using a mouse or a touch pad to move the location indicator and clicking a button on the mouse or touch pad to select the selected indefinite article) or any combination thereof);

optionally the step of prompting the user to provide user input comprises prompting the user to indicate whether an element of the invention, elements of the invention, sub-element of the invention, sub-elements of the invention or combination thereof (e.g., component, components, subcomponent, subcomponents, subcomponent of a subcomponent, subcomponents of a subcomponent, step, steps, substep, substeps, substep of a substep, substeps of a substep or any combination thereof) comprises or has a characteristic (e.g., a physical property (e.g., melting point, boiling point, density, viscosity, color, tensile strength, compressive strength, yield strength, hardness, phase, conductivity, or any combination thereof), a chemical property (e.g., heat of combustion, flammability, or any combination thereof), a compositional characteristic (e.g., compositional makeup by mass percentage, weight percentage, volume percentage, mole percentage, mass ratio, weight ratio, volume ratio, mole ratio, mass concentration, weight concentration, volume concentration, mole concentration, or any combination thereof), an extensive property (e.g., mass, weight, volume, moles, number, mass flow rate, weight flow rate, volumetric flowrate, molar flow rate or any combination thereof) an intensive property (e.g., temperature, pressure, volume, density, viscosity, or any combination thereof), a user-defined characteristic (e.g., property), a kinetic energy possessed or imparted, potential energy possessed or imparted, momentum possessed or imparted, force possessed or imparted, flux possessed or imparted, or any combination thereof, optionally that the user desires to select, optionally that the user desires to describe, optionally that the user desires to select (e.g., from a set of characteristics), optionally that the user desires to select (e.g., from a set of characteristics) and further specify (e.g., selecting a characteristic that includes a blank or other opportunity for a user (e.g., the user) to provide more specific input with respect to the characteristic), or any combination thereof;

optionally the user input 2002 comprises any characteristic or any combination of characteristics (e.g., any characteristic described in this disclosure or any combination of characteristics described in this disclosure) corresponding to an element of the invention, elements of the invention, sub-element of the invention, sub-elements of the invention or combination thereof (e.g., component, components, subcomponent, subcomponents, subcomponent of a subcomponent, subcomponents of a subcomponent, step, steps, substep, substeps, substep of a substep, substeps of a substep or any combination thereof);

optionally the user input comprising at least one type of invention that the user desires to describe, optionally the type of invention being selected from the group consisting of a machine, a composition, an article of manufacture, a product, a method (e.g., process), a product-by-process, a method of making something, and a method of using something;

optionally the step of prompting the user to provide user input comprises prompting the user to indicate whether an element of the invention, elements of the invention, sub-element of the invention, sub-elements of the invention or combination thereof (e.g., component, components, subcomponent, subcomponents, subcomponent of a subcomponent, subcomponents of a subcomponent, step, steps, substep, substeps, substep of a substep, substeps of a substep or any combination thereof) comprises or has an additional characteristic or plurality of additional characteristics (e.g., any characteristic described in this disclosure or any combination of characteristics described in this disclosure), the additional characteristic or plurality of additional characteristics corresponding to an element of the invention, elements of the invention, sub-element of the invention, sub-elements of the invention or combination thereof (e.g., component, components, subcomponent, subcomponents, subcomponent of a subcomponent, subcomponents of a subcomponent, step, steps, substep, substeps, substep of a substep, substeps of a substep or any combination thereof);

optionally the user input 2002 comprises a characteristic or plurality of characteristics in response to a first user prompt and an additional characteristic or plurality of additional characteristics in response to a second user prompt (e.g., any characteristic described in this disclosure or any combination of characteristics described in this disclosure), the additional characteristic or plurality of additional characteristics corresponding to an element of the invention, elements of the invention, sub-element of the invention, sub-elements of the invention or combination thereof (e.g., component, components, subcomponent, subcomponents, subcomponent of a subcomponent, subcomponents of a subcomponent, step, steps, substep, substeps, substep of a substep, substeps of a substep or any combination thereof);

optionally the user input 2002 comprises an image (e.g., figure, drawing, picture, photograph or any combination thereof);

optionally the user input 2002 comprises identifying a location on the image where a label is to be added to the image (e.g., a label comprising a symbolic designation (e.g. a reference number), a location indicator (e.g. a lead line) or any combination thereof);

optionally the user input comprises identifying an indefinite article (e.g., “a” or “an”) that applies to a word or group of words (e.g., claim element, claim term, noun, singular noun, plural noun, gerund, qualifier, adjective, adverb or a combination thereof), optionally the identifying comprises changing a symbolic representation appearing on an image display from an on configuration (e.g., an boxing comprising a “x” or “check” or a filled in circle) to an off configuration (e.g., an empty box, or empty circle) or from an off configuration (e.g., an empty box, or empty circle) to an on configuration (e.g., an boxing comprising a “x” or “check” or a filled in circle);

optionally the user input comprises indicating that no indefinite article (e.g., “a” or “an”) applies to a word or group of words (e.g., claim element, claim term, noun, singular noun, plural noun, gerund, qualifier, adjective, adverb or a combination thereof), optionally the identifying comprises changing a symbolic representation appearing on an image display from an on configuration (e.g., an boxing comprising a “x” or “check” or a filled in circle) to an off configuration (e.g., an empty box, or empty circle) or from an off configuration (e.g., an empty box, or empty circle) to an on configuration (e.g., an boxing comprising a “x” or “check” or a filled in circle);

optionally the user input comprises indicating that the indefinite article “a” is used with a word or group of words e.g., claim element, claim term, noun, singular noun, plural noun, gerund, qualifier, adjective, adverb or a combination thereof), the indefinite article “an” is used with the word or group of words, or no indefinite article is used with the word or group of words;

optionally the user input comprises inserting a word or group of words into a blank and selecting the indefinite article that applies to the word or group of words, optionally the selecting the indefinite article occurring via a single user indication (e.g., one and only one user action, touching a location on a touch screen of an image display that corresponds to the selected indefinite article, two and only two user actions, moving a location indicator (e.g., an arrow or a cursor) over a location on an image display that corresponds to the selected indefinite article and selecting the indefinite article (e.g., using a mouse or a touch pad to move the location indicator and clicking a button on the mouse or touch pad to select the selected indefinite article) or any combination thereof);

optionally the user input comprises indicating whether a user (e.g., the user) is done describing an invention;

optionally the user input comprises indicating whether a user (e.g., the user) desires to further describe a subsequent invention that was previously identified in the user input, optionally the subsequent invention is not a finally described invention (e.g., completely described invention), optionally the method and/or apparatus has received user input indicating that the user is done describing the finally described invention;

optionally the user input comprises a third-party indication, optionally the third-party indication indicating (i) whether the user desires to select the identity, identities, class-related characteristic, class-related characteristics, number or any combination thereof of at least one third-party to be provided access to the user input 2002 (e.g., patent-related user input) or patent application so that the third party can review the user input 2002 (e.g., patent-related user input) or patent application; (ii) whether the user desires at least one third party (e.g., a single third party, at least two third parties, or a plurality of third parties) to be notified of the existence of the user input 2002 (e.g., patent-related user input) or patent application or information related to the user input 2002 (e.g., patent-related user input) or patent application (e.g., field of the invention, title, claims, any information contained in the user input 2002 (e.g., patent-related user input) or patent application or meta data related to the user input 2002 (e.g., patent-related user input) or patent application (e.g., the inventor, the applicant, number of pages, number of drawings, filing date, or any combination thereof), (iii) whether the user desires at least one third party to be provided with access to the user input 2002 (e.g., patent-related user input) or patent application so that the third party can review the user input 2002 (e.g., patent-related user input) or patent application, (iv) whether the user desires the entire public to be provided with information related to or access to the user input 2002 (e.g., patent-related user input) or patent application, (v) whether the user desires to limit access to the application or information related to the application to a specific selection of at least one third party (for example, in exchange for being able to use any method and/or system described in this disclosure, in exchange for a lower filing fee, or any combination thereof), (vi) whether the user desires at least one third party to bid for an assignment or a license of all or any of the rights or interests associated with the user input 2002 (e.g., patent-related user input) or patent application, or (vii) any combination thereof;

optionally the user input comprises at least one assistance indication (e.g., an assistance indication or plurality of assistance indications), the at least one assistance indication indicating that the user desires to discuss a prompt, or some other issue with the patent professional entity (e.g., to receive assistance from the patent professional entity);

optionally the user input comprises a patent professional review indication (e.g., an indication or plurality of indications), the at least one patent professional review indication indicating that the user desires a patent professional entity to review a patent application or the user input relating to (e.g., based upon or created using) a patent application, to file a patent application relating to (e.g., based upon or created using) the user input, or otherwise assist the user with a patent application relating to (e.g., based upon or created using) the user input;

optionally the user input comprises a navigation indication from a or the user (e.g., first user, second user, patent professional entity or any combination thereof), optionally the navigation indication providing an indication that the user desires to provide user input or review previously provided user input;

optionally the user input comprises a navigation indication from a or the user (e.g., first user, second user, patent professional entity or any combination thereof), optionally the navigation request indicating that the user desires to review a list of the at least one assistance indications, user defined characteristics, or a category of user input;

optionally the user input comprises a second navigation indication from a or the user (e.g., first user, second user, patent professional entity or any combination thereof), optionally the second navigation request indicating that the user desires to review at least one assistance indication, user defined characteristic, or user input in a list of the at least one assistance indications, user defined characteristics, or a category of user input;

optionally the user input comprises a modification indication (e.g., new user input 2002, 6002) from a or the user (e.g., patent professional entity) to modify or edit the user input 2002 (e.g., any portion of the user input 2002, a selection of the user input 2002, all of the user input 2002);

optionally the user input comprises patent-related user input;

or

any combination thereof.

9. The method 0100, 0200, 0300 of any preceding clause, the method 0100, 0200, 0300 comprising:

displaying any portion of a patent application described in this disclosure to the user;

displaying at least one at least one specific claim 0906 (e.g. a specific claim, a combination of specific claims, a plurality of specific claims, or any combination thereof) to the user;

optionally the at least one specific claim 0906 is a claim created by the system using the application information;

optionally the step of displaying the at least one specific claim 0906 to the user occurs before the step of prompting the user to provide the application information to the system, during the step of prompting the user to provide the application information to the system, after the step of prompting the user to provide the application information to the system, or a combination thereof;

optionally the step of displaying the at least one specific claim 0906 to the user occurs before the step of receiving the application information from the user, during the step of receiving the application information from the user, after the step of receiving the application information from the user, or a combination thereof;

optionally the method comprises displaying at least one at least one specific claim 0906 to the user, the step of displaying at least one at least one specific claim 0906 to the user comprising the step of displaying the at least one specific claim 0906 to the user;

optionally a step of displaying at least one at least one specific claim 0906 to the user comprises displaying a plurality of specific claims to the user;

optionally the step of displaying the at least one specific claim 0906 to the user comprises displaying one and only one claim to the user;

optionally the system and/or method is configured so that the image display 0432 displays the at least one specific claim 0906, optionally at least a portion of the application information provided by the user is included in the at least one specific claim 0906 as, immediately after, or after the user provides (e.g., types or speaks) the application information, optionally so that the user can see how the application information is being used to create a claim, optionally so that the user can amend the application information provided to the system and/or method so that the application information included in the claim has an appropriate configuration (e.g., position, order, arrangement, conjugation, format, display or any combination thereof) for the claim;

optionally the at least a portion of the application information is the specifically configured information (e.g., comprising at least a portion of, a selection of, or all of the application information);

or

any combination thereof.

10. The method 0100, 0200, 0300 of any preceding clause: the method comprising:

displaying an application information summary (e.g., table of contents, series of symbols, or any combination thereof) comprising a summary of the application information that the user has been prompted to provide, that the user has provided, or a combination thereof;

providing the user an opportunity to provide an election indication, the election indication comprising an election of a reviewable portion of the application information identified in the application information summary which reviewable portion the user desires to review;

optionally the election indication comprises using a mouse to move a positional indicator 0702 (e.g., arrow or cursor) over a selected location corresponding to a symbolic representation appearing on the image display 0432, the symbolic representation corresponding to the reviewable portion of the application information, and using the mouse to click on the symbolic representation;

optionally the election indication comprises touching a touch pad to move a positional indicator 0702 (e.g., arrow or cursor) over a selected location corresponding to a symbolic representation appearing on the image display 0432, the symbolic representation corresponding to the reviewable portion of the application information, and using the touch pad to select the symbolic representation (e.g., by clicking a button or double-tapping the symbolic representation);

optionally the election indication comprises touching a touching a selected location corresponding to a symbolic representation appearing on a touchscreen of the image display 0432, the symbolic representation corresponding to the reviewable portion of the application information, and using the touchscreen to select the symbolic representation;

or

any combination thereof.

11. The method 0100, 0200, 0300 of any preceding clause, comprising:

receiving any user input (e.g., patent-related user input) described in this disclosure, optionally via the user interface, the computer, or any component of a system described in this disclosure;

displaying any item or items described in this disclosure (e.g., any image 0604, any images 0604, any portion of an image 0604, any combination of portions of an image 0604, any visible prompt 0606, any combination of visible prompts 0606, any portion of a visible prompt 0606, any combination of portions of visible prompts 0606, any selection indicator 0608, any combination of selection indicators 0608, any blank, any combination of blanks, any assistance indicator 0610, any combination of assistance indicators 0614, any link, any combination of links, any table-of-contents link 0612, any combination of table-of-contents links 0612, at least one specific claim 0906 or any combination thereof) on an image display or image displays 0432 (e.g., as part of an image 0604 or combination of images 0604) of any system and/or method (e.g., user interface, user interfaces, component of a user interface, or components of a user interface) described herein;

performing the method, any step of the method, any combination of steps of the method, any substep of the method, or any combination of substeps of the method using a selection indicator (e.g., cursor, arrow or symbol) to select user input (e.g., any user input described in this disclosure), optionally from a plurality of potential user inputs (e.g., any combination of user inputs described in this disclosure);

swapping the order of any step of the method, any combination of steps of the method, any substep of the method, any combination of substeps of the method, or any combination thereof with any other step of the method, any other combination of steps of the method, any other substep of the method, any other combination of substeps of the method, or any combination thereof;

performing the method, any step of the method, any combination of steps of the method, any substep of the method, or any combination of substeps of the method using a system described in this disclosure, a computer described in this disclosure, a user interface described in this disclosure, or any component thereof;

repeating any step, any combination of steps, any portion of a step or steps, or any combination of portions of a step or steps so that the repeating occurs one time, two times, three times, a number of times determined by the user input 2002, or any number of times;

or

any combination thereof.

12. The method of any preceding clause, the user input 2002 comprising:

at least one indication that the user desires or does not desire to (i) describe, (ii) claim or (iii) both describe and claim: a composition, compositions, a machine, machines, a system, systems, an article (e.g., article of manufacture), articles, a product, products, a method (e.g., process), methods, a method of using a composition, methods of using a composition, a method of using a machine, methods of using a machine, a method of using a system, methods of using a system, a method of using an article (e.g., article of manufacture), methods of using an article, a method of using a product, methods of using a product, a method of making a composition, methods of making a composition, a method of making a machine, methods of making a machine, a method of making a system, methods of making a system, a method of making an article (e.g., article of manufacture), methods of making an article, a method of making a product, methods of making a product, a composition made by a process (e.g. product by process), compositions made by a process, a machine made by a process, machines made by a process, a system made by a process, systems made by a process, an article (e.g., article of manufacture) made by a process, articles made by a process, a product made by a process, products made by a process, or any combination thereof.

13. The method of any preceding clause, the user input 2002 comprising:

displaying any portion of a patent application or any portion of information described in this disclosure (e.g., any user prompt, any user input, a claim, claims, or any combination thereof) before prompting a user (e.g., the user) to provide the user input related to the portion of the application or the portion of the information, while prompting a user (e.g., the user) to provide user input related to the portion of the application or the portion of the information, after prompting the user to provide user input related to the portion of the application or the portion of the information, or any combination thereof;

wherein the user input (e.g., patent-related user input), the portion of the patent application, the portion of information described in this application, or any combination thereof is selected from the group consisting of: (1) a claim; (2) claims; (3) an image; (4) images; (5) a figure; (6) figures; (7) drawing; (8) drawings; (9) a table; (10) tables; (11) a cross-reference to a related application; (12) an incorporation by reference of a document, patent application, patent publication or patent; (13) a technical field of the disclosure and/or claimed invention; (14) a background of the disclosure and/or claimed invention; (15) a brief description of an image, figure, or drawing; a brief description of images, figures, or drawings; (16) a detailed description of the images, figures, drawings, disclosure, claimed invention, or any combination thereof; (17) a summary of the disclosure, claimed invention, claimed inventions or any combination thereof; (18) a problem solved by the disclosure, claimed invention, claimed inventions or combination thereof; (19) an advantage, a technical effect, or a solution to the problem solved by the disclosure, a portion of the disclosure, claimed invention, a portion of the claimed invention, a component or combination of components of the claimed invention or claimed inventions or any combination thereof; or (20) any combination thereof;

or

any combination thereof.

14. A system 0416 configured to perform the method 0100, 0200, 0300 of any preceding clause.

15. A system comprising:

a computer; and

a user interface (e.g., in communication with the computer);

the user interface comprising an image display and at least one input device configured to permit a user to communicate with the computer;

the system configured to perform a method comprising:

prompting a user (e.g., the user) to provide user input by displaying a user prompt on the image display;

the computer receiving the user input from the user via the user interface; and

the computer using the user input to draft at least a portion of a patent application (e.g., a claim, claims, any portion or any combination of portions of a patent application described in this disclosure, or an entire patent application) describing at least one invention;

the user input comprising at least one element of an invention of the at least one invention; and

the user input comprising a third-party indication, the third-party indication indicating whether the user desires at least one third party to be notified of the existence of the patent application.

16. The system of clause 15, the third party being an entity that is not responsible for receiving a patent application or information relating to a patent application for a patent office or a government.

17. A system comprising:

a computer; and

a user interface (e.g., in communication with the computer);

the user interface comprising an image display and at least one input device configured to permit a user to communicate with the computer;

the system configured to perform a method comprising:

prompting a user (e.g., the user) to provide user input by displaying a user prompt on the image display;
the computer receiving the user input from the user via the user interface;

the computer using the user input to draft at least a portion of a patent application (e.g., a claim, claims, any portion or any combination of portions of a patent application described in this disclosure, or an entire patent application) describing at least one invention; and

the user input comprising at least one element of an invention of the at least one invention; and

the prompting the user to provide user input comprising prompting the user to provide the user input in a format that can be converted into a portion of the application without any further user input.

18. The system of clause 17, the third party being an entity that is not responsible for receiving a patent application or information relating to a patent application for a patent office or a government.

19. The system of any one of clauses 16 to 17, wherein:

any additions, edits or omissions from the user input used to create the portion of the application from the user input do not require artificial intelligence;

any additions, edits or omissions from the user input used to create the portion of the application from the user input can be determined due the format of the user prompt and the format of the user input that the user is prompted to provide;

any additions, edits or omissions from the user input used to create the portion of the application from the user input can be determined as a result of the user being prompted to provide the user input in such a format that at least one addition, edit or omission can always be made to the user input to provide the portion of the application, optionally without needing to change the user input apart from changing the tense of a word, and optionally without needing to change any word or words input by the user;

the user input comprising a word or words inserted by a user (e.g., the user) into a blank;

the user input comprising information that can be selected from a list of information, optionally the information can be further specified via additional user input;

the user input comprising a word or group of words and indicating whether an indefinite article corresponds to the word or group of words, and if an indefinite article corresponds to the word or group of words, which indefinite article corresponds to the word or group of words; or

any combination thereof.

20. A system comprising:

a computer; and

a user interface (e.g., in communication with the computer);

the user interface comprising an image display and at least one input device configured to permit a user to communicate with the computer;

the system configured to perform a method comprising:

prompting a user (e.g., the user) to provide user input by displaying a user prompt on the image display;

the computer receiving the user input from the user via the user interface; and

the computer using the user input to draft at least a portion of a patent application (e.g., a claim, claims, any portion or any combination of portions of a patent application described in this disclosure, or an entire patent application) describing at least one invention;

the user input comprising at least one element of an invention of the at least one invention; and

the prompting the user to provide user input comprising displaying a portion of the patent application that is created by the system or method using the user input, optionally the portion of the patent application comprising a clause or clauses of the patent application.

21. A system comprising:

a computer; and

a user interface (e.g., in communication with the computer);

the user interface comprising an image display and at least one input device configured to permit a user to communicate with the computer;

the system configured to perform a method comprising:

prompting a user (e.g., the user) to provide user input by displaying a user prompt on the image display, the user interface located remotely from the computer;

the computer receiving the user input from the user via the user interface;

the computer using the user input to draft at least a portion of a patent application (e.g., a claim, claims, any portion or any combination of portions of a patent application described in this disclosure, or an entire patent application) describing at least one invention; and

the user input comprising at least one element of an invention of the at least one invention.

22. The system of clause 21, the method comprising:

providing a patent professional entity located remotely from the user interface with access to the draft patent application.

23. The system of clause 22, the method comprising:

prompting the patent professional entity to approve the patent application for filing with a patent office, optionally the patent office being a patent office where the patent professional entity is authorized to prepare patent applications for others.

24. The system of clause 23, the method comprising:

filing the patent application, and optionally using the system to file the patent application.

25. The system of clause 1,

the computer being in communication with the user interface via the internet.

26. The system of any preceding clause, the computer being located remotely relative to the user interface.

27. The system of any preceding clause, the system comprising software configured to perform the method when executed by a computer, the computer configured to execute the software.

28. The system of any preceding clause, the computer comprising software configured to perform the method when executed by a computer, the computer configured to execute the software.

29. The system of any preceding clause, the computer comprising or connected to a memory, the memory comprising software configured to perform the method when executed by a computer, the computer configured to execute the software.

30. A system 0416 comprising:
a. a computer, optionally a plurality of computers (e.g., a first computer, a second computer, a third computer or a combination thereof) comprising the computer; optionally the computer being a first computer (e.g., a user computer used by the user); optionally the second computer being a remote platform optionally (i) for hosting software as a service, (ii) to execute software to perform the system and/or method and provide a user or users with a website to interact with the system and/or method or (iii) any combination thereof; optionally the third computer being a computer used by a patent professional entity; or any combination thereof); and
b. optionally a user interface (e.g., in communication with the computer);

optionally the user interface comprising an image display 0432 and at least one input device configured to permit a user (e.g., the user) to communicate with the computer;

optionally the system (e.g., computer, user interface, any combination thereof, or any component thereof) configured to perform the method of any preceding clause

or

any combination thereof.

31. The system 0416 of any preceding clause:

optionally the computer being in communication with the user interface via the internet;

optionally the computer being located remotely relative to the user interface;

optionally the system comprising software configured to perform the method when executed by a computer, the computer configured to execute the software;

or

any combination thereof.

32. The system 0416 of any preceding clause:
optionally the system 0416 comprising the user interface 0420;
optionally the system 0416 comprising the image display 0432;
optionally the system 0416 comprising software configured to perform the method (e.g., when executed by a system, computer, user interface, any combination thereof, or any component thereof);
optionally the system (e.g., computer, component of a system, combination of components of a system, or any combination thereof) or a device or combination of devices external to the system (e.g., server, network, device connected through the internet, a cloud-based server, any other device or combination of devices described herein, etc.) configured to execute the software;
optionally the user interface 0420 comprising the image display 0432;
optionally the computer being indirectly in communication with the user interface (e.g., the computer being in communication with the user interface via the internet but not directly);
optionally the computer being located remotely relative to the user interface and/or the user interface;
optionally the computer being directly in communication with the user interface (e.g., via direct wireless or wired connection);
optionally the computer being co-located with (e.g., adjacent or in proximity to) the user interface and/or the user interface;
optionally the user interface being co-located with (e.g., adjacent or in proximity to) the user; or

any combination thereof.

33. The system 0416 of any preceding clause:
the user interface 0420 comprising the image display 0432 (e.g., monitor, touchscreen), a controller for a visible location selector (e.g., a controller, a controller for a cursor, a controller for an arrow, a mouse 0430, a joystick, a key, a keyboard 0424, a touch pad, a touch screen, a sensor to detect movement of a or the user, or any combination thereof), a controller, a controller for a cursor, a controller for an arrow, a mouse 0430, a joystick, a key, a keyboard 0424, a touch pad, a touch screen, a sensor to detect movement of a or the user, a sound detector 0426 (e.g., microphone), a sound maker 0422 (e.g., speaker), a virtual reality system, a virtual reality headset, a head mounted display, a sensor, a vibrator, a robot, a light detector 0434 (e.g., camera), or any combination thereof.

34. The system 0416 of any preceding clause, the system 0416 comprising:

a computer 0418 (e.g., a computing environment, a personal computer 0418, a desktop computer, a laptop computer, a notebook computer, a tablet computer, a handheld computer, an integrated office system, a virtual reality system, a personal digital assistant, a smart phone, a smart watch, a smart television set (T.V.), a cloud server, a virtual server, a cloud-based computer, a virtual machine, a virtual personal computer a network, the internet, or any combination thereof);

at least one input device (e.g., a touch screen, a touch pad, a mouse 0430, a keyboard 0424, a sound detector 0426 (e.g., microphone), an input port configured to receive information, any device (e.g., any device described herein) that is configured to permit a user (e.g., the user) to communicate with a computer, or any combination thereof;

at least one output device (e.g., a monitor, a screen, a printer, a touch screen, a vibrator, a sound maker 0422 (e.g., speaker), an output port configured to send information, or any device (e.g., any device described herein) that is configured to permit a computer to communicate with a user (e.g., the user), or any combination thereof;

a network communicator (e.g., wired or wireless) configured to send information to a network, receive information from a network, or any combination thereof;

optionally wherein the computer 0418 comprises:

a processor 0402 (e.g., central processing unit (CPU));

memory 0404 (hard drive, solid state drive, connected memory 0404 devices (e.g., USB drive, CD, DVD, or any combination thereof);

or any combination thereof;

optionally the computer storing software configured to execute the method;

optionally the user interface being in communication with the computer;

optionally wherein the network communicator comprises or forms a part of a router, wireless router, telecommunication device, a phone, a fax machine, a cellular phone, a telecommunication network, a wired network, a wireless network, a cable network, a fiberoptic cable network, or any combination thereof;

optionally wherein the network comprises a local area network, the internet, a device (e.g., a network, the internet, a server, a cloud-based server, a computer) or devices (e.g., combination of devices) 0412 outside the system, or any combination thereof;

optionally wherein the system comprises a line or lines of communication 0436, 0438, 0440, 0442, 0444, 0406, 0410, 0414, 0428 (e.g., direct line of communication or indirect line of communication, wired line of communication, wireless line of communication, cable or any combination thereof) from any component of the system to any other component of the system described in this disclosure or from any combination of components of the system to any other combination of components of the system described in this disclosure;

optionally wherein the system comprises a line 0414 or lines 0414 of communication (e.g., direct line of communication or indirect line of communication, wired line of communication, wireless line of communication, cable or any combination thereof) from the system or any component of the system to any device 0412 or devices (e.g., combination of devices) 0412 outside the system;

optionally wherein the system comprises a line or lines of communication 0436, 0438, 0440, 0442, 0444, 0406, 0410, 0414, 0428 (e.g., direct line of communication or indirect line of communication, wired line of communication, wireless line of communication, cable or any combination thereof) from the computer 0418 (e.g., any computer, any component of a computer or any combination of components of a computer described in this disclosure) to any component described herein (e.g., the user interface 0420, any component of the user interface);

optionally wherein the system comprises a line or lines of communication 0436 (e.g., direct line of communication or indirect line of communication, wired line of communication, wireless line of communication, cable or any combination thereof) from the computer 0418 (e.g., any computer, any component of a computer or any combination of components of a computer described in this disclosure) to the sound maker 0422;

optionally wherein the system comprises a line or lines of communication 0438 (e.g., direct line of communication or indirect line of communication, wired line of communication, wireless line of communication, cable or any combination thereof) from the computer 0418 (e.g., any computer, any component of a computer or any combination of components of a computer described in this disclosure) to the image display 0432, the light detector 0434 (e.g., camera) or a combination thereof;

optionally wherein the system comprises a line or lines of communication 0440 (e.g., direct line of communication or indirect line of communication, wired line of communication, wireless line of communication, cable or any combination thereof) from the computer 0418 (e.g., any computer, any component of a computer or any combination of components of a computer described in this disclosure) to the keyboard 0424;

optionally wherein the system comprises a line or lines of communication 0442 (e.g., direct line of communication or indirect line of communication, wired line of communication, wireless line of communication, cable or any combination thereof) from the computer 0418 (e.g., any computer, any component of a computer or any combination of components of a computer described in this disclosure) to the mouse 0430;

optionally wherein the system comprises a line or lines of communication 0444 (e.g., direct line of communication or indirect line of communication, wired line of communication, wireless line of communication, cable or any combination thereof) from the computer 0418 (e.g., any computer, any component of a computer or any combination of components of a computer described in this disclosure) to the sound detector 0426;

optionally wherein the system comprises a line or lines of communication 0410 (e.g., direct line of communication or indirect line of communication, wired line of communication, wireless line of communication, cable or any combination thereof) from the computer 0418 (e.g., any computer, any component or combination of components of a computer described in this disclosure) to a connected device 0408 or connected devices 0408 (e.g., any component of system described in this disclosure or any combination of components of a system described in this disclosure);

optionally wherein the system comprises a line or lines of communication 0428 (e.g., direct line of communication or indirect line of communication, wired line of communication, wireless line of communication, cable or any combination thereof) from the computer 0418 (e.g., any component of a computer or any combination of components of a computer described in this disclosure) to a user interface 0420 (e.g., any component of a user interface 0420 described in this disclosure, or any combination of components of a user interface 0420 described in this disclosure);

optionally wherein the system comprises a line or lines of communication 0448 (e.g., direct line of communication or indirect line of communication, wired line of communication, wireless line of communication, cable or any combination thereof) from the computer 0418 (e.g., any computer, any component of a computer or any combination of components of a computer described in this disclosure) to a remote platform 0446 (e.g., any component of a remote platform 0446 described in this disclosure, or any combination of components of a remote platform 0446 described in this disclosure);

optionally wherein the system comprises a line or lines of communication 0406 (e.g., direct line of communication or indirect line of communication, wired line of communication, wireless line of communication, cable or any combination thereof) from the processor 0402 to memory 0404 (e.g., volatile memory, non-volatile memory, random access memory, solid state memory, a disk, a memory storage device, or any combination thereof);

optionally wherein the system comprises a line or lines of communication 0414 (e.g., direct line of communication or indirect line of communication, wired line of communication, wireless line of communication, cable or any combination thereof) from the system 0416 to a device 0412 or devices (e.g., combination of devices) 0412 outside the system (e.g., any network, the internet, line of communication, device or component described in this disclosure, or any combination thereof); or
any combination thereof.

35. The system 0416 of any preceding clause, the system comprising:
a computer 0418, optionally a plurality of computers comprising the computer;
a processor 0402;
a memory 0404;
a connected device 0408, the connected device being in communication (e.g., direct or indirect communication) with the computer 0418, any component of a computer described in this disclosure, any combination of components of a computer described in this disclosure, a user interface described in this disclosure, any component of a user interface in this disclosure, any combination of components of a user interface described in this disclosure, a device 0412 outside the system 0416, devices 0412 outside the system 0416, or any combination thereof;

connected devices 0408, the connected devices being in communication (e.g., direct or indirect communication) with the computer 0418, any component of a computer described in this disclosure, any combination of components of a computer described in this disclosure, a device 0412 outside the system 0416, devices 0412 outside the system 0416, or any combination thereof;

optionally the connected device comprising: a computer, a user interface, a router, a network, the internet, a memory storage device, a remote platform or any combination thereof;

optionally the device or devices that can be outside (or optionally inside) the system include, but are not limited to, a network, the internet, a server, a cloud-based server, a computer (e.g., a first computer, a second computer, a third computer, a computer used by a first user, a computer used by a second user, a computer used by an inventor or applicant, a computer used by a patent professional entity, or any combination thereof), a user interface (e.g., a first user interface, a second user interface, a third user interface, a user interface used by a first user, a user interface used by a second user, a user interface used by an inventor or applicant, a user interface used by a patent professional entity, or any combination thereof) or any combination thereof;

or

any combination thereof.

36. The system 0416 of any preceding clause:

the system in communication (e.g., directly, indirectly, via a line of communication, via any approach described in this disclosure, via any system, component (e.g., device) or combination of components (e.g., devices) described in this disclosure, or any combination thereof) with any system described in this disclosure, any component described in this disclosure, any combination of components described in this disclosure, any portion of a component or components described in this disclosure, any combination of portions of a component or components described in this disclosure, or any combination thereof;

any component described in this disclosure, any combination of components described in this disclosure, any portion of a component or components described in this disclosure, any combination of portions of a component or components described in this disclosure, or any combination thereof in communication (e.g., directly, indirectly, via a line of communication, via any approach described in this disclosure, via any system, component (e.g., device) or combination of components (e.g., devices) described in this disclosure, or any combination thereof) with any system described in this disclosure, any component described in this disclosure, any combination of components described in this disclosure, any portion of a component or components described in this disclosure, any combination of portions of a component or components described in this disclosure, or any combination thereof;

or any combination thereof.

37. The system 0416 of any preceding clause:

optionally the system 0416 comprising any component, any combination of components, any portion of a component, or any combination of portions of components described in this disclosure; and

optionally the system 0416 using any component, any combination of components, any portion of a component, or any combination of portions of components described in this disclosure to perform any step described in this disclosure, any portion of a step described in this disclosure, any combination of steps described in this disclosure, or any combination of portions of steps described in this disclosure.

38. A system 0416:

optionally the system of any preceding clause;

optionally the system being used to perform the method of any preceding clause;

optionally the system 0416 comprising or using any component, any combination of components, any portion of a component, or any combination of portions of components described in this disclosure;

optionally the system 0416 comprising or using any component, any combination of components, any portion of a component, or any combination of portions of components described in this disclosure to perform any step described in this disclosure, any portion of a step described in this disclosure, any combination of steps described in this disclosure, or any combination of portions of steps described in this disclosure; or

any combination thereof.

The reference numbers in this application are provided for illustration only and are not limiting for the disclosure in general or any clauses in the additional embodiment section that recite reference numbers.

Throughout this application, the use of the abbreviation, “e.g.” means “for example.” The use of the abbreviation “i.e.” means “that is.”

As used in this application, the term “comprising” means “including, but not limited to.” As used in this application, the term “consisting of” means “including and limited to.”

Although embodiments have been described using the term “comprising” or its conjugates additional embodiments can be created by replacing the term “comprising” or its conjugates with “consisting essentially of” or “consisting of” or their conjugates. Additionally, although embodiments have been described using the term “consisting of” or its conjugates, additional embodiments can be created by replacing the term “consisting of” or its conjugates with “comprising” or “consisting essentially of” or their conjugates. Additionally, for any embodiment described using the term “consisting essentially of” or its conjugates, additional embodiments can be created by replacing the term “consisting essentially of” or its conjugates with “comprising” or “consisting of” or their conjugates.

Although embodiments have been described in the context adding reference numbers to at least one figure in a patent application, additional embodiments can be created in which the at least one figure is replaced with at least one image of any kind that comprises elements to be labeled. Moreover, additional embodiments can be created in which the reference numbers are replaced with any label. For example, rather than being limited to a reference number, the label can comprise any symbol, for example, a shape, a letter, a numeral, or any combination thereof. The label can also comprise lead lines extending from the symbol toward the element or elements corresponding to the label.

Although embodiments have been described with reference to a user, additional embodiments can be provided by replacing the user with a human, artificial intelligence, a machine directed by a human, a plurality of users, or any combination thereof. Additionally, any user or combination of users described in this disclosure can each be provided with any user interface described in this disclosure, any computer described in this disclosure, any system described in this disclosure, any component of a system described in this disclosure, any combination of components of a system described in this disclosure, or any combination thereof, optionally with any configuration described in this disclosure. Moreover, although a generic user may be referred to in some embodiments of this disclosure, the generic user can be replaced with a specific user that was previously recited. Accordingly, for any embodiment described in this application referring to “a user” or “users,” an additional embodiment can be explicitly formed by replacing “a user” with “the user” and/or by replacing “users” with “the users.”

Although embodiments have been described with reference to a computer, additional embodiments can be provided by replacing the computer with a system comprising a computer, a computing environment, a personal computer, a desktop computer, a laptop computer, a notebook computer, a tablet computer, a handheld computer, an integrated office system, a virtual reality system, a personal digital assistant, a smart phone, a smart watch, a smart television set (T.V.), a network server, a cloud server, a virtual server, a cloud-based computer, a virtual machine, a virtual personal computer, a network, the internet, or any combination thereof.

Although embodiments have been described with reference to an interface (e.g., user interface), additional embodiments can be provided by replacing the interface with the image display (e.g., monitor, touchscreen), a controller for a visible location selector (e.g., a controller, a controller for a cursor, a controller for an arrow, a mouse, a joystick, a key, a keyboard, a touch pad, a touch screen, a sensor to detect movement of a user, or any combination thereof) a keyboard, a sound detector (e.g., microphone), a sound maker (e.g., speaker), a virtual reality system, a virtual reality headset, a head mounted display, a sensor, a vibrator, a robot, or any combination thereof.

Additionally, embodiments have been described in which a system, a component (e.g., user monitor, user interface), or combination of components (e.g., a user interface) of a system is used to accomplish a task described herein, a combination of tasks described herein, a portion of a task described herein, a combination of portions of a task or tasks described herein, a step described herein, a combination of steps described herein, a portion of a step described herein, or a combination of portions of a step or steps described herein. However, additional embodiments can be created in which any system described herein, any component (e.g., user interface) of a system described herein, any combination of components (e.g., a user interface) of a system described herein, any subcomponent of a system described herein, any combination of subcomponents of a system described herein, any portion or any combination of portions of the component of a system described herein, or any combination of components of a system described herein is used to accomplish any task described herein, any combination of tasks described herein, any portion of a task described herein, any combination of portions of a task or tasks described herein, any step described herein, any combination of steps described herein, any portion of a step described herein, or any combination of portions of a step or steps described herein. For example, although an embodiment may describe a user interface as being used to move a visible location selector, the task or step can also be accomplished by an input device (e.g., a controller for the visible location selector).

Although embodiments have been described with reference to an image that is a figure for a patent application, additional embodiments can be created in which any image is or any images are a figure in a technical drawing, instructions for making or assembling furniture, a machine drawing, an engineering drawing, an equipment specification, a manufacturing specification, a figure for a patent application, a figure in a text book, any image or plurality of images for which adding one or more labels may be desirable, or any combination thereof.

Although embodiments have been described with reference to an arrow, cursor or other indicator to identify a location, in additional embodiments, any location identifier can be used. For example, any symbol can be used as a location identifier to identify a location where an action will be taken (e.g., placing a label) or a location where selected information is located (e.g., an image to be selected, a reference number or other symbol to be selected for use in a label, a specific type of lead line to be selected, a type of edit to be made or any combination thereof), or any combination thereof.

Embodiments have been described in this disclosure with reference to an element or a list of elements corresponding to an element or elements appearing in an image or a plurality of images to which a label can be added by a method and/or system described in this disclosure. Any such list of elements can be provided by a user for the method and/or system.

As another example, a list of elements can be generated by a user in conjunction with a method and/or system described herein. For example, a user can simply be given an opportunity to identify an element or plurality of elements by selecting a series of continuous words appear in language (e.g., a claim set). Then, the method and/or system described herein can be used to automatically assign a symbolic designation to the element.

Any list of elements described in this disclosure can also be automatically generated by the method and/or system, for example, by reviewing a claim set for a patent application comprising the elements that make up the list of elements or by reviewing information or text comprising the elements that make up the list of elements. Automatically generating the list of elements can be done according to any method and/or system known in the art or any document incorporated by reference in this disclosure.

As another example, a list of elements can be automatically generated (e.g., either fully or partially automatically generated) by any method and/or system described in this disclosure by using grammar rules to look for candidates for elements in a claim set or other information (e.g., language), and the user can be provided with an opportunity to accept, modify or reject the candidates for inclusion in the list of claim elements. To illustrate, a series of continuous words comprising a noun (for example, “a machine,” or gerunds (e.g., “pleading”)) and a qualifier, qualifiers, an adjective (e.g., “quick”), adjectives (e.g., “powerful, quick”), a noun acting as an adjective (e.g., “car wash” or “condition precedent”), nouns acting as adjectives (e.g., “car wash machine”), adverb (e.g., “unusually quick car wash”), adverbs (e.g., “most unusually quick car wash”), or any combination thereof directly or indirectly qualifying the noun, adjacent to the noun, preceding the noun, following the noun or any combination thereof can be deemed an element. Then, any subsequent appearance of the element can be considered non-unique (i.e., redundant) and assigned the same symbolic designation (e.g., a reference number) as an earlier occurrence of the element. Thus, a list of unique (i.e., non-redundant) elements can be established. Furthermore, any label added to an image for an element can include the symbolic designation.

After a list of elements exists and is available to a method and/or system, a method and/or system disclosed herein can, for each element or any selection of elements in the list of elements (e.g., to be included in a label to be applied to an image or a plurality of images), assign a provisional symbolic designation to the element, optionally give the user an opportunity to change the provisional symbolic designation for the element to a specifically selected symbolic designation, give the user an opportunity to provide a positional indication to identify a location on an image corresponding to the element, and apply a label comprising the provisional or specifically selected symbolic designation to the image.

Additionally, each symbolic designation for each element or a selection of elements in a list of elements described in this disclosure can be automatically generated. For example, a first set of symbolic characters in the symbolic designation (e.g., numbers, letters, symbols, or any combination thereof in the first 1, 2, 3, or 4 places of the symbolic designation) can correspond to a symbolic designation (e.g., Figure number, such as FIG. 1, 2, 3, 10, 22, etc.) assigned to an image. Further, a second set of symbolic characters in the symbolic designation (e.g., numbers, letters, symbols, or any combination thereof in the next 1, 2, 3, or 4 places of the symbolic designation) can correspond to a symbolic designation (e.g., element number, such as 1, 2, 3, 10, 22, etc.) assigned to each element appearing in an image. To illustrate, if each image in a set of 10 images is identified using a one- or two-digit number from 1 to 10, and each element appearing in each image is assigned a two digit number from 00 to 99, then the first five elements in the image identified as FIG. 1 could be assigned the following symbolic designations: 0101, 0102, 0103, 0104, and 0105; and the first five elements in the image identified as FIG. 2 could be assigned the following symbolic designations: 0201, 0202, 0203, 0204, and 0205. As another illustration, if the element numbers are assigned by counting by an integer other than one (e.g., two), the first five elements in the image identified as FIG. 1 could be assigned the following symbolic designations: 0102, 0104, 0106, 0108, and 0110; and the first five elements in the image identified as FIG. 10 could be assigned the following symbolic designations: 1002, 1004, 1006, 1008, and 1010. As a skilled person would understand upon reading this disclosure, these approaches for automatically generating each symbolic designation for each element or a selection of elements in a list of elements is illustrative, and non-limiting. Accordingly, additional embodiments can be provided using other approaches.

Although embodiments have been described with reference to an action (e.g., by a user), an interaction (e.g., by a user with a user interface or a computer or any component or combination of components described herein), an indication of any kind, an identification step or any combination thereof, in additional embodiments, the action, interaction, indication, identification or any combination thereof can be replaced by another action, interaction, indication, identification or any combination thereof described herein or by a user clicking a mouse 0430, a user touching a screen, a user illuminating a location with a laser, a user moving the body or portion of a body of the user, a user making a hand motion, a user moving an eye or eyes, a user blinking an eye or eyes, a user making a noise, a user speaking a word, receiving information from an electrophysiological monitor of the user's brain activity or thoughts, a user making a sound whether directly or indirectly, or any combination thereof.

Although examples have been described using a “default” item of some type, it should be understood that in some embodiments, the user will have the ability to set the default item to a selected default item, for example, having selected characteristics.

Although some image displays comprise a single device (e.g., monitor, touch screen or any other device described herein) for displaying an image, additional embodiments can be provided in which the image display comprises a plurality of the devices. Accordingly, when an item is described as being displayed on an image display, it can be displayed on a single device or a plurality of devices.

Embodiments of this disclosure have been described with reference to a device or devices (e.g., a combination of devices, optionally in communication) outside a system described herein. Nonetheless, additional embodiments can be created in which the device or devices outside the system form a part of the system. Examples of a device or devices that can be outside (or inside) the system include, but are not limited to, a network, the internet, a server, a cloud-based server, a computer (e.g., a first computer, a second computer, a third computer, a computer used by a first user, a computer used by a second user, a computer used by an inventor or applicant, a computer used by a patent professional entity, or any combination thereof), a user interface (e.g., a first user interface, a second user interface, a third user interface, a user interface used by a first user, a user interface used by a second user, a user interface used by an inventor or applicant, a user interface used by a patent professional entity, or any combination thereof) or any combination thereof.

Although embodiments are described herein using a term that is singular, additional embodiments can be provided in which the singular term is replaced with the corresponding plural term (e.g., “monitor,” “a monitor,” “the monitor,” or “one monitor” can be replaced with “monitors,” “the monitors,” “a plurality of monitors,” or “the plurality of monitor”). Similarly, although embodiments are described herein using a term that is plural, additional embodiments can be provided in which the plural term is replaced with the corresponding singular term (e.g., “monitors,” “a plurality of monitors,” or “the plurality of monitors” can be replaced with “monitor,” “a monitor,” “the monitor,” or “one monitor”). Additionally, although embodiments are described herein with reference to an item, additional embodiments can be provided in which the reference to the item is replaced with a reference to one and only one of the item.

When the term “at least one” or similar language is used in this application, it means one or more. Accordingly, although embodiments are described using “at least one” item, additional embodiments can be provided by replacing “at least one” of the item with “an” or “the” item, “one” of the item, “at least two” of the items or “a plurality of” items (e.g., “at least one monitor” or “the at least one monitor” can be replaced with “a monitor,” “the monitor” “a plurality of monitors,” or “the plurality of monitors”).

Although examples have been described with reference to methods having a series of ordered steps, additional examples can be provided in which the order is changed by moving any step or selection of steps sooner or later in the ordered series of steps.

Although examples have been described with reference to methods having a series of ordered steps, additional examples can be provided in which the method is changed by omitting any step or selection of steps described herein.

Although examples have been described with reference to methods having a series of ordered steps, additional examples can be provided in which the method is changed by adding any step or selection of steps described herein.

For any specific step described in this application as capable of being equivalent or analogous to a reference step, the specific step can include any step or substep or feature, or any combination of steps or substeps or features described with reference to the reference step, and optionally the elements of the reference step can be replaced by the analogous elements in the specific step. Similarly, when any specific step is described in this application as capable of being equivalent or analogous to a reference step, the reference step can include any step or substep or feature, or any combination of steps or substeps or features described with reference to the specific step, and optionally the elements of the specific step can be replaced by the analogous elements in the reference step.

Although examples have been described with reference to a number, in some embodiments, the number can be considered an ordinal number designating position in a list or order of steps. Although examples have been described with reference to a number, in some embodiments, the number can be considered an ordinal number designating how many of something are present. Although examples have been described with reference to a number, in some embodiments, the number can be considered a merely nominal number designating the name of something for purposes of distinguishing it from something else. If a type of number is not indicated by the application, the number is a nominal number used for naming purposes. However, in additional embodiments, the nominal number can be deemed an ordinal number or a cardinal number, or both.

Although examples have been described using a limited number of steps for the sake of illustration, additional embodiments can be created using any number of steps by repeating any step or any combination of steps described herein any number of times. To illustrate, although an example might be provided in which one step or a series of steps is repeated once, and additional embodiment can be created in which the step or series of steps is repeated any number of times, for example, repeated one to 1000 times or any integer number included in this range. Additionally, in some embodiments an item is reference in a step or a first item is referenced in a first step or a second item is referenced in a second step; however, additional embodiments can be provided in which a subsequent step or subsequent steps are provided in which the item, first item, or second item is replaced with an item identified by a number corresponding to the number of the subsequent step. For example, if a first step recites a first positional indication, an additional embodiment can be created in which a second step is analogous to the first step and the first positional indication is replaced with a second positional indication. As another example, if a second step recites a second positional indication, an additional embodiment can be created in which a third step is analogous to the second step and the second positional indication is replaced with a third positional indication.

As used in this disclosure, describing a first item “and/or” a second item describes (i) the first item or the second item and (ii) the first item and the second item. In other words, each of options (i) and (ii) is described in this disclosure when the term “and/or” is used in combination with a first item and a second item, whatever those items happen to be in a particular passage.

Examples of “at least one” item include, for example, one and only one of the item, at least wo of the item, and a plurality of the item. Accordingly, although embodiments have been described using “at least one” item additional embodiments can be created in which “at least one” is replaced with “one and only one” item, “a” or “an” item, “at least two” items, “a plurality of” items or analogous phrases. Accordingly, although embodiments have been described using “the at least one” item additional embodiments can be created in which “the at least one” is replaced with “the one and only one” item, “the” item, “the at least two” items, “the plurality of” items or analogous phrases.

Examples of “at least a portion” of an item include the complete item, a portion of the item, less than the complete item, at least 1, 2, 3, 4, 5, 6, 7, 8, 9, 10, 20, 30, 40, 50, 60, 70, 80, 90, 91, 92, 93, 94, 95, 96, 97, 98, 99, or 100% of the item, no more than 2, 3, 4, 5, 6, 7, 8, 9, 10, 20, 30, 40, 50, 60, 70, 80, 90, 91, 92, 93, 94, 95, 96, 97, 98, 99 or 100% of the item, or any combination thereof, optionally the percentage of the item based on total weight of the item, total volume of the item, total number of the item, total letters in the item, total words in the item, total pages in the item, or any combination thereof.

Although embodiments have been described using the terms “providing,” “permitting,” “allowing,” “giving,” “for,” “to,” their conjugates or similar terms in combination with a specific objective, advantage, function, characteristic or any combination thereof; additional embodiments can be provided in which the embodiment is “configured for” achieving or “configured to” achieve the specific objective, advantage, function, characteristic or any combination thereof. For example, if one embodiment describes “giving the user an opportunity to skip applying a provisional label” an additional embodiment can be created in which a method and/or system is “configured to give the user an opportunity to skip applying a provisional label.”

Although indefinite articles or no articles before a noun, nouns, gerund or gerunds have been used in embodiments of this disclosure, additional embodiments can be formed in which the indefinite article or no article is replaced with a definite article before the noun, nouns, gerund or gerunds, so that the noun refers, nouns refer, gerund refers, or gerunds refer to a previously recited instance of the noun, nouns, gerund or gerunds. For example, “a computer” can be replaced with “the computer.”

Although definite articles before a noun, nouns, gerund or gerunds have been used in embodiments of this disclosure, additional embodiments can be formed in which the definite article is replaced with an indefinite article or no article before the noun, nouns, gerund or gerunds, so that the noun refers, nouns refer, gerund refers, or gerunds refer more generally to a noun, nouns, gerund or gerunds as applicable. For example, “the computer” can be replaced with “a computer.”

Throughout the application, methods and/or systems have been disclosed (e.g., for drafting a patent application, for labeling an image or any other function described herein). Software (e.g., data or information that can be read by a computer and code or instructions to perform tasks that can be read and executed by a computer) loaded on a system (e.g., component of a system, components of a system, computer, or computers) can be used to perform any method described herein. Furthermore, the system can be a fully local system or a partially remote system relative to a user of the method and/or system. An example of a fully local system is a system that comprises a computer and user interface, which can be located in a user's hand like a smart phone or at a desk where a user sits or stands to operate the computer and interact with the user interface. The computer can be loaded with software to perform any method described herein. The software can be stored on machine or computer readable medium (e.g., memory) that forms a part of the computer or on external memory in direct or indirect communication with the computer. The computer can also be connected to or in communication with a remote platform 0446 (e.g., so that the computer can send and receive information from the remote platform 0446 via a line of communication 0448, which can be direct, indirect, wired, wireless or any combination thereof) even if the software for performing the method is not stored on the remote platform. Examples of a remote platform include a remote server, a cloud-based server, a network, the internet, or any combination thereof. An example of a partially remote system is a system comprising a computer and a user interface located at a desk where a user sits or stands to operate the computer and interact with the user interface, the computer being connected to a remote platform where the software for performing any method described herein can be stored and/or run. To provide a further illustration of a partially remote system, the computer can be used to access an internet webpage that enables the computer and user interface to communicate with a remote platform running software used to perform any method described in this disclosure. When the method needs to receive input from a user, the user can provide this input by interacting with the user interface, the input can be communicated to the computer, and from the computer to the platform running the software to perform the method. Furthermore, when the method needs to communicate information to a user, the platform can provide the information to a user by sending the information to the computer, which can communicate the information to the user via the user interface. Additionally, a plurality of users can each be provided with a system that is remote or partially remote relative to each of the plurality of users. For example, the software can be provided on a computer that is remote to each user, and each user can be provided with a user interface and optionally a computer, to interact with the software on the computer that is remote (e.g., via the internet).

As can be seen, any system, any component of a system, any components of a system, any devices outside the system, any network, any server, any other device or combination of devices described expressly or by incorporation by reference in this disclosure, or any combination thereof can be used to store or execute software for purposes of performing any method described in this disclosure, any step of the method, any combination of steps of the method in any order, any portion of a step of the method, or any combination of portions of a step of the method in any order.

Although embodiments have been described in which a first component is in communication with a second component, additional embodiments can be created in which the first component is in direct communication (e.g., via a direct wireless connection, a direct wired connection, or any combination thereof) with the second component or indirect communication (e.g., via a network or the internet, or any combination thereof) with the second component;

Examples of components being in communication with each other include electronic communication. Components that are in communication with each other are able to share information. For example, a first component can send information to a second component, the second component can send information to the first component, or both.

Although examples have been described as displaying a user prompt, additional embodiments can be created in which the information requested via a user prompt is received by the method and/or system (e.g., from the user).

Although examples have been described in which the method and/or system receives information (e.g., from a user), additional embodiments can be created in which the information is requested (e.g., from the user) via a user prompt, which user prompt, for example, can be displayed on an image display.

Although non-limiting, illustrative examples have been described in this disclosure, for example, with reference to the accompanying drawings, various equivalents, modifications and alternatives to the illustrative examples provided in this disclosure will be apparent to those skilled in the art. These equivalents, modifications and alternatives are to be understood as included in the scope of this disclosure. Novel features believed to be characteristic of selected embodiments of the disclosed invention are recited in the appended claims. Nonetheless, there is no intention to exclude equivalents or modifications of the disclosed invention that may be practiced without departing from the spirit and scope of the invention. Rather, the scope of the claimed invention is intended to cover all equivalents of the subject matter defined in the claims.

What is claimed is:

1. A system comprising:
a computer; and
a user interface in communication with the computer;
the user interface comprising an image display and at least one input device configured to permit a user to communicate with the computer;
the system configured to perform a method comprising:
prompting the user to provide user input by displaying a user prompt on the image display;
the computer receiving the user input from the user via the user interface; and
the computer using the user input to draft at least a portion of a patent application describing at least one invention;
the user input comprising at least one element of an invention of the at least one invention; and
the user input comprising a third-party indication, the third-party indication indicating whether the user desires at least one third party to be notified, before publication of the patent application, of the existence of the patent application.

2. The system of claim 1, the third party being an entity that is not responsible for receiving a patent application or information relating to a patent application for a patent office or a government.

3. The system of claim 1, wherein the computer using the user input to draft at least a portion of the patent application comprises drafting at least one claim of the patent application; and
the prompting the user to provide user input comprising prompting the user to provide the user input in a format that can be converted into the at least one claim without any further user input.

4. (canceled)

5. The system of any one of claim 3, wherein:
any additions, edits or omissions from the user input used to create the portion of the application from the user input do not require artificial intelligence;
any additions, edits or omissions from the user input used to create the portion of the application from the user input can be determined due the format of the user prompt and the format of the user input that the user is prompted to provide;
any additions, edits or omissions from the user input used to create the portion of the application from the user input can be determined as a result of the user being prompted to provide the user input in such a format that at least one addition, edit or omission can always be made to the user input to provide the portion of the application, optionally without needing to change the user input apart from changing the tense of a word, and optionally without needing to change any word or words input by the user;
the user input comprising a word or words inserted by the user into a blank;
the user input comprising information that can be selected from a list of information, optionally the information can be further specified via additional user input;
the user input comprising a word or group of words and indicating whether an indefinite article corresponds to the word or group of words, and if an indefinite article corresponds to the word or group of words, which indefinite article corresponds to the word or group of words; or
any combination thereof.

6. The system of claim 3,
the prompting the user to provide user input comprising displaying a portion of the patent application that is created by the system or method using the user input, the portion of the patent application comprising the at least one claim of the patent application.

7. The system of claim 3, the user interface located remotely from the computer.

8. (canceled)

9. The system of claim 8, the method comprising:
providing a patent professional entity located remotely from the user interface with access to the draft patent application; and
prompting the patent professional entity to approve the patent application for filing with a patent office, optionally the patent office being a patent office where the patent professional entity is authorized to prepare patent applications for others.

10. The system of claim 9, the method comprising:
using the system to file the patent application.

11. The system of claim 1,
the computer being in communication with the user interface via the internet.

12. The system of claim 1, the computer being located remotely relative to the user interface.

13. (canceled)

14. (canceled)

15. The system of claim 1, the computer comprising or connected to a non-transitory machine readable medium, the non-transitory machine readable medium storing instructions configured to perform the method when executed by the computer, the computer configured to execute the instructions.

16. A method of using a system for drafting at least a portion of a patent application and receiving an indication regarding whether a user desires to notify at least one third party, the method comprising:
prompting the user to provide user input by displaying a user prompt on the image display;
a computer of the system receiving the user input from the user via a user interface; and
the computer using the user input to draft at least a portion of a patent application describing at least one invention, the at least a portion of the patent application being at least one claim;
the user input comprising at least one element of an invention of the at least one invention; and
the user input comprising a third-party indication, the third-party indication indicating whether the user desires at least one third party to be notified, before publication of the patent application, of the existence of the patent application.

17. The method of claim 16, the third party being an entity that is not responsible for receiving a patent application or information relating to a patent application for a patent office or a government.

18. The method of claim 16, the prompting the user to provide user input comprising prompting the user to provide the user input in a format that can be converted into a portion of the application without any further user input.

19. (canceled)

20. The method of claim 18, wherein:
any additions, edits or omissions from the user input used to create the portion of the application from the user input do not require artificial intelligence;
any additions, edits or omissions from the user input used to create the portion of the application from the user input can be determined due the format of the user prompt and the format of the user input that the user is prompted to provide;
any additions, edits or omissions from the user input used to create the portion of the application from the user input can be determined as a result of the user being prompted to provide the user input in such a format that at least one addition, edit or omission can always be made to the user input to provide the portion of the application, optionally without needing to change the user input apart from changing the tense of a word, and optionally without needing to change any word or words input by the user;
the user input comprising a word or words inserted by the user into a blank;
the user input comprising information that can be selected from a list of information, optionally the information can be further specified via additional user input;
the user input comprising a word or group of words and indicating whether an indefinite article corresponds to the word or group of words, and if an indefinite article corresponds to the word or group of words, which indefinite article corresponds to the word or group of words; or
any combination thereof.

21. The method of claim 16, the prompting the user to provide user input comprising displaying the at least one claim that is created by the system or method using the user input.

22. (canceled)

23. The method of claim 16, the user interface located remotely from the computer.

24. The method of claim 23, the method comprising:
providing a patent professional entity located remotely from the user interface with access to the draft patent application.

25. The method of claim 24, the method comprising:
prompting the patent professional entity to approve the patent application for filing with a patent office where the patent professional entity is authorized to prepare patent applications for others.

26. The method of any one of claim 23, the method comprising:
using the system to file the patent application.
